(19) United States
(12) Patent Application Publication
(10) Pub. No.: US 2009/0262724 A1
(43) Pub. Date: Oct. 22, 2009

(54) PROXY SERVER, COMMUNICATION SYSTEM, COMMUNICATION METHOD AND PROGRAM

(75) Inventors: Motohiro Suzuki, Tokyo (JP); Hiroshi Kazami, Tokyo (JP); Kunihiro Taniguchi, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: NEC CORPORATION, Tokyo (JP)

(21) Appl. No.: 12/092,034

(22) PCT Filed: Aug. 14, 2007
(86) PCT No.: PCT/JP2007/066079

§ 371 Date: Apr. 29, 2008

(30) Foreign Application Priority Data
Aug. 18, 2006 (JP) 2006-223363

(51) Int. Cl. H04L 12/66

(52) U.S. Cl. 370/352

(57) ABSTRACT

Provided in a proxy server which enables a plurality of SIP servers to copy registration information after presenting, to an SIP server requesting SIP Digest authentication, properness of one who makes an access and of a REGISTER request to be transmitted. With a REGISTER request generation function provided in addition to a function that a common SIP proxy server holds, a proxy server disposed between a user agent and an SIP server generates a REGISTER request to a spare SIP server and transmits the same to the spare SIP server, thereby realizing registration information copying, and holds a user identifier and a password of the proxy server to execute Digest authentication with the spare SIP server. Moreover, after confirming a REGISTER request processing completion response (200 OK) from a working SIP server from which registration information is copied, the proxy server transmits a copied REGISTER request to the spare SIP server.

### TECHNICAL FIELD

The present invention relates to a proxy server, a communication system, a communication method and a program which enable servers to copy registration information of an external terminal for use in a network (communication network) and the like which execute signaling by using SIP (Session Initiation Protocol).

### BACKGROUND ART

In recent years, as in VoIP (Voice over IP), real time communication using an IP network has been widely used. There is an increasing number of cases where SIP (Session Initiation Protocol) is adopted as an international standard protocol for setting up connection between terminals at the opposite ends of real time communication such as a telephone terminal or a personal computer. In the present specification, a communication network in which signaling is executed using SIP is referred to as an SIP network.

Common structure of an SIP network is recited in non-Patent Document 1 which will be described later. An SIP network is formed of a location server, an SIP server and a user agent (UA). The user agent is described on page 76 of the non-Patent Document 1 as “SIP is based on a client-server model between end systems. Equivalent to the end system is a user agent (UA). User agent, which is more specifically an end system such as a telephone set or a personal computer, realizes services by transmitting and receiving a request and a response to/from these end systems”. In the present specification, a request recited in the above description will be referred to as an SIP request and a response as an SIP response.

SIP server has (1) a proxy server function of relaying an SIP request and an SIP response, (2) a redirect server function for use in inquiry of a destination of an SIP request and (3) a registration server function of accepting registration of user agent information on an SIP network as recited on page 77 of the non-Patent Document 1. Here, user agent information is, for example, URI (Uniform Resource Identifier) as an identifier for accessing a user agent or an IP address to be used by a user agent. In the present specification, user agent information to be registered by a user agent will be referred to as registration information.

Location server is recited on page 81 of the non-Patent Document 1 as “to accumulate user agent information maintained by a registration server and provide data base service for use by a proxy server function or a redirect server function”. More specifically, as recited on page 112 of the non-Patent Document 1, user agent registration information is updated by using a REGISTER request as an SIP request.

Update of the registration information is premised on that a user agent transmits a REGISTER request to a certain SIP server. This is conspicuous in an authentication system (Digest authentication) of a user agent adopted in SIP as shown in FIG. 56.

FIG. 56 is a sequence diagram showing a flow of Digest authentication adopted by SIP. First, a user agent 2000 transmits a REGISTER request to an SIP server 2500. In the present specification, a REGISTER request transmitted first to the SIP server 2500 by the user agent 2000 will be referred to as an initial REGISTER request. The SIP server 2500 having received the initial REGISTER request from the user agent 2000 generates a nonce for use in Digest authentication and returns an SIP response (401) with the nonce value added to the user agent 2000. The user agent 2000 hashes a user identifier and a password with the received nonce as a key and transfers a REGISTER request with the obtained result stored in an Authorization header to the SIP server 2500. In the present specification, a REGISTER request with an Authorization header added will be referred to as an authentication REGISTER request. The SIP server 2500 having received the authentication REGISTER request, similarly to the user agent 2000, hashes a user identifier and a password of the user agent 2000 by using own generated nonce value. Thereafter, compare an obtained result with an Authorization header value stored in the authentication REGISTER request from the user agent 2000 and when they coincide with each other, determine that the request is a REGISTER request from a proper user agent to return an SIP response (200 OK) after updating registration information by using the data of the REGISTER request.

It is found from FIG. 56 that first, an initial REGISTER request needs to be transmitted to the SIP server 2500 which is allowed to refer to a user identifier and a password of the user agent 2000. This is because when reference by the SIP server 2500 is impossible, hash calculation using a user identifier and a password is impossible to fail in authentication. It is furthermore found that an initial REGISTER request and an authentication REGISTER request need to be transferred to the same SIP server 2500. This is because when the SIP server 2500 as a transfer destination differs, no nonce value is taken over by the SIP server 2500, so that even with an authentication REGISTER request from a proper user agent 2000, no hash calculation is made on the SIP server 2500 to fail in authentication.

It can be found from the foregoing that it is necessary to continue transmitting a REGISTER request to the SIP server 2500 which is allowed to refer to a user identifier and a password until REGISTER request processing is completed.

In view of the processing of a REGISTER request having such characteristics which is executed at the SIP server 2500, when copying registration information to other SIP server 2500, the following two forms are possible, for example. In the present specification, the SIP server 2500 for managing registration information to be copied will be referred to as a working SIP server 3000 and an SIP server for managing copied registration information will be referred to as a spare SIP server 4000. Moreover, although in the figure showing three forms set forth below, only the two SIP servers 2500 are shown, SIP servers 2500 to which registration information is to be copied may be provided in any number.

The first form is a form in which the user agent 2000 itself transfers a REGISTER request to a plurality of SIP servers 2500. More specifically, in the first form, as shown in FIG. 57, with a user identifier and a password of the user agent 2000 held by all the working and spare SIP servers, the user agent 2000 executes Digest authentication independently of each SIP server to update registration information.

The second form is a form in which the working SIP server 3000 transfers a REGISTER request to the spare SIP server 4000. More specifically, in the second form, as shown in FIG. 58, the user agent 2000 and the working SIP server 3000 execute Digest authentication and after completing update of registration information, the working SIP server 3000 transmits a REGISTER request to the spare SIP server 4000, thereby updating registration information of the spare SIP server 4000.

Non-Patent Document 1: ┌Revised Edition SIP Textbook┘ ┌Relationship between User Agent and SIP Server┘ (FIG. 5-2, page 78).

Of the above-described two forms, however, in the first form, even such a simple user agent 2000 as a telephone set needs to be mounted with a function of transferring a REGISTER request to the plurality of SIP servers 2500, resulting in making the user agent 2000 side cost more. Another problem is that traffic for updating registration information between the user agent 2000 and the SIP server 2500 will be increased by several times in proportion to the number of the spare SIP servers 4000.

Furthermore, in the second form, although the existing SIP server 2500 has a function of receiving and processing a REGISTER request, it might fail to have a function of transmission to other SIP server 2500. Therefore, function expansion of such SIP server 2500 is required to cost more for the realization of registration information copying between the SIP servers 2500.

For resolving the problems of the above-described exemplary embodiments, assuming a form in which a proxy server 1000 is provided between the user agent 2000 and the SIP server 2500 as shown in FIG. 59 to note a function of intervening in an SIP request and an SIP response of the proxy server 1000, an SIP proxy server is proposed as related technique. In the non-Patent Document 1, the function that the SIP proxy server holds is recited to interpret an SIP request from the user agent 2000 and after executing necessary processing, transmit an SIP request to a subsequent destination.

There occurs a problem set forth below, however, when copying registration information between the working SIP server 3000 and the spare SIP server 4000 by making the best of an SIP proxy server according to the related art and taking facility of application to the existing user agent 2000 and the SIP server 2500 and suppression of traffic between the user agent 2000 and the SIP server 2500 into consideration.

The first problem is that an SIP proxy server fails to copy registration information. This is because the SIP proxy server fails to generate an SIP request as recited in the above non-Patent Document 1. In other words, the SIP proxy server is incapable of generating a REGISTER request to be transmitted to the spare SIP server 4000.

Even if the SIP proxy server is capable of generating a REGISTER request, there exists a further problem as follows.

The second problem is that it is impossible to transmit a REGISTER request by Digest authentication using a user identifier and a password of the user agent 2000 to the spare SIP server 4000 which requests Digest authentication. This is because for an SIP proxy server not holding a user identifier and a password of the user agent 2000 to obtain the user identifier and the password of the user agent 2000, only the way is to break Digest authentication between the user agent 2000 and the working SIP server 3000.

The third problem is that a means should be provided for confirming properness of a REGISTER request transmitted to the working SIP server 3000 from the user agent 2000. This is because when making a DoS (Denial of Service) attack to an SIP network, for example, it is assumed that useless data is stored in an initial REGISTER request from the user agent 2000 and transmitted in volume. In this case, when the SIP proxy server copies/transmits an initial REGISTER request to the spare SIP server 4000 without referring to a processing result obtained at the working SIP server 3000, even the spare SIP server 4000 will suffer from a DoS attack. Thus, the proxy server 1000 needs to confirm properness of a REGISTER request transmitted to the working SIP server 3000 from the user agent 2000.

An object of the present invention is to provide a proxy server on an SIP network which enables a plurality of servers to copy registration information after indicating properness of one who makes an access and of communication to a server which requests Digest authentication.

### SUMMARY

According to an exemplary aspect of the invention, a proxy server includes a proxy server function of intervening in transmission and reception of a message among an external user terminal, an external working communication control device and an external spare communication control device, a message discrimination function of discriminating a kind of message received by the proxy server function, a temporary storage function of, when the message discrimination function determines that a message is a message requesting processing of information related to the user terminal which is held in the working communication control device, temporally recording the contents of the message, and a request generation function of, when a message is accepted by the working communication control device, copying a message having the same contents as those of the message in question for authentication to the spare communication control device.

### Effects of the Invention

The present invention attains the following effects.

The first effect is realizing copying of registration information. This is because a proxy server holds a function of generating a REGISTER request (message) to be transmitted to a spare SIP server in addition to a function that the proxy server originally has.

The second effect is enabling properness of one who accesses a spare SIP server to be indicated to the spare SIP server at the time of copying registration information. This is because with a user identifier and a password of a proxy server held by the proxy server, Digest authentication is executed between the proxy server and the spare SIP server.

### BRIEF DESCRIPTION OF THE DRAWINGS

FIG. 1 is a block diagram showing a structure of a communication system according to a first exemplary embodiment of the present invention;

FIG. 2 is a block diagram showing a structure of a proxy server according to the first exemplary embodiment;

FIG. 3 is a diagram showing one example of a storage form of a REGISTER request in a temporary storage function according to the first exemplary embodiment;

FIG. 4 is a block diagram showing a hardware structure of the proxy server according to the first exemplary embodiment;

FIG. 5 is a flow chart showing operation of the proxy server according to the first exemplary embodiment;

FIG. 6 is a diagram showing a flow of data in the entire system including the proxy server according to the first exemplary embodiment;

FIG. 7 is a sequence diagram showing operation of the entire system including the proxy server according to the first exemplary embodiment;

FIG. 8 is a block diagram showing a structure of a proxy server according to a second exemplary embodiment of the present invention;

FIG. 9 is a flow chart showing operation of the proxy server according to the second exemplary embodiment;

FIG. 10 is a diagram showing a flow of data in the entire system including the proxy server according to the second exemplary embodiment;

FIG. 11 is a sequence diagram showing operation of the entire system including the proxy server according to the second exemplary embodiment;

FIG. 12 is a block diagram showing a structure of a proxy server according to a third exemplary embodiment of the present invention;

FIG. 13 is a flow chart showing operation of the proxy server according to the third exemplary embodiment;

FIG. 14 is a diagram showing a flow of data in the entire system including the proxy server according to the third exemplary embodiment;

FIG. 15 is a sequence diagram showing operation of the entire system including the proxy server according to the third exemplary embodiment;

FIG. 16 is a block diagram showing a structure of a proxy server according to a fourth exemplary embodiment of the present invention;

FIG. 17 is a flow chart showing operation of the proxy server according to the fourth exemplary embodiment;

FIG. 18 is a diagram showing a flow of data in the entire system including the proxy server according to the fourth exemplary embodiment;

FIG. 19 is a sequence diagram showing operation of the entire system including the proxy server according to the fourth exemplary embodiment;

FIG. 20 is a block diagram showing a structure of a proxy server according to a fifth exemplary embodiment of the present invention;

FIG. 21 is a flow chart showing operation of the proxy server according to the fifth exemplary embodiment;

FIG. 22 is a diagram showing a flow of data in the entire system including the proxy server according to the fifth exemplary embodiment;

FIG. 23 is a sequence diagram showing operation of the entire system including the proxy server according to the fifth exemplary embodiment;

FIG. 24 is a block diagram showing a structure of a proxy server according to a sixth exemplary embodiment of the present invention;

FIG. 25 is a flow chart showing operation of the proxy server according to the sixth exemplary embodiment;

FIG. 26 is a diagram showing a flow of data in the entire system including the proxy server according to the sixth exemplary embodiment;

FIG. 27 is a sequence diagram showing operation of the entire system including the proxy server according to the sixth exemplary embodiment;

FIG. 28 is a block diagram showing a structure of a proxy server according to a seventh exemplary embodiment of the present invention;

FIG. 29 is a flow chart showing operation of the proxy server according to the seventh exemplary embodiment;

FIG. 30 is a diagram showing a flow of data in the entire system including the proxy server according to the seventh exemplary embodiment;

FIG. 31 is a sequence diagram showing operation of the entire system including the proxy server according to the seventh exemplary embodiment;

FIG. 32 is a block diagram showing a structure of a proxy server according to an eighth exemplary embodiment of the present invention;

FIG. 33 is a flow chart showing operation of the proxy server according to the eighth exemplary embodiment;

FIG. 34 is a diagram showing a flow of data in the entire system including the proxy server according to the eighth exemplary embodiment;

FIG. 35 is a sequence diagram showing operation of the entire system including the proxy server according to the eighth exemplary embodiment;

FIG. 36 is a block diagram showing a structure of a proxy server according to a ninth exemplary embodiment of the present invention;

FIG. 37 is a flow chart showing operation of the proxy server according to the ninth exemplary embodiment;

FIG. 38 is a diagram showing a flow of data in the entire system including the proxy server according to the ninth exemplary embodiment;

FIG. 39 is a sequence diagram showing operation of the entire system including the proxy server according to the ninth exemplary embodiment;

FIG. 40 is a block diagram showing a structure of a proxy server according to a tenth exemplary embodiment of the present invention;

FIG. 41 is a flow chart showing operation of the proxy server according to the tenth exemplary embodiment;

FIG. 42 is a diagram showing a flow of data in the entire system including the proxy server according to the tenth exemplary embodiment;

FIG. 43 is a sequence diagram showing operation of the entire system including the proxy server according to the tenth exemplary embodiment;

FIG. 44 is a block diagram showing a structure of a proxy server according to an eleventh exemplary embodiment of the present invention;

FIG. 45 is a flow chart showing operation of the proxy server according to the eleventh exemplary embodiment;

FIG. 46 is a diagram showing a flow of data in the entire system including the proxy server according to the eleventh exemplary embodiment;

FIG. 47 is a sequence diagram showing operation of the entire system including the proxy server according to the eleventh exemplary embodiment;

FIG. 48 is a block diagram showing a structure of a proxy server according to a twelfth exemplary embodiment of the present invention;

FIG. 49 is a flow chart showing operation of the proxy server according to the twelfth exemplary embodiment;

FIG. 50 is a diagram showing a flow of data in the entire system including the proxy server according to the twelfth exemplary embodiment;

FIG. 51 is a sequence diagram showing operation of the entire system including the proxy server according to the twelfth exemplary embodiment;

FIG. 52 is a block diagram showing a structure of a proxy server according to a thirteenth exemplary embodiment of the present invention;

FIG. 53 is a flow chart showing operation of the proxy server according to the thirteenth exemplary embodiment;

FIG. 54 is a diagram showing a flow of data in the entire system including the proxy server according to the thirteenth exemplary embodiment;

FIG. 55 is a sequence diagram showing operation of the entire system including the proxy server according to the thirteenth exemplary embodiment;

FIG. 56 is a sequence diagram showing operation of Digest authentication in SIP according to related art;

FIG. 57 is a diagram showing a form of transmitting a REGISTER request to working and spare SIP servers by a user agent at the time of copying registration information according to the related art;

FIG. 58 is a diagram showing a form of transmitting a REGISTER request to the spare SIP server by the working SIP server at the time of copying registration information according to the related art; and

FIG. 59 is a diagram showing a form of arrangement of a proxy server between a user agent and an SIP server according to the related art.

### EXEMPLARY EMBODIMENTS

### First Exemplary Embodiment

Next, a first exemplary embodiment of the present invention will be detailed with reference to the drawings.

### (Structure of the First Exemplary Embodiment)

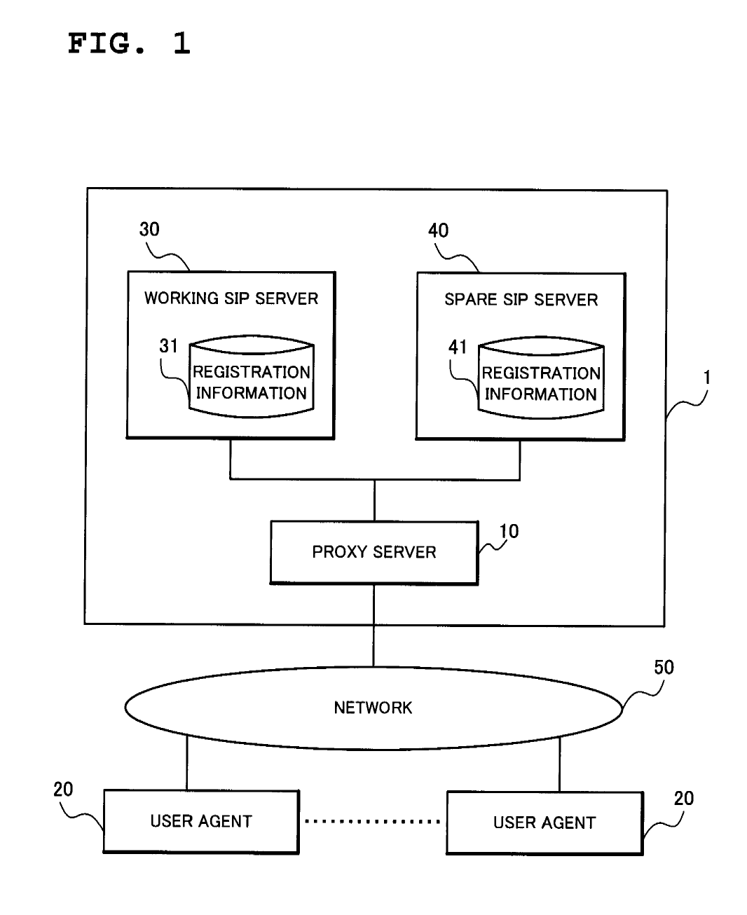

FIG. 1 is a block diagram showing a communication system according to the first exemplary embodiment of the present invention.

As shown in FIG. 1, in the communication system according to the first exemplary embodiment of the present invention, a proxy server 10 connected to a working SIP server 30 having registration information 31 and to a spare SIP server 40 on hot-standby having registration information 41 communicates with a user agent 20 through a network 50. Here, an SIP system 1 comprises the proxy server 10, the working SIP server 30 and the spare SIP server 40 and connects to the network 50.

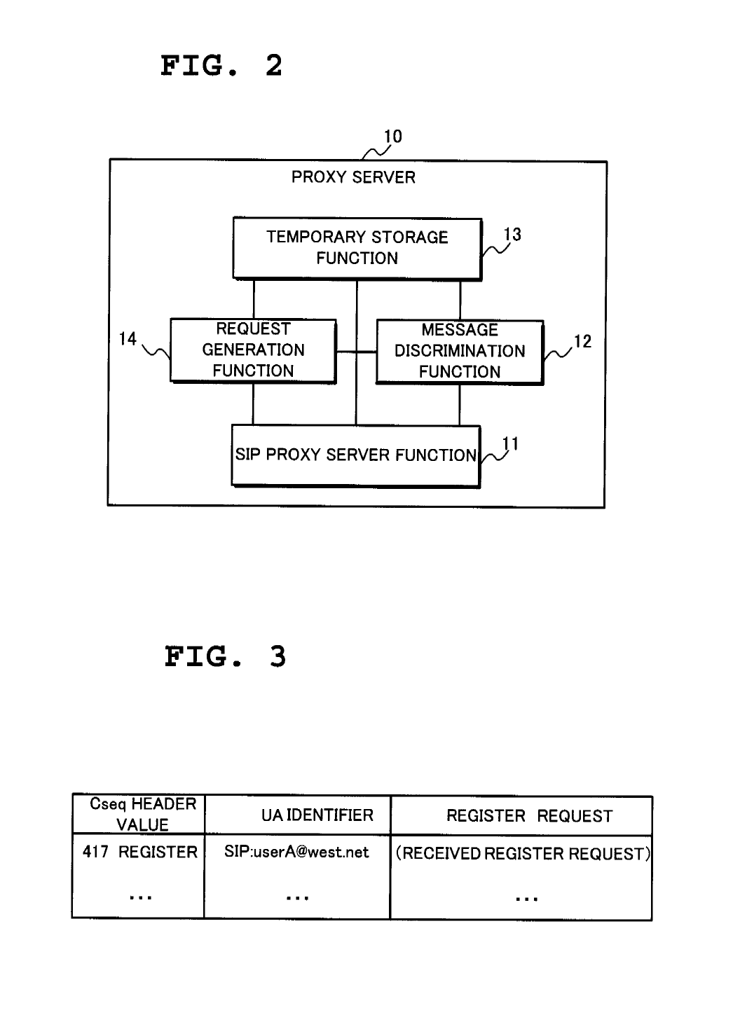

Next, FIG. 2 shows a block diagram of the proxy server 10 according to the first exemplary embodiment of the present invention.

As shown in FIG. 2, the proxy server 10 according to the first exemplary embodiment of the present invention comprises, in addition to an SIP proxy server function 11, a message discrimination function 12 for discriminating a kind and a transmission source of a message received by the SIP proxy server function 11, a temporary storage function 13 for temporally storing a REGISTER request received by the SIP proxy server function 11, and a request generation function 14 for generating initial and authentication REGISTER requests to be transferred to the spare SIP server.

The temporary storage function 13 stores a REGISTER request in a following manner, for example. FIG. 3 is a diagram showing one example of a storage form of a REGISTER request in the temporary storage function 13. As shown in the figure, the REGISTER request is stored in a table format which is formed of CSeq for use in searching a REGISTER request, a user agent identifier for identifying a transmission source which is to be stored in a From header of the REGISTER request, and a REGISTER request (REGISTER request received by the proxy server 10).

A user identifier and a password of a proxy server for use in Digest authentication executed by the proxy server 10 with the spare SIP server are held by the request generation function 14 because they are necessary at the time of generation of an authentication REGISTER request.

Accordingly, as the characteristics of the present exemplary embodiment, the proxy server 10 transmits/receives a REGISTER request to/from the spare SIP server 40 by Digest authentication using a user identifier and a password of the proxy server 10 itself.

Here, a hardware structure of the proxy server 10 will be described.

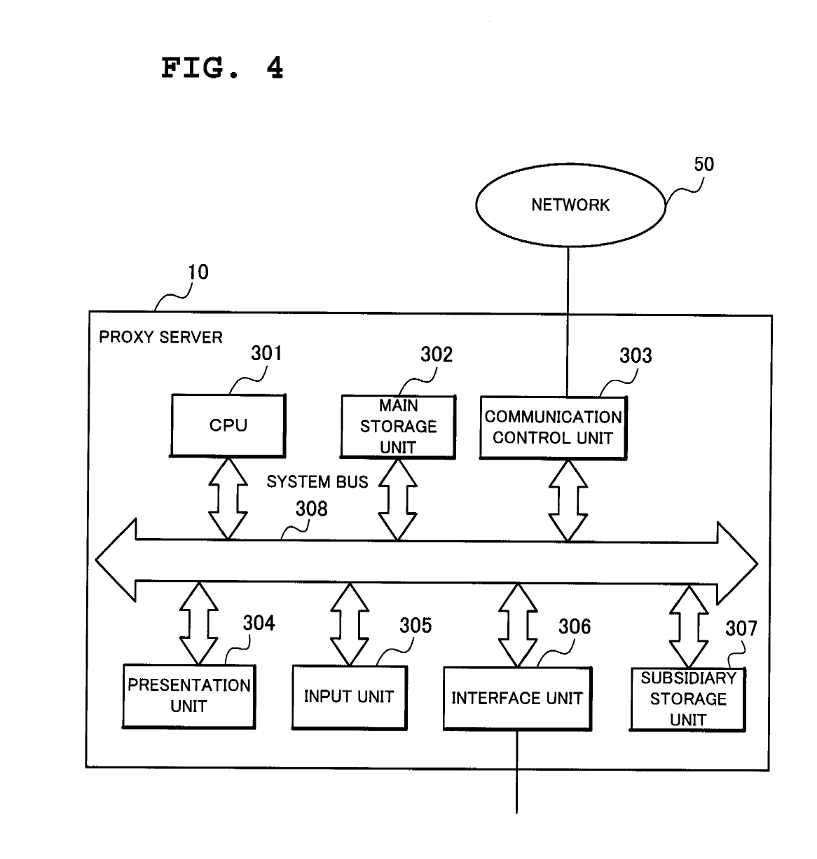

FIG. 4 is a block diagram showing a hardware structure of the proxy server 10 of the communication system according to the present exemplary embodiment.

With reference to FIG. 4, the proxy server 10 according to the present invention, which can be realized by the same hardware structure as that of a common computer device, comprises a CPU (Central Processing Unit) 301, a main storage unit 302, which is a main memory such as an RAM (Random Access Memory), for use as a data working region or a data temporary saving region, a communication control unit 303 for transmitting and receiving data through the network 50, a presentation unit 304 such as a liquid crystal display, a printer or a speaker, an input unit 305 such as a keyboard or a mouse, an interface unit 306 connected to a peripheral apparatus for transmitting and receiving data, a subsidiary storage unit 307 as a hard disk device formed of a non-volatile memory such as an ROM (Read Only Memory), a magnetic disk or a semiconductor memory, and a system bus 308 for connecting the respective components described above of the present information processing device with each other.

The proxy server 10 according to the present invention has its operation realized not only in hardware, with a circuit part mounted which is formed of a hardware component such as an LSI (Large Scale Integration) in which a program realizing such functions is incorporated but also in software by executing a program providing each function of the above-described respective components on the CPU 301 of the computer processing device.

More specifically, the CPU 301 loads the program stored in the subsidiary storage unit 307 onto the main storage unit 302 and executes the same to control operation of the proxy server 10, thereby realizing each of the above-described functions in software.

### (Operation of the First Exemplary Embodiment)

Next, operation of the proxy server 10 according to the first exemplary embodiment of the present invention will be detailed with reference to the drawings.

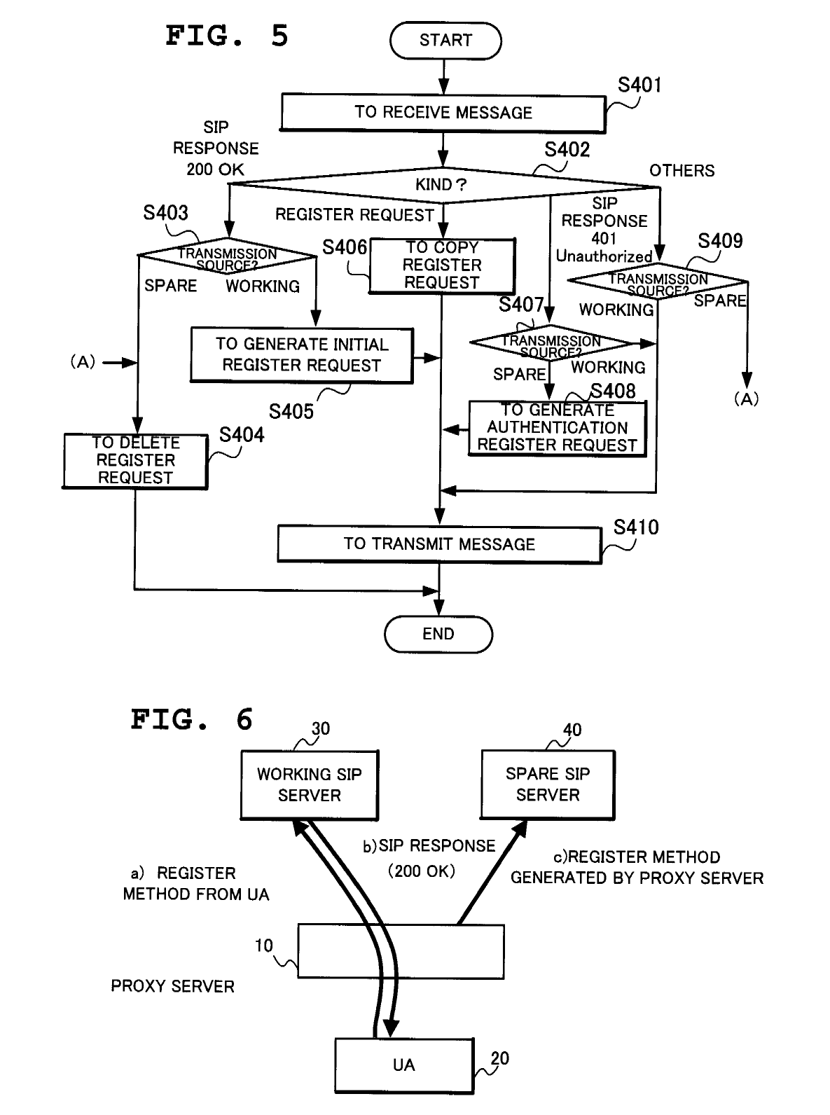

FIG. 5 is a flow chart showing operation of the proxy server 10 according to the first exemplary embodiment of the present invention.

Assume now that the SIP proxy server function 11 receives an external message (Step S401). Next, the message discrimination function 12 discriminates a kind of message received by the SIP proxy server function 11 (Step S402).

As a result of Step S402, when the received message is an SIP response (200 OK), the message discrimination function 12 further discriminates a transmission source of the above received message (Step S403).

As a result of Step S403, when the transmission source is a working SIP server, the request generation function 14 generates an initial REGISTER request to be transmitted to the spare SIP server (Step S405).

The generation processing is as follows, for example. First, the request generation function 14 selects a REGISTER request corresponding to the SIP response (200 OK) received at Step S401 among the REGISTER requests stored in the temporary storage function 13. The selection processing can be realized by searching a REGISTER request having the same values as values of a CSeq header and a From header in the SIP response (200 OK).

Next, the request generation function 14 copies the header value of the selected REGISTER request and changes the same as required to generate the above-described initial REGISTER request to be transmitted to the spare SIP server 40. Among headers to be changed are, for example, URI stored in a To header or a From header, a Call-ID header and a CSeq header.

Accordingly, as a result of Step S405, the proxy server 10 executes transmission/reception related to the initial REGISTER request generated by itself to/from the spare SIP server 40.

As a result of Step S402, when the received message is a REGISTER request, the temporary storage function 13 copies the received REGISTER request and stores the copy (Step S406).

The REGISTER request stored in this copying processing is made use of at the above-described Step S405. In the processing at Step S402 and Step S406, for excluding copying/storage of an improper REGISTER request from a user agent such as a DoS attack as much as possible, with a REGISTER request to be identified at Step S402 as an authentication REGISTER request, the authentication REGISTER request will be stored at Step S406.

As a result of Step S402, when the message received at Step S401 is an SIP response (401 Unauthorized), the message discrimination function 12 further discriminates a transmission source of the message (Step S407).

As a result of Step S407, when the transmission source of the SIP response (401 Unauthorized) is a spare SIP server, the request generation function 14 generates an authentication REGISTER request to be transferred to the spare SIP server in order to complete Digest authentication with the spare SIP server (Step S408).

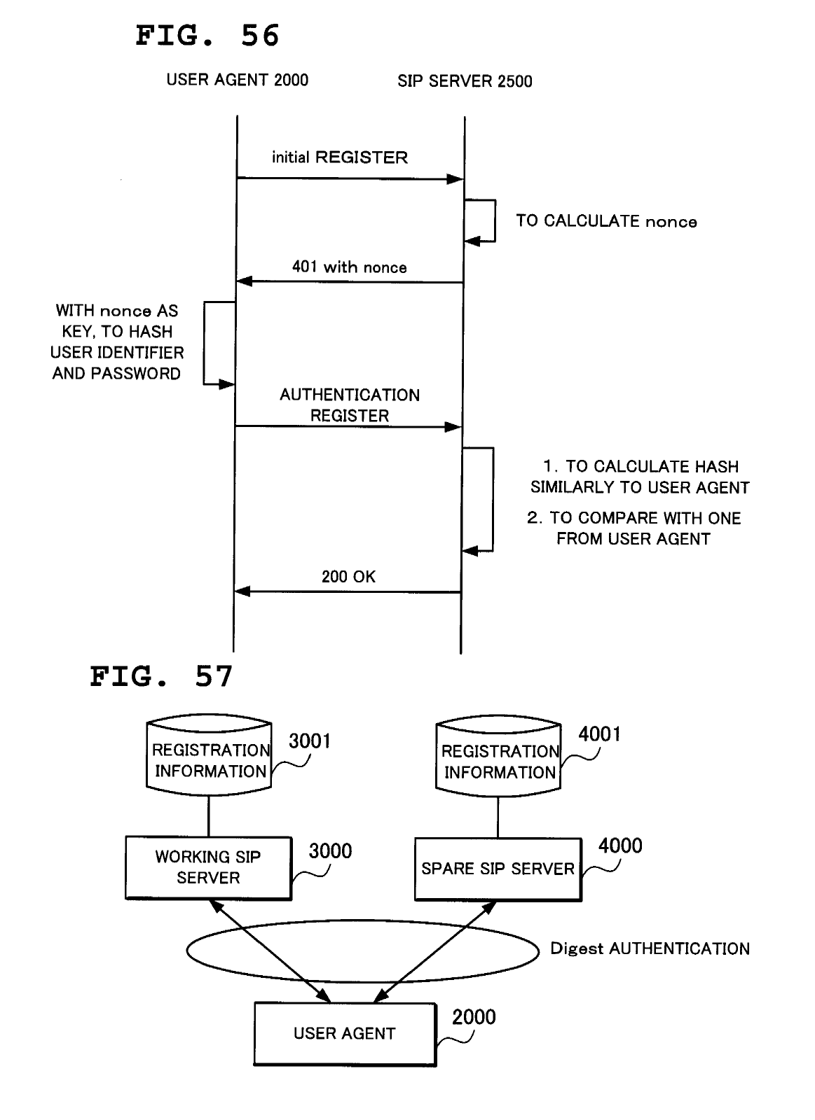

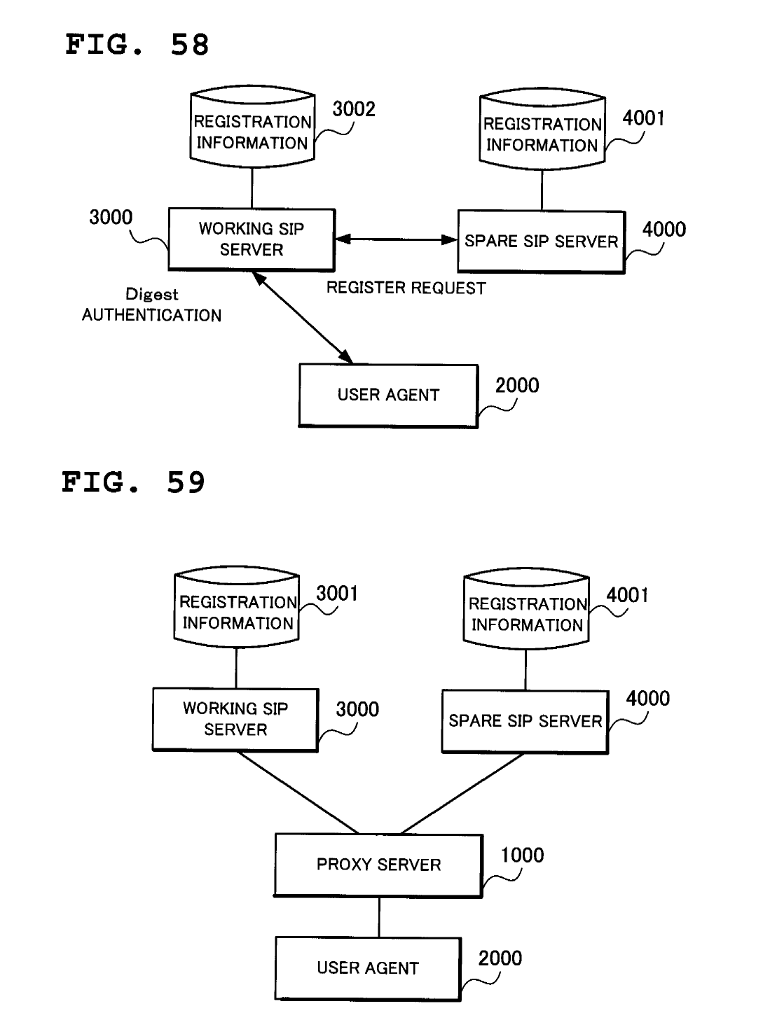

The generation processing conforms to general Digest authentication shown in FIG. 56. More specifically, with a nonce value stored in the SIP response (401 Unauthorized) as a key, the request generation function 14 hashes a pair of a user identifier and a password of the proxy server 10 itself by MD5 (message digest 5) as one of hash functions for use in authentication or digital signature and thereafter generates an authentication REGISTER request by the same processing as that of the initial REGISTER message generation at Step S405. Here, the difference from Step S405 is having an Authorization header provided and storing a calculated hash value in the header.

Accordingly, as a result of Step S408, the proxy server 10 transmits/receives the authentication REGISTER request to/from the spare SIP server 40 by Digest authentication using the user identifier and the password of the proxy server 10 itself.

As a result of Step S402, when the received message is none of the SIP response (200 OK), the REGISTER request and the SIP response (401 Unauthorized), the message discrimination function 12 further discriminates a transmission source of the message (Step S409).

As a result of Step S409, when a transmission source is the working SIP server, or as a result of Step S405, when an initial REGISTER request to be transmitted to the spare SIP server is generated, or as a result of Step S406, when a REGISTER request transmitted from the user agent is copied/stored, or as a result of Step S408, when an authentication REGISTER to be transmitted to the spare SIP server is generated, or as a result of Step S407, when a transmission source of the SIP response (401 Unauthorized) is the working SIP server, the SIP proxy server function 11 transmits the message received at Step S401 to a destination designated or the initial and authentication REGISTER requests to the spare SIP server (Step S410).

As a result of Step S403, when the transmission source of the SIP response (200 OK) is the spare SIP server or as a result of Step S409, when a transmission source of other SIP response is the spare SIP server, delete a REGISTER request stored by the temporary storage function 13 (Step S404).

The deletion processing can be realized by searching a REGISTER request having the same values as those of the CSeq header and the From header of the SIP response received at Step S401.

As a result of Step S404, when the REGISTER request in question is deleted or as a result of Step S410, when the SIP proxy server function 11 transmits a message, end the processing.

Next, operation of the entire system including the proxy server 10 according to the first exemplary embodiment of the present invention will be detailed with reference to the drawings.

First, FIG. 6 shows a data flow in the entire system including the proxy server 10 according to the first exemplary embodiment of the present invention.

As shown in FIG. 6, in this system, a REGISTER request transmitted from the user agent 20 is always transferred to the working SIP server 30 (a in FIG. 6). At the same time, the REGISTER request is copied and held by the proxy server 10.

After receiving the SIP response (200 OK) from the working SIP server 30 (b in FIG. 6), the proxy server 10 generates a REGISTER request to be transmitted to the spare SIP server 40 based on the copied REGISTER request and transfers the same to the spare SIP server 40 (c in FIG. 6).

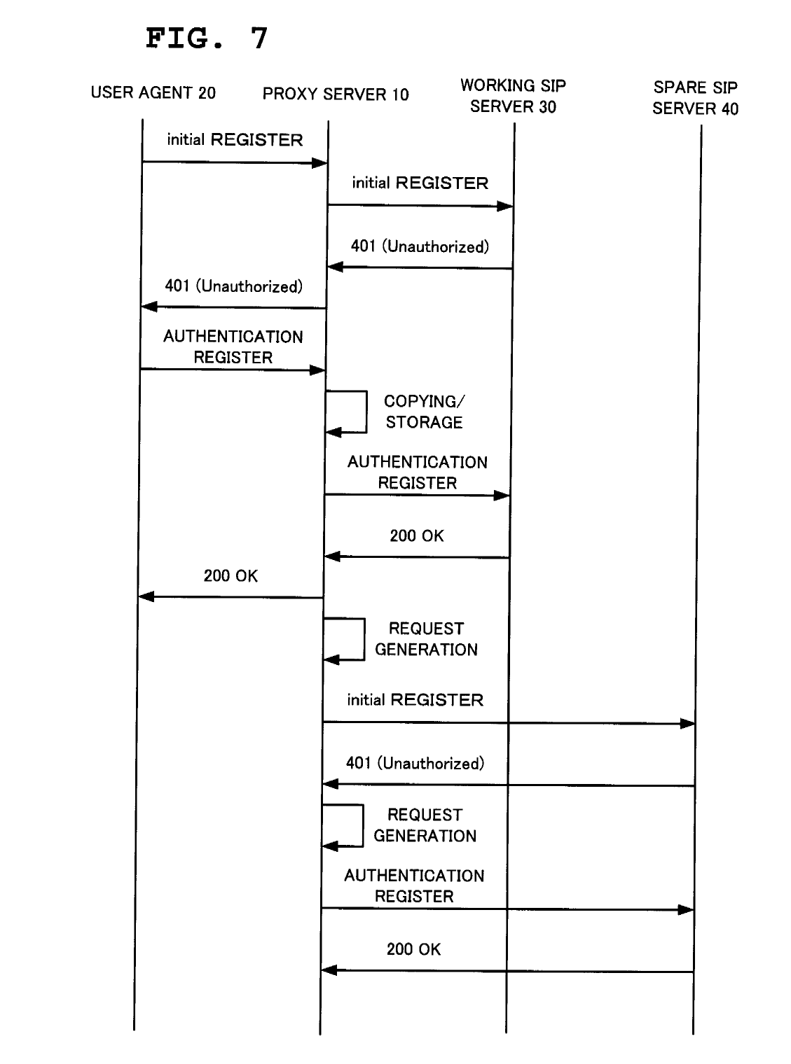

Shown in FIG. 7 is an operation sequence of the entire system including the proxy server 10 according to the first exemplary embodiment of the present invention. In this figure, illustrated is a case of copying an authentication REGISTER request from the user agent 20 by the proxy server 10.

As shown in FIG. 7, after confirming processing completion of the REGISTER request directed to the working SIP server 30 from the user agent 20 (after reception of 200 OK), the proxy server 10 transmits a REGISTER request generated based on the user identifier and the password of the proxy server 10 itself and the REGISTER request received from the user agent 20 to the spare SIP server 40 to execute Digest authentication with the spare SIP server 40.

### (Effects of the First Exemplary Embodiment)

Thus, the present exemplary embodiment enables properness of one who makes an access (proxy server 10) and of a REGISTER request which is to be transmitted to be presented to the spare SIP server 40.

The reason is that after confirming normal completion of processing of a REGISTER request transmitted from the user agent 20, the system including the proxy server 10 holding a user identifier and a password of the proxy server 10 itself executes Digest authentication with the spare SIP server 40 to transmit a REGISTER request generated based on the REGISTER request whose normal processing is completed (copy of a request processed by the working SIP server 30) to the spare SIP server 40.

The present exemplary embodiment also facilitates application to an existing user agent and an existing SIP server technically and economically and enables active and mutual backup of registration information between the working SIP server 30 and the spare SIP server 40.

The reason is that because copying/transmission of a REGISTER request is taken charge of by the proxy server 10, the user agent 20 only needs to transmit a REGISTER request to the proxy server 10 according to a registration information update procedure defined by SIP and each SIP server only needs to process, based on its function, a REGISTER request authenticated according to common Digest authentication. As a result, pieces of the registration information of the working SIP server 30 and the spare SIP server 40 are both updated upon transmission of the REGISTER request by the user agent 20. Moreover, since in each SIP server, a REGISTER request generated by the proxy server 10 for registration information copying and a REGISTER request transmitted by the user agent 20 are similarly processed, the SIP system 1 enables mixed transmission of the REGISTER request transmitted by the user agent 20 and the REGISTER request generated by the proxy server 10 to each SIP server. These characteristics enable active and mutual backup of registration information.

Furthermore, the present exemplary embodiment enables the volume of traffic related to registration information update between the user agent 20 and the SIP server to be suppressed.

The reason is that transmission of a REGISTER request to the spare SIP server 40 is executed by the proxy server 10 located in-between the working SIP server 30 and the user agent 20. In other words, while in general, a personal computer or a cellular phone at which the user agent 20 exists has a much narrower band of an access network connected than a band of a core network in which an SIP server exists, the proxy server 10 realizes copying/transmission of a REGISTER request to reduce the number of REGISTER requests transmitted from the user agent 20, resulting in suppressing a band for use in the access network.

### Second Exemplary Embodiment

Next, a proxy server 10 according to a second exemplary embodiment of the present invention will be detailed with reference to the drawings.

### (Structure of the Second Exemplary Embodiment)

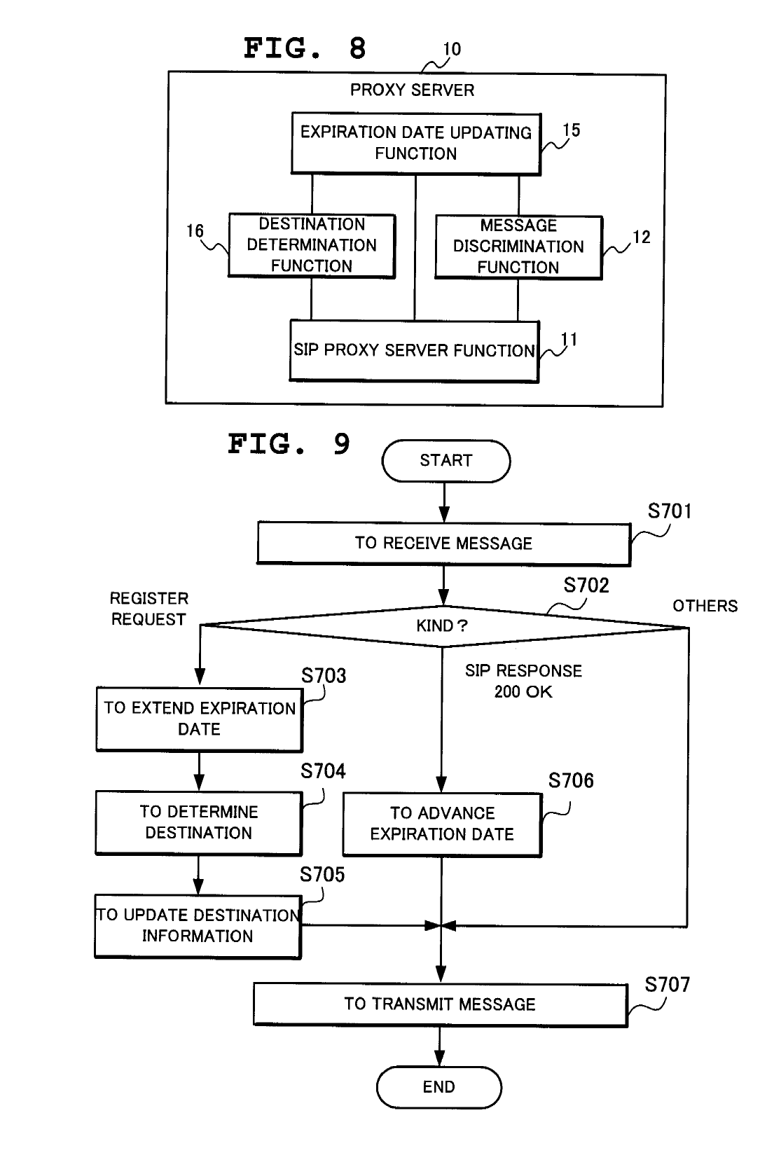

FIG. 8 is a block diagram showing a structure of the proxy server 10 according to the second exemplary embodiment of the present invention.

As shown in FIG. 8, the proxy server 10 according to the second exemplary embodiment of the present invention comprises, in addition to the common SIP proxy server function 11, the message discrimination function 12 for identifying a kind of message received by the SIP proxy server function 11, an expiration date updating function 15 for changing (increase/decrease) a value of an Expires header included in a message received by the SIP proxy server function 11, and a destination determination function 16 for determining a transmission destination of a REGISTER request based on information (destination information) to be referred to at the time of determining a destination of a REGISTER request.

Destination information is realized, for example, as a pair of the user agent 20 and a REGISTER request transfer destination and is held by the destination determination function 16.

### (Operation of the Second Exemplary Embodiment)

Next, operation of the proxy server 10 according to the second exemplary embodiment of the present invention will be detailed with reference to the drawings.

FIG. 9 is a flow chart showing operation of the proxy server 10 according to the second exemplary embodiment of the present invention.

Assume now that the SIP proxy server function 11 receives an external message (Step S701). Next, the message discrimination function 12 discriminates a kind of message received by the SIP proxy server function 11 (Step S702).

As a result of Step S702, when the received message is a REGISTER request, the expiration date updating function increases a value of the Expires header of the REGISTER request (Step S703).

In the updating processing, the value of the Expires header in question is increased according to the number of spare SIP servers such as double when one spare SIP server 40 exists and triple when two spare SIP servers 40 exist.

Next, the destination determination function 16 determines a transmission destination of the REGISTER request (Step S704).

The determination processing can be realized as follows, for example. More specifically, the destination determination function 16 refers to an identifier of the user agent 20 recited in the From header of the REGISTER request to obtain a transfer destination of the REGISTER request from the user agent 20 in question based on destination information. Recited in the transfer destination is the working SIP server 30 or the spare SIP server 40.

At Step S704, when the REGISTER request is an initial REGISTER request, the destination determination function 16 determines a transfer destination not recited in the relevant transfer destination (when recited is the working SIP server 30, “the spare SIP server 40”) as a transmission destination of the REGISTER request, while when the REGISTER is an authentication REGISTER request, determines the transfer destination in question as a transfer destination of the REGISTER request.

Thereafter, the destination determination function 16 makes the destination determined at Step S704 be reflected on the destination information (Step S705).

As a result of Step S702, when the message received by the SIP proxy server function 11 is the SIP response (200 OK), the expiration date updating function 15 decreases the value of the Expires header of the relevant SIP response (Step S706).

The updating processing decreases the amount of increase made by the updating processing at Step S703. More specifically, when the Expires header value of the REGISTER request is doubled at Step S703, for example, the expiration date updating function 15 halves the Expires header value at Step S705.

When as a result of Step S702, the kind of the message received by the SIP proxy server function 11 is neither a REGISTER request nor the SIP response (200 OK), or when as a result of Step S705, update of destination information is completed or when as a result of Step S706, the value of the Expires header of the SIP response (200 OK) is decreased, the SIP proxy server function 11 transmits the message to a designated destination (Step S707). Designated destination is a destination determined at Step S704 in a case of a REGISTER request and otherwise, it is a destination recited in the message received by the SIP proxy server function 11.

Next, operation of the entire system including the proxy server 10 according to the second exemplary embodiment of the present invention will be detailed with reference to the drawings.

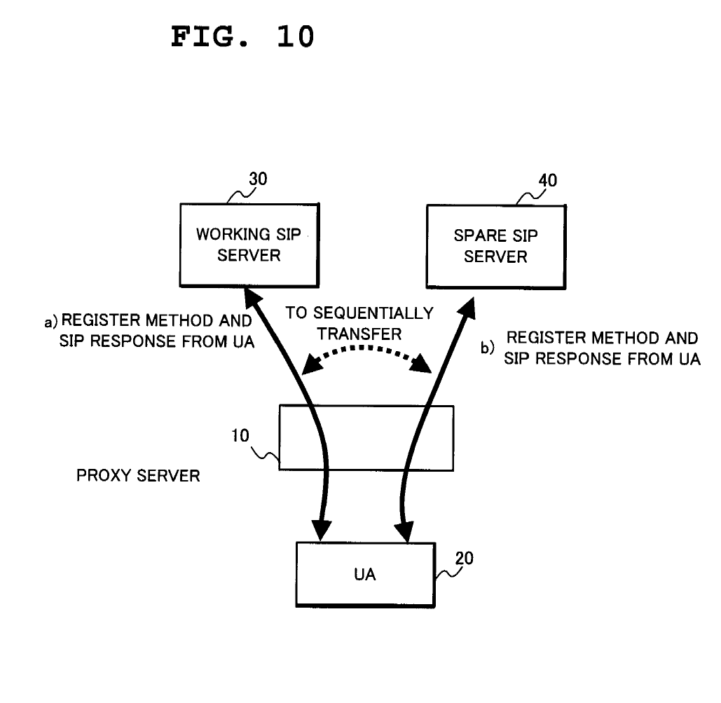

First, FIG. 10 shows a flow of data in the entire system including the proxy server 10 according to the second exemplary embodiment of the present invention.

As shown in FIG. 10, in this system, REGISTER requests transmitted from the user agent 20 are not all transmitted to the working SIP server 30. The proxy server 10 sequentially transfers a REGISTER request to the working SIP server 30 and the spare SIP server 40 such as first transferring to the working SIP server 30 and then to the spare SIP server 40 (a and b in FIG. 10). In other words, a REGISTER request is transferred to each of the working SIP server 30 and the spare SIP server 40 once in several times. In this situation, for preventing invalidation of registration information related to the user agent 20, the proxy server 10 changes an expiration date of a REGISTER request received from the user agent 20 to transfer the REGISTER request to the working SIP server 30 and the spare SIP server 40.

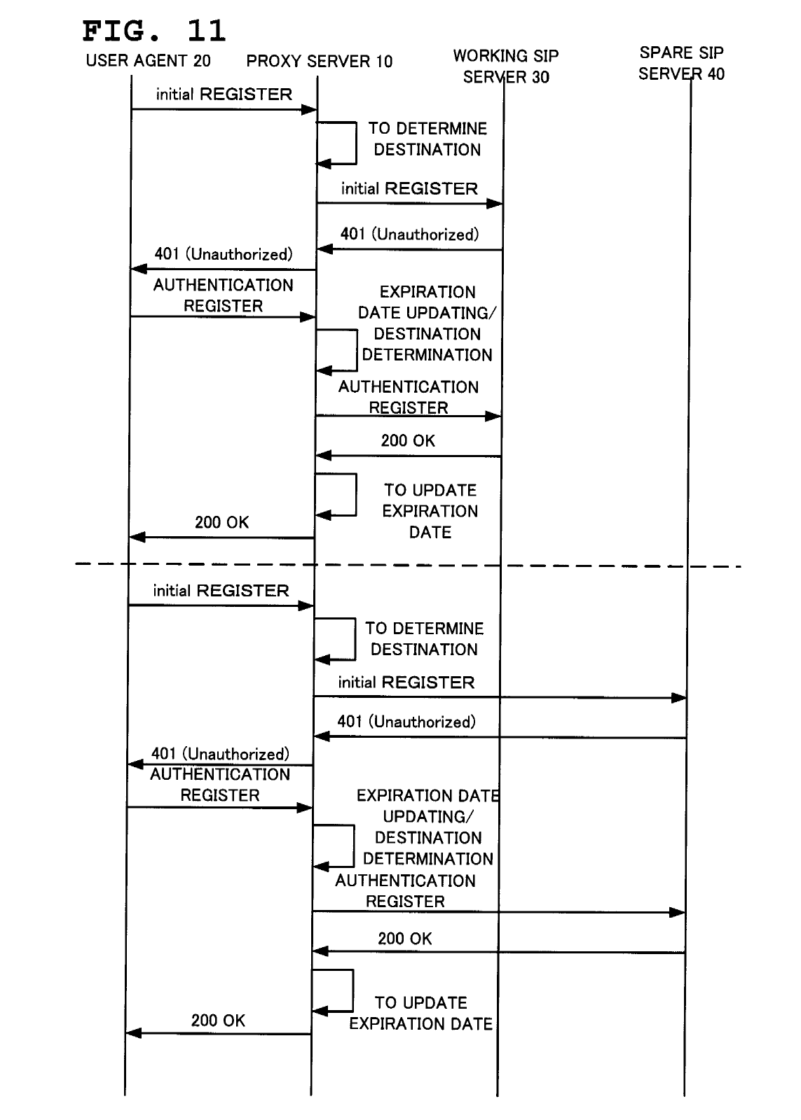

Shown in FIG. 11 is an operation sequence of the entire system including the proxy server 10 according to the second exemplary embodiment.

As shown in FIG. 11, when receiving an initial REGISTER request from the user agent 20, the proxy server 10 determines to which of the working SIP server 30 and the spare SIP server 40, the REGISTER request should be transmitted, while when receiving an authentication REGISTER request from the user agent 20, it transfers the authentication REGISTER request to a destination to which the initial REGISTER request is transmitted for completing Digest authentication.

### (Effects of the Second Exemplary Embodiment)

The present exemplary embodiment enables copying of registration information of each SIP server by using only a user ID (user agent identifier) and a password for identifying the user agent 20 which is held by the user agent 20.

The reason is that with the provision of the destination determination function 16, Digest authentication executed between the user agent 20 and the working SIP server 30 is executed also between the user agent 20 and the spare SIP server 40.

The present exemplary embodiment also prevents registration information of even a REGISTER request arriving at each SIP server once in several times from expiring.

The reason is that the expiration date updating function 15 increases a value of the Expires header of an authentication REGISTER request.

The present exemplary embodiment also facilitates application to an existing user agent and an existing SIP server technically and economically and enables active and mutual backup of registration information between the working SIP server 30 and the spare SIP server 40. As a result, a REGISTER request issued by the user agent 20 will be sequentially transferred to the working or spare SIP server 40, so that registration information will be appropriately updated at an interval on the order of an Expires header value. Moreover, since in each SIP server, a REGISTER request whose destination is changed by the proxy server 10 for copying registration information and a REGISTER request transmitted by the user agent 20 are similarly processed, the SIP system 1 is allowed to transmit a REGISTER request transmitted by the user agent 20 and a REGISTER request whose destination is changed by the proxy server 10 by mixture to each SIP server. These characteristics enable active and mutual back-up of registration information.

The reason is that since the proxy server 10 executes change of a transmission destination of a REGISTER request and adjustment of a value of an Expires header, the request is processed as an ordinary REGISTER request in view of the user agent 20 and each SIP server similarly to the first exemplary embodiment.

Also according to the present exemplary embodiment, unlike the first exemplary embodiment, the proxy server 10 needs not to hold its own user identifier and password.

The reason is that with the provision of the destination determination function 16, Digest authentication is executed between the user agent 20 and the spare SIP server 40, so that no Digest authentication is required between the proxy server 10 and the spare SIP server 40 and no message generation is required at the proxy server 10.

### Third Exemplary Embodiment

Next, a proxy server 10 according to a third exemplary embodiment of the present invention will be detailed with reference to the drawings.

### (Structure of the Third Exemplary Embodiment)

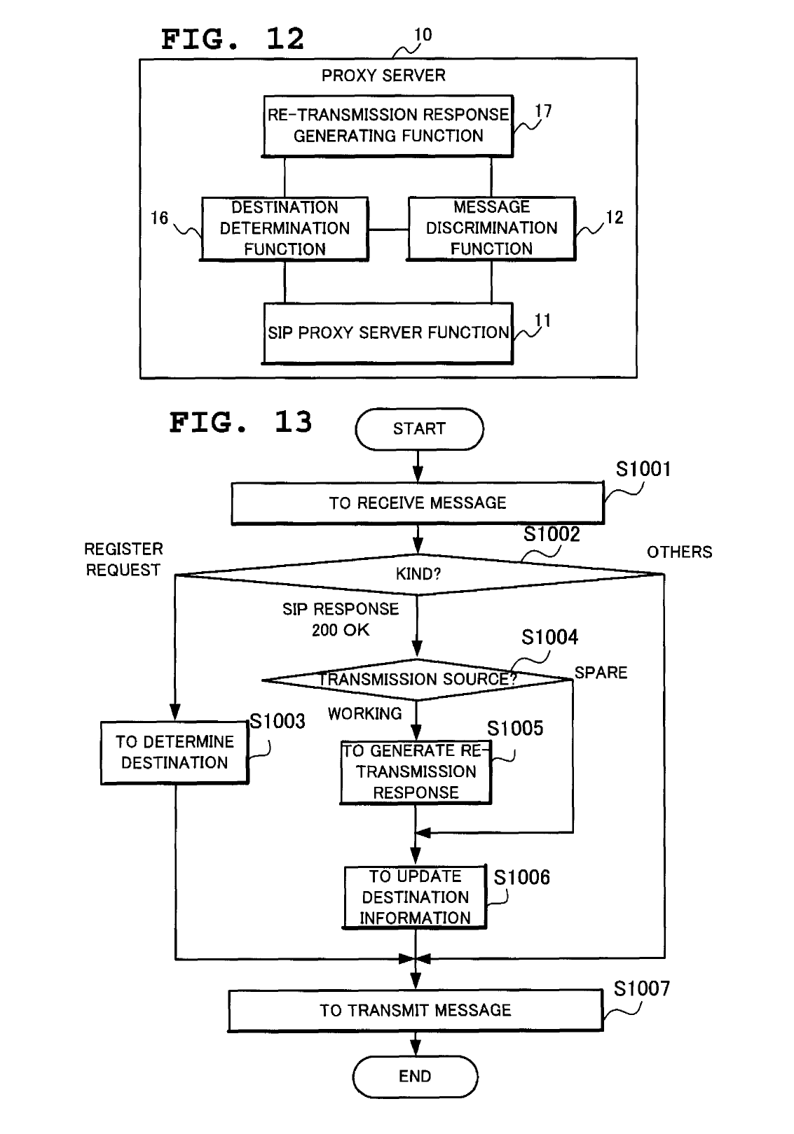

FIG. 12 is a block diagram showing a structure of the proxy server 10 according to the third exemplary embodiment of the present invention.

As shown in FIG. 12, the proxy server 10 according to the third exemplary embodiment of the present invention comprises, in addition to the SIP proxy server function 11, the message discrimination function 12 for identifying a kind and a transmission source of a message, a re-transmission response generating function 17 for generating an SIP response (re-transmission response) urging a user agent to re-transmit an initial REGISTER request, and the destination determination function 16 for determining a transfer destination of a REGISTER request with reference to destination information.

Destination information, similarly to the proxy server 10 according to the second exemplary embodiment of the present invention, is a pair of the user agent 20 and a transmission destination of a REGISTER request, for example, which is held by the destination determination function 16.

### (Operation of the Third Exemplary Embodiment)

Next, operation of the proxy server 10 according to the third exemplary embodiment of the present invention will be detailed with reference to the drawings.

FIG. 13 is a flow chart showing operation of the proxy server 10 according to the third exemplary embodiment of the present invention.

Assume now that the SIP proxy server function 11 receives an external message (Step S1001). Next, the message discrimination function 12 discriminates a kind of message received by the SIP proxy server function 11 (Step S1002).

As a result of Step S1002, when the kind of the message received by the SIP proxy server function 11 is a REGISTER request, the destination determination function 16 determines a transmission destination of the REGISTER request (Step S1003).

This determination processing can be realized by the following manner, for example. The destination determination function 16 searches destination information based on an identifier of the user agent 20 recited in a From header of the received REGISTER request. As a result of the search, the destination determination function 16 considers a transmission destination recited in the destination information as a transmission destination of the REGISTER request.

On the other hand, as a result of Step S1002, when the kind of the message received by the SIP proxy server function 11 is the SIP response (200 OK), the message discrimination function 12 further discriminates a transmission source of the message (Step S1004).

As a result of Step S1004, when the transmission source is the working SIP server 30, the re-transmission response generating function 17 generates a re-transmission response for causing the user agent 20 to re-transmit an initial REGISTER request (Step S1005).

In this generation processing, for example, the SIP proxy server function 11 adds a “Retry-After header” to an SIP response (503 Service Unavailable) indicating that SIP “is not allowed to use service”, so that the user agent 20 having received the response will transfer the initial REGISTER request to the proxy server 10 again after a lapse of the Retry-After header value. As other headers, an SIP response (200 OK) from the working SIP server 30 is used. As another method of the generation processing, the SIP proxy server function 11 transmits an SIP response (408 Request Timeout) to the user agent 20, so that the user agent 20 re-transmits the SIP request without modification to the proxy server 10 any time after reception of the SIP response.

When a transmission source of the SIP response (200 OK) is the spare SIP server 40 as a result of Step S1004 or when generation of a re-transmission response to the user agent is completed as a result of Step S1005, the destination determination function 16 updates the destination information (Step S1006).

This update processing is as follows, for example. First, the destination determination function 16 refers to the user agent 20 recited in a To header of the SIP response (200 OK) to search destination information. When the SIP response (200 OK) is transmitted from the working SIP server 30, the destination determination function 16 changes a transfer destination of the REGISTER request in the relevant destination information to “the spare SIP server 40”. On the other hand, when the SIP response (200 OK) is transmitted from the spare SIP server 40, the destination determination function 16 changes the transfer destination of the REGISTER request in the relevant destination information to “the working SIP server 30”.

When the message received by the SIP proxy server function 11 is neither a REGISTER request nor the SIP response (200 OK) as a result of Step S1002, or when a transmission destination of the REGISTER request is determined as a result of Step S1003, or when the destination information is updated as a result of Step S1006, the SIP proxy server function 11 transmits the message to the designated destination (Step S1007).

At this time, the REGISTER request is transmitted to the destination determined at step S1003, and other SIP response than the SIP response (200 OK) from the working SIP server 30 and a re-transmission response generated at Step S1005 are transmitted to the user agent 20.

Next, operation of the entire system including the proxy server 10 according to the third exemplary embodiment of the present invention will be detailed with reference to the drawings.

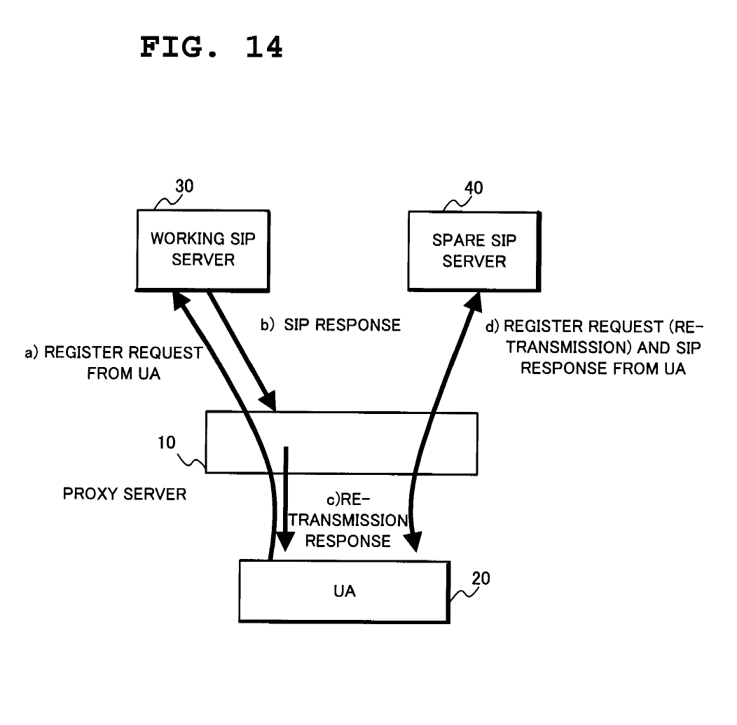

First, FIG. 14 shows a data flow in the entire system including the proxy server 10 according to the third exemplary embodiment of the present invention.

As shown in FIG. 14, the proxy server 10 having received the SIP response (200 OK) (b in FIG. 14) indicative of the end of processing of the REGISTER request (a in FIG. 14) transmitted from the user agent 20 transmits a re-transmission response of the REGISTER request to the user agent 20 (c in FIG. 14).

The user agent 20 having received the re-transmission response transmits another REGISTER request to the proxy server 10 according to the processing defined by an SIP protocol code, so that the proxy server 10 transfers the re-transmitted REGISTER request to the spare SIP server 40 (d in FIG. 14).

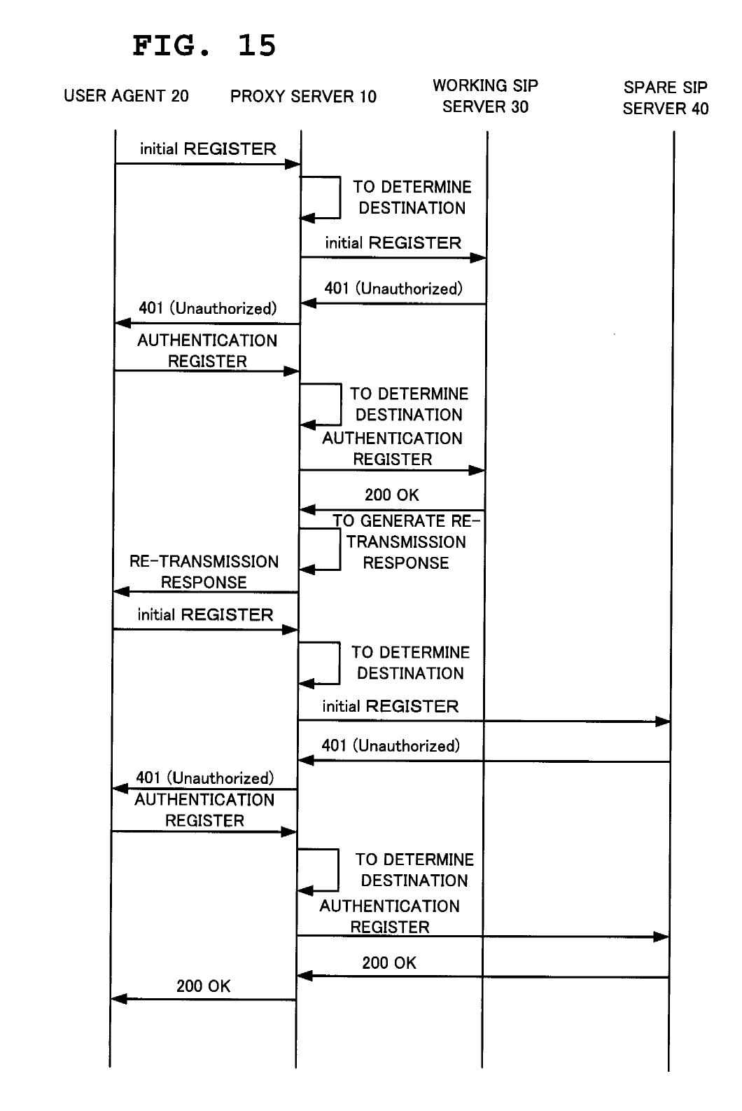

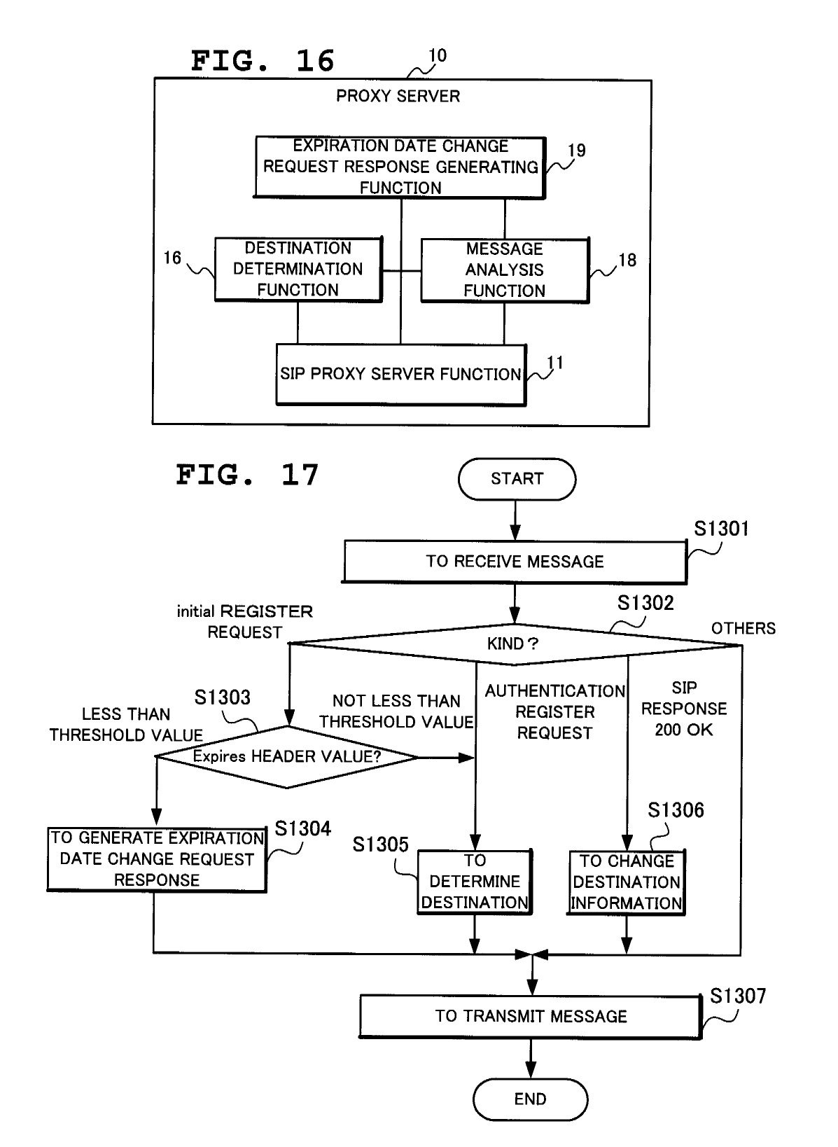

Next, shown in FIG. 15 is an operation sequence of the entire system including the proxy server 10 according to the third exemplary embodiment of the present invention.

As shown in FIG. 15, in the system including the proxy server 10 according to the present exemplary embodiment, when the processing of a REGISTER request at the working SIP server 30 is completed (SIP response (200 OK) is received), a re-transmission response of an initial REGISTER request is transmitted to the user agent 20, based on which the initial REGISTER request transmitted by the user agent 20 is transferred to the spare SIP server 40, thereby enabling registration information of the working/spare SIP server to be updated while executing Digest authentication. The user agent 20 recognizes that although first REGISTER request processing fails, update of registration information is completed by the re-transmission processing according to an SIP requirement. On the other hand, the working SIP server 30 recognizes the processing as ordinary REGISTER request processing.

### (Effects of the Third Exemplary Embodiment)

According to the present exemplary embodiment, registration information of each SIP server can be copied using only a user ID (user agent identifier) and a password for identifying the user agent 20 which are held by the user agent 20.

The reason is that with the provision of the re-transmission response generating function 17 and the destination determination function 16, even when update of registration information at the working SIP server 30 succeeds, a failure of registration information processing is transmitted to the user agent 10 to induce another registration information processing at the user agent 20 and a REGISTER request re-transmitted from the user agent 20 is transferred to the spare SIP server 40 to cause Digest authentication to be executed between the user agent 20 and the spare SIP server 40.

Also according to the present exemplary embodiment, registration information of the working SIP server 30 and the spare SIP server 40 can be updated while executing Digest authentication without generation of a message directed to the spare SIP server 40 at the proxy server 10.

The reason is that in the system including the proxy server 10 according to the present exemplary embodiment, when processing of a REGISTER request is completed at the working SIP server 30 (SIP response (200 OK) is received), a re-transmission response of an initial REGISTER request is transmitted to the user agent 20, based on which re-transmission response, the user agent 20 receives the initial REGISTER request transmitted and transfers the same to the spare SIP server 40.

### Fourth Exemplary Embodiment

Next, a proxy server 10 according to a fourth exemplary embodiment of the present invention will be detailed with reference to the drawings.

### (Structure of the Fourth Exemplary Embodiment)

FIG. 16 is a block diagram showing a structure of the proxy server 10 according to the fourth exemplary embodiment of the present invention.

As shown in FIG. 16, the proxy server 10 according to the fourth exemplary embodiment of the present invention comprises, in addition to the SIP proxy server function 11, a message analysis function 18 for analyzing a kind of message received by the SIP proxy server function 11 and when the received message is an initial REGISTER request, further analyzing an Expires header, an expiration date change request response generating function 19 for generating an SIP response which informs the user agent 20 to change a value of an Expires header when a value of the Expires header of an initial REGISTER request is less than a certain threshold value, and the destination determination function 16 for determining a transfer destination of a REGISTER request with reference to destination information.

Destination information, similarly to the proxy server 10 according to the second and third exemplary embodiments of the present invention, is a pair of the user agent 20 and a transmission destination of a REGISTER request, for example, which is held by the destination determination function 16.

### (Operation of the Fourth Exemplary Embodiment)

Next, operation of the proxy server 10 according to the fourth exemplary embodiment of the present invention will be detailed with reference to the drawings.

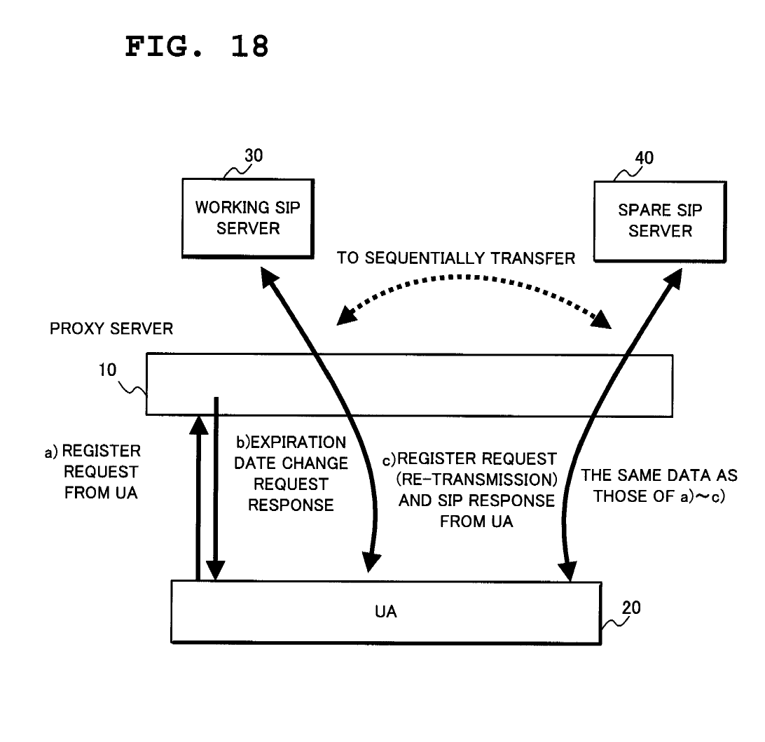

FIG. 17 is a flow chart showing operation of the proxy server 10 according to the fourth exemplary embodiment of the present invention.

Assume now that the SIP proxy server function 11 receives an external message (Step S1301). Next, the message analysis function 18 discriminates a kind of message received by the SIP proxy server function 11 (Step S1302).

As a result of Step S1302, when the received message is an REGISTER request, the message analysis function 18 further refers to an initial Expires header of the initial REGISTER request (Step S1303).

As a result of Step S1303, when a value of the Expires header is less than a certain threshold value, the expiration date change request response generating function 19 generates an expiration date change request response (Step S1304).

Here, similarly to the proxy server 10 according to the second exemplary embodiment of the present invention, this threshold value is determined in advance according to the number of spare SIP servers such as when one spare SIP server 40 exists, double a standard Expires header value (3600 sec.) or when two spare SIP servers 40 exist, triple the value.

Moreover, possible as an SIP response generated by the expiration date change request response generating function 19 at Step S1304 is, for example, 423 (Interval Too Brief).

This SIP response is to be transmitted to the user agent 20 when an expiration date and time of registration information to be refreshed by a REGISTER request is too short. Since this SIP response (423 Interval Too Brief) enables designation of an expiration date to be required for a Min-Expires header, the above-described threshold value is used, for example.

As a result of Step S1303, when the Expires header value is not less than the threshold value, or as a result of Step S1302, when a received message is an authentication REGISTER request, the destination determination function 16 refers to the destination information to determine a destination of the REGISTER request (Step S1305).

This determination processing can be realized by the following manner, for example. Destination information is searched based on an identifier of the user agent 20 recited in a From header of initial and authentication REGISTER requests. As a result of the search, the transmission destination recited in the destination information is considered as a transmission destination of the initial and authentication REGISTER requests.

On the other hand, as a result of Step S1302, when the received message is an SIP response (200 OK), update the destination information held by the destination determination function 16 (Step S1306).

This updating processing can be realized by the following manner, for example. The destination determination function 16 searches destination information based on an identifier of the user agent 20 recited in a From header of an received SIP response (200 OK). Next, the destination determination function 16 examines a transmission source of the received SIP response (200 OK) and when the transmission source is the working SIP server 30, considers the transmission destination obtained as a result of the search as “the spare SIP server 40” and when the transmission source is the spare SIP server 40, considers the transmission destination obtained as a result of the search as “the working SIP server 30”.

As a result of Step S1302, when the received message is other than an initial or authentication REGISTER request and an SIP response (200 OK), or as a result of Step S1304, when the expiration date change request response function 19 generates an expiration date change request response to the user agent 20, or as a result of Step S1305, when a destination of an initial or authentication REGISTER request is determined, or as a result of Step S1306, when update of the destination information is completed, the SIP proxy server function 11 transmits a message to a designated destination (Step S1307). More specifically, the initial or authentication REGISTER request is transmitted to an SIP server determined at Step S1306 and the others are transmitted to the user agent 20.

Next, operation of the entire system including the proxy server 10 according to the fourth exemplary embodiment of the present invention will be detailed with reference to the drawings.

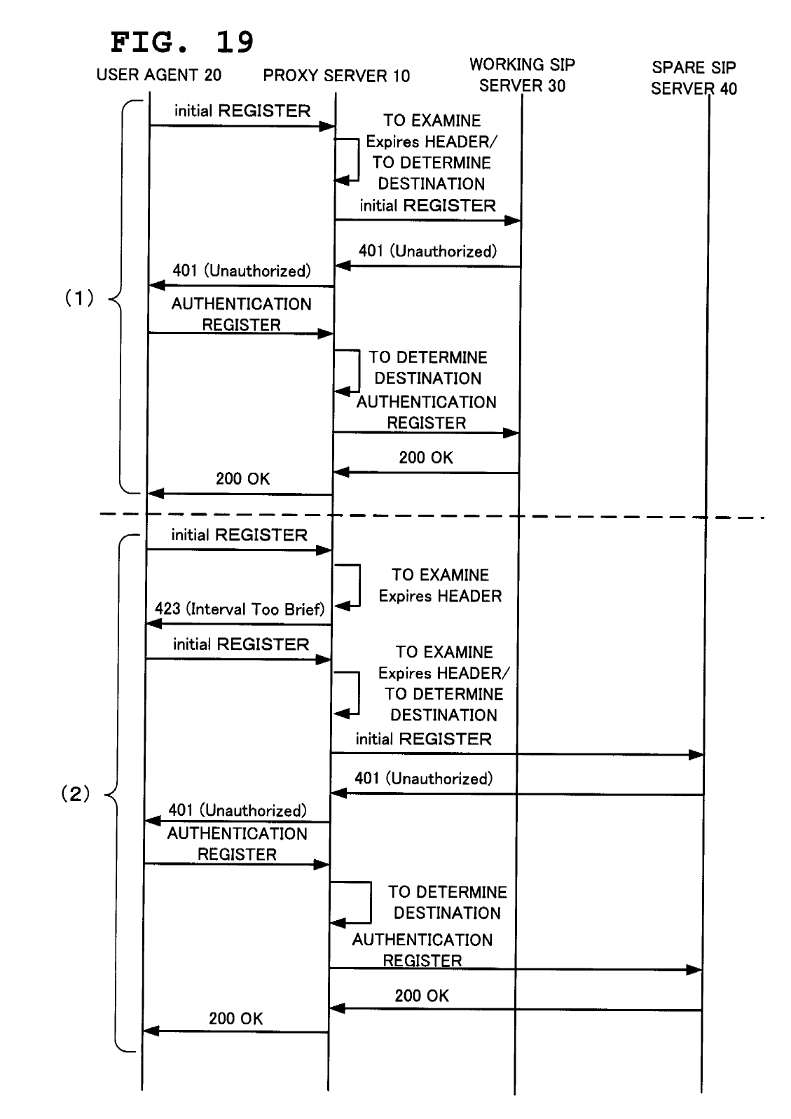

First, FIG. 18 shows a data flow in the entire system including the proxy server 10 according to the fourth exemplary embodiment of the present invention.

As shown in FIG. 18, the proxy server 10 having received a REGISTER request transmitted from the user agent 20 (a in FIG. 18) examines a value of an Expires header of the REGISTER request and when the value is less than a certain threshold value, transfers an expiration date change request response (b in FIG. 18) to ask the user agent 20 to change the Expires header value.

The user agent 20 having received the expiration date change request response transmits a REGISTER request whose Expires header value is changed according to the processing defined by the SIP protocol code (c in FIG. 18).

Moreover, this series of flow is sequentially executed by the working SIP server 30 and the spare SIP server 40 similarly to the proxy server 10 according to the second exemplary embodiment of the present invention. In other words, a REGISTER request is transferred to each of the working SIP server 30 and the spare SIP server 40 once in several times.

Next, shown in FIG. 19 is a sequence diagram illustrating operation of the entire system. As shown in FIG. 19, the proxy server 10 examines an Expires header of a received initial REGISTER request and when it is not less than a threshold value, after determining an SIP server as a transmission destination, transmits the initial REGISTER request to the relevant SIP server (sequence (1) in FIG. 19).

On the other hand, when the Expires header of the initial REGISTER request is less than the threshold value, the proxy server 10 receives the initial REGISTER request whose Expires header value is changed by returning the SIP response (423: Interval too Brief) indicative of an Expires header value update request (sequence (2) in FIG. 19).

Moreover, in either case, an authentication REGISTER request is transmitted to the same SIP server as a transmission destination of an initial REGISTER request. The user agent 20 recognizes that although first REGISTER request processing fails, update of registration information is completed by the re-transmission processing according to the SIP requirement.

On the other hand, since an expiration date of registration information is extended also by the SIP server, the registration information will not expire although a REGISTER request is received only once in several times.

### (Effects of the Fourth Exemplary Embodiment)

According to the present exemplary embodiment, registration information of each SIP server can be copied using only a user ID (user agent identifier) and a password for identifying the user agent 20 which are held by the user agent 20.

The reason is that with the provision of the destination determination function 16, Digest authentication executed between the user agent 20 and the working SIP server 30 is executed also between the user agent 20 and the spare SIP server 40.

Also according to the present exemplary embodiment, registration information will not expire although each SIP server receives a REGISTER request only once in several times.

The reason is that the message analysis function 18 identifies a message externally received by the SIP proxy server function 11 and when the received message is an initial REGISTER request, the message analysis function 18 further refers to an Expires header of the initial REGISTER request and when a value of the Expires header is less than a certain threshold value, the expiration date change request response generating function 19 generates an expiration date change request response, so that the proxy server 10 receives the initial REGISTER request whose Expires header value is changed from the user agent 20, thereby allowing the SIP server to extend an expiration date of the registration information.

Also according to the present exemplary embodiment, the proxy server 10 itself requires no provision of an Expires header expansion function because the expiration date change request response generating function 19 causes the user agent 20 to execute Expires header expansion processing.

### Fifth Exemplary Embodiment

Next, a proxy server 10 according to a fifth exemplary embodiment of the present invention will be detailed with reference to the drawings.

### (Structure of the Fifth Exemplary Embodiment)

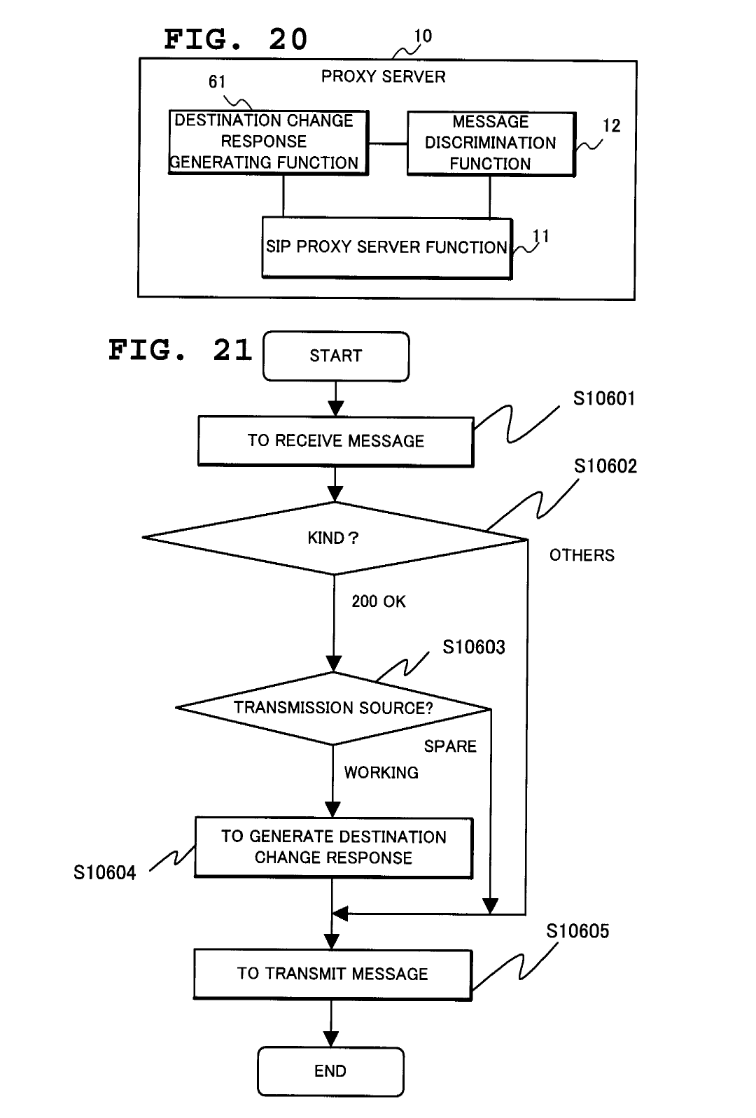

Structure of the proxy server 10 according to the fifth exemplary embodiment of the present invention will be detailed with reference to the drawings. FIG. 20 is a block diagram showing a structure of the proxy server 10 according to the fifth exemplary embodiment of the present invention.

As shown in FIG. 20, the proxy server 10 according to the fifth exemplary embodiment of the present invention comprises, in addition to the SIP proxy server function 11, the message discrimination function 12 for identifying a kind of message received by the SIP proxy server function 11 and a destination change response generating function 61 for generating a destination change response (destination change request response) to cause a function of changing a transmission destination of an SIP request by the user agent 20 to operate which is defined by the SIP protocol code.

Possible as this destination change response is, for example, an SIP response 305 (use proxy) defined by the SIP protocol code with an IP address of the spare SIP server 40 inserted into a contact header of the SIP response.

### (Operation of the Fifth Exemplary Embodiment)

Next, operation of the proxy server 10 according to the fifth exemplary embodiment of the present invention will be detailed with reference to the drawings. FIG. 21 is a flow chart showing operation of the proxy server 10 according to the fifth exemplary embodiment of the present invention.

Assume now that the SIP proxy server function 11 receives a message (Step S10601). Next, examine a kind of message received by the message discrimination function 12 (Step S10602).

As a result of Step S10602, when the message received by the SIP proxy server function 11 is the SIP response (200 OK), the message discrimination function 12 further examines a transmission source of the relevant SIP response (200 OK) (Step S10603).

As a result of Step S10603, when a transmission source of the SIP response (200 OK) is the working SIP server 30, the destination change response generating function 61 generates an SIP response indicative of destination change which is to be transmitted to the user agent 20 (Step S10604). This processing results in, for example, having the SIP response 305 (use proxy) defined by the SIP protocol code with an IP address of the spare SIP server 40 inserted in the contact header of the SIP response as described above.

As a result of Step S10602, when the message received by the proxy server 10 is other than the SIP response (200 OK) or when the transmission source of the SIP response (200 OK) is the spare SIP server 40 as a result of Step S10603 or when a destination change response to be transferred to the user agent 20 is generated as a result of Step S10604, the SIP proxy server function 11 transfers the message received at Step S10601 to a destination recited in the message or the destination change response generated at Step S10604 to the user agent 20 (Step S10605).

Next, operation of the entire system including the proxy server 10 according to the fifth exemplary embodiment of the present invention which has such structure and operation as described above will be detailed with reference to the drawings.

First, FIG. 22 shows a data flow in the entire system. As shown in the figure, the proxy server 10 having received the SIP response (200 OK) (b in FIG. 22) indicative of the end of processing of the REGISTER request (a in FIG. 22) transmitted from the user agent 20 transmits an SIP response (destination change response) urging the user agent 20 to change a destination of the REGISTER request (c in FIG. 22).

The user agent 20 having received the destination change response changes the transmission destination of the REGISTER request to the destination recited in the destination change response according to processing defined by the SIP protocol code to transmit another REGISTER request. The proxy server 10 transfers the re-transmitted REGISTER request to the spare SIP server 40 (d in FIG. 22).

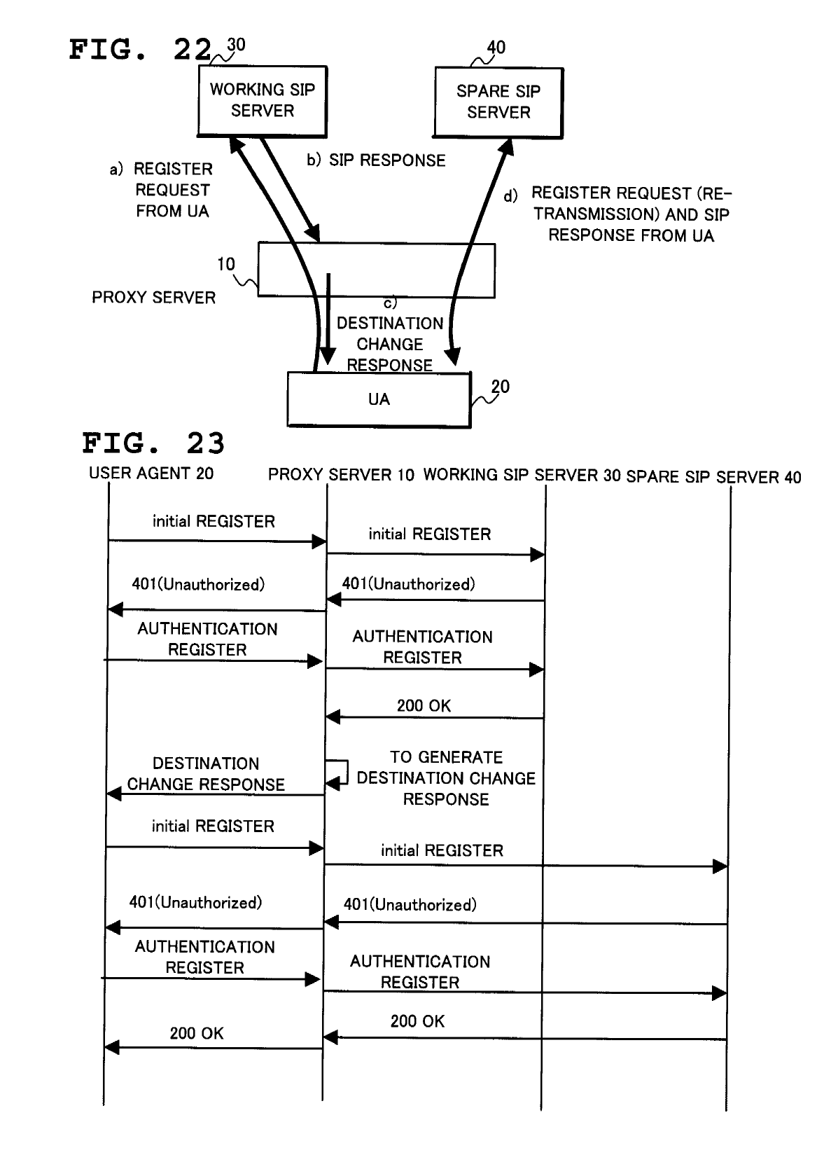

Furthermore, shown in FIG. 23 is this data flow illustrated as an operation sequence. As shown in the figure, the proxy server 10 having received the SIP response (200 OK) transmitted from the working SIP server 30 causes the user agent 20 to transmit an initial REGISTER request whose destination has been changed to the spare SIP server 40 by transmitting a destination change response to the user agent 20. The proxy server 10 having received the initial REGISTER request, only by transmitting the same to a destination (spare SIP server 40) recited in the initial REGISTER request, enables copying of registration information between the working SIP server 30 and the spare SIP server 40.

### (Effects of the Fifth Exemplary Embodiment)

According to the present exemplary embodiment, only by transmission by the proxy server 10 to a destination (spare SIP server 40) recited in the initial REGISTER request from the user agent 20, copying of registration information is enabled between the working SIP server 30 and the spare SIP server 40.

The reason is that the proxy server 10 having received the SIP response (200 OK) transmitted from the working SIP server 30 causes the user agent 20 to transmit an initial REGISTER request whose destination is changed to the spare SIP server 40 to the proxy server 10 by transmitting a destination change response generated by the destination change response generating function 61 to the user agent 20.

### Sixth Exemplary Embodiment

Next, a proxy server 10 according to a sixth exemplary embodiment of the present invention will be detailed with reference to the drawings.

### (Structure of the Sixth Exemplary Embodiment)

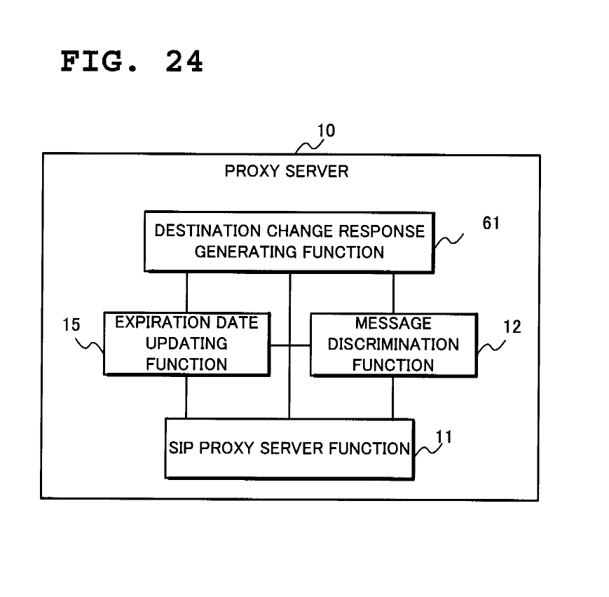

Structure of the proxy server 10 according to the sixth exemplary embodiment of the present invention will be detailed with reference to the drawings. FIG. 24 is a block diagram showing a structure of the proxy server 10 according to the sixth exemplary embodiment of the present invention.

As shown in FIG. 24, the proxy server 10 according to the sixth exemplary embodiment of the present invention comprises, in addition to the common SIP proxy server function 11, the message discrimination function 12 for identifying a message received by the SIP proxy server function 11, the destination change response generating function 61 for generating a destination change response (destination change request response) for causing a function of changing a transmission destination of an SIP request by the user agent 20 in response to an SIP response to operate which is defined by the SIP protocol code, and the expiration date updating function 15 of changing (increase/decrease) a value of an Expires header included in a message received by the SIP proxy server function 11.

Destination change response generated by the destination change response generating function 61 here is the same, for example, as a destination change response generated by the proxy server 10 according to the fifth exemplary embodiment of the present invention described above.

Furthermore, the message discrimination function 12 preserves information (destination information) to be referred to at the time of determining a destination of a REGISTER request, which information is used for determining whether to generate a destination change response. The destination information can be realized, for example, as a pair of the user agent 20 and a transfer destination of a REGISTER request.

### (Operation of the Sixth Exemplary Embodiment)

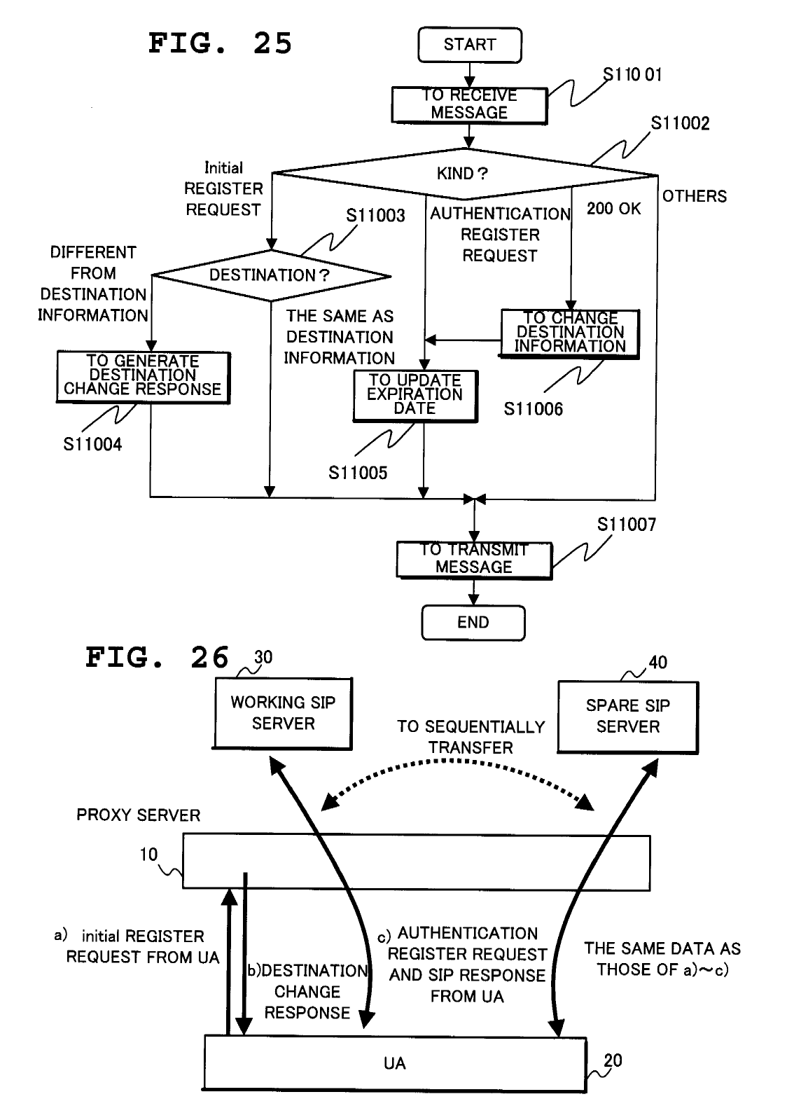

Next, operation of the proxy server 10 according to the sixth exemplary embodiment of the present invention will be detailed with reference to the drawings. FIG. 25 is a flow chart showing operation of the proxy server 10 according to the sixth exemplary embodiment of the present invention.

Assume now that the SIP proxy server function 11 receives an external message (Step S11001). Next, the message discrimination function 12 examines a kind of message (Step S11002).

As a result of Step S11002, when the message received by the SIP proxy server function 11 is an initial REGISTER request, the message discrimination function 12 further examines a transmission destination (destination) of the initial REGISTER request (Step S11003).

This processing can be realized by the following manner, for example. First, the message discrimination function 12 extracts a transfer destination of the REGISTER request from destination information with the user agent 20 having transmitted the received initial REGISTER request as a search key. Thereafter, compare the transmission destination of the received initial REGISTER request with the extracted transfer destination at Step S11001.

As a result of Step S11003, when the destination of the initial REGISTER request differs from the destination information, the destination change response generating function 61 generates a destination change response (Step S11004).

This processing results, for example, in processing of inserting an IP address of the spare SIP server 40 into a contact header of the SIP response 305 (use proxy) which is defined by the SIP protocol code as described above.

As a result of Step S11002, when the received message is an authentication REGISTER request, change a value of the Expires header of the authentication REGISTER request (Step S11005).

In this processing, the value is increased according to the number of spare SIP servers, for example, double when one spare SIP server 40 exists, and triple when two spare SIP servers 40 exist.

As a result of Step S11002, when the received message is the SIP response (200 OK), change the destination information held by the message discrimination function 12 (Step S11006).

This processing can be realized as follows, for example. First, extract a transfer destination of a REGISTER request of the user agent 20 as a transmission destination of the SIP response (200 OK) from the destination information. Thereafter, when the SIP response (200 OK) received at Step S11001 is transmitted from the working SIP server 30, consider the relevant request transfer destination as the spare SIP server 40. On the other hand, when the SIP response (200 OK) is transmitted from the spare SIP server 40, consider the relevant request transfer destination as the working SIP server 30.

Next, change the value of the Expires header of the SIP response (200 OK) (Step S11005). In this case, conversely from the change of an Expires header value of an authentication REGISTER request, the value is decreased according to the number of the spare SIP servers, for example, half when there exists one spare SIP server 40 and one-third when there exist two spare SIP servers 40.

As a result of Step S11004, when generation of a destination change response to be transferred to the user agent 20 is completed, or as a result of Step S11003, when the destination of the initial REGISTER request coincides with the destination information, or as a result of Step S11005, when the change of the Expires header values of the authentication REGISTER request and the SIP response (200 OK) is completed, or as a result of Step S11002, when the received message is other than the initial/authentication REGISTER request and the SIP response (200 OK), the SIP proxy server function 11 transfers the destination change response to the user agent 20 and in other cases, transfers the same to a destination recited in the message (Step S11007).

Next, operation of the entire system including the proxy server 10 according to the sixth exemplary embodiment of the present invention will be detailed with reference to the drawings.

First, a data flow in the entire system is shown in FIG. 26. As shown in the figure, the proxy server 10 having received an initial REGISTER request (a in FIG. 26) from the user agent 20 examines a destination of the initial REGISTER request and when it is not a destination transfer turn recited in the initial REGISTER request, transfers a destination change response (b in FIG. 26) to the user agent 20. Thereafter, transfer the initial REGISTER whose destination is modified by the user agent 20 to the recited destination and transfer an SIP response received from the relevant destination to the user agent 20 (c in FIG. 26). As a result, the initial REGISTER request will be sequentially transferred to the working SIP server 30 and the spare SIP server 40.

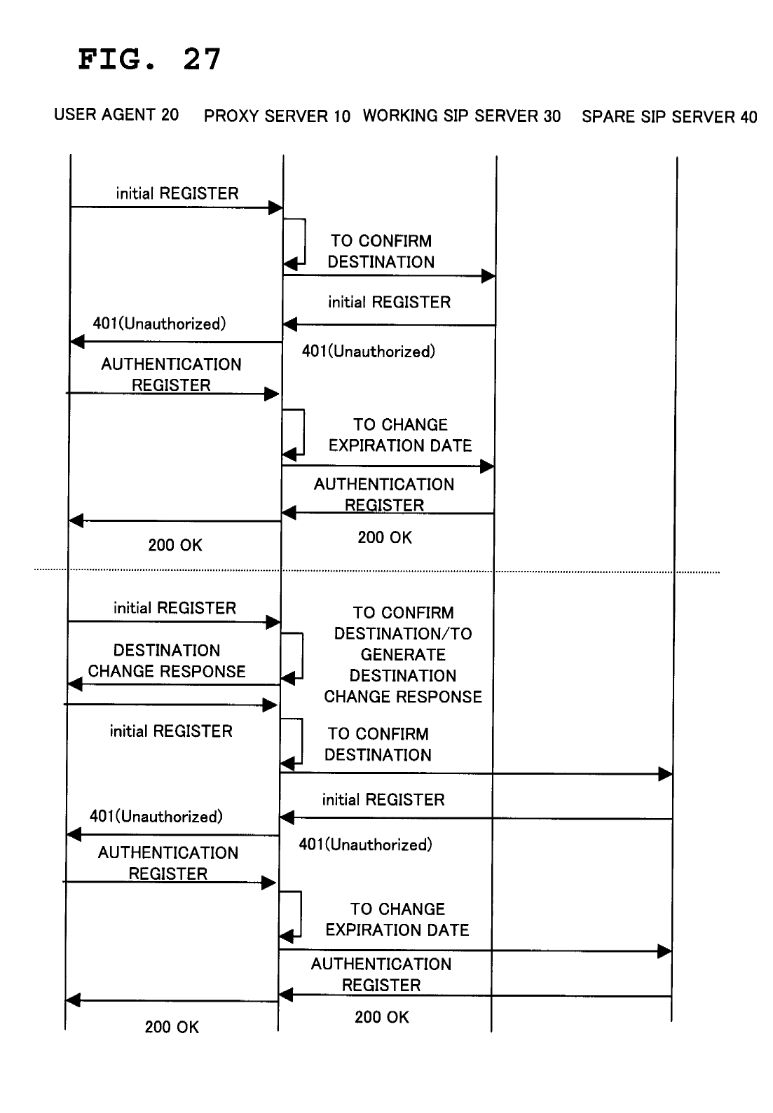

Furthermore, this data flow illustrated as an operation sequence is shown in FIG. 27. As illustrated in this figure, examination of a destination of an initial REGISTER request and change of an Expires header value of an authentication REGISTER request enable registration information of the working SIP server 30 and the spare SIP server 40 to be sequentially updated without invalidating registration information stored in each SIP server.

### (Effects of the Sixth Exemplary Embodiment)

The present exemplary embodiment enables update of registration information of the working SIP server 30 and the spare SIP server 40 without invalidating registration information stored in each SIP server.

The reason is that registration information of the working SIP server 30 and the spare SIP server 40 is sequentially updated by the examination of a destination of an initial REGISTER request, the change of an Expires header value of an authentication REGISTER request by the expiration date updating function 15 for changing (increase/decrease) a value of an Expires header and the generation, by the destination change response generating function 61, of a destination change response for operating the function of changing a transmission destination of an SIP request.

### Seventh Exemplary Embodiment

Next, a proxy server 10 according to a seventh exemplary embodiment of the present invention will be detailed with reference to the drawings.

### (Structure of the Seventh Exemplary Embodiment)

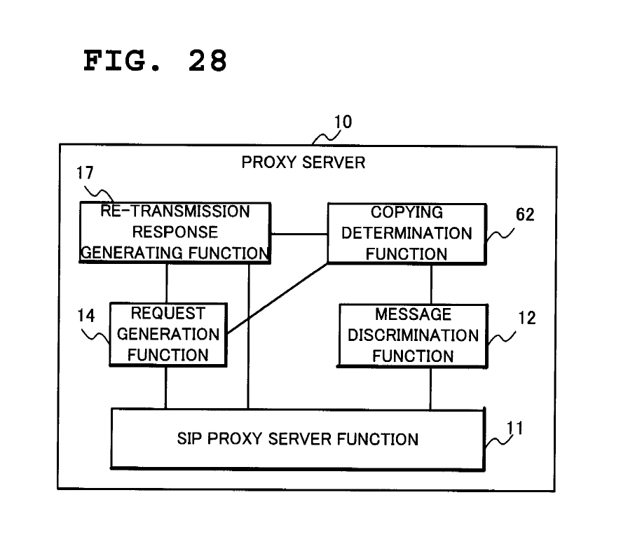

Structure of the proxy server 10 according to the seventh exemplary embodiment of the present invention will be detailed with reference to the drawings. FIG. 28 is a block diagram showing a structure of the proxy server 10 according to the seventh exemplary embodiment of the present invention.

As shown in FIG. 28, the proxy server 10 according to the seventh exemplary embodiment of the present invention is structured with a copying determination function 62 for determining whether copying to the spare SIP server 40 is executed or not added to the structure of the proxy server 10 according to the first exemplary embodiment of the present invention.

While in the proxy server 10 according to the first exemplary embodiment of the present invention, all the REGISTER requests transmitted from the user agent 20 are copied, in the proxy server 10 according to the seventh exemplary embodiment of the present invention, a REGISTER request is transmitted once in several times to the spare SIP server 40 with the introduction of the copying determination function 62.

Moreover, the request generation function 14 is expanded from the function held by the request generation function 14 at the proxy server 10 according to the first exemplary embodiment of the present invention to a function of increasing an Expires header value at the time of generation of a REGISTER request to be transferred to the spare SIP server 40. As a result, even when a REGISTER request from the user agent 20 arrives at the spare SIP server 40 once in several times, no registration information of the spare SIP server 40 will be invalidated.

### (Operation of the Seventh Exemplary Embodiment)

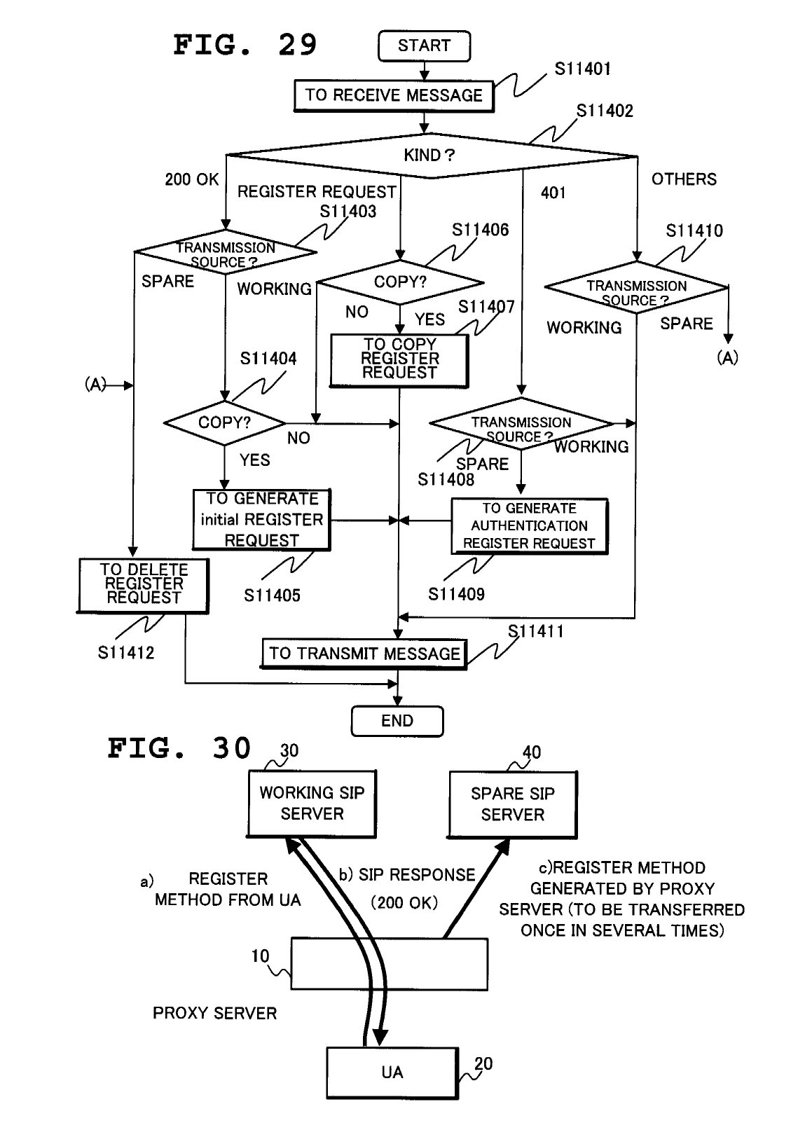

Next, operation of the proxy server 10 according to the seventh exemplary embodiment of the present invention will be detailed with reference to the drawings. FIG. 29 is a flow chart showing operation of the proxy server 10 according to the seventh exemplary embodiment of the present invention.

The flow chart is formed with copying determination processing (Step S11404 and Step S11406) by the copying determination function 62 added to the flow chart showing operation of the proxy server 10 according to the first exemplary embodiment of the present invention. Since as other steps than the copying determination processing of the present exemplary embodiment, Step S11401 has the same processing contents as those of Step S401 shown in FIG. 5 according to the first exemplary embodiment, Step S11402 as those of Step S402, Step S11403 as those of Step S403, Step S11412 as those of Step S404, Steps S11405 as those of Step S405, Step S11407 as those of Step S406, Step S11408 as those of Step S407, Step S11409 as those of Step S408, Step S11410 as those of Step S409 and Step S11411 as those of Step S410, no description will be made thereof.

The copying determination processing (Step S11404 and Step S11406) by the copying determination function 62 can be realized by the following processing, for example. Refer to a CSeq header value of the message (REGISTER request or SIP response (200 OK)) received at Step S11401 to determine, when coping once in two times, to copy at an odd number and not to copy at an even number (Step S11404).

As a result of Step S11404, when the determination is made to copy, the request generation function 14 generates an initial REGISTER request (Step S11405). This processing, as described above, is realized by adding Expires header value increase processing to the processing of the request generation function 14 in the proxy server 10 according to the first exemplary embodiment of the present invention.

As a result of Step S11404, when the determination is made not to copy, the SIP proxy server function 11 transfers the message received at Step S11401 to a destination recited in the message.

Processing of Step S11406 in a case where the message received as a result of Step S11402 is a REGISTER request is also executed similarly to Step S11404 to determine copying. When the determination is made to copy as a result of Step S11406, the temporary storage function 13 copies the received REGISTER request (Step S11407). Operation of the temporary storage function 13 is the same as the operation of the temporary storage function 13 at the proxy server 10 according to the first exemplary embodiment of the present invention.

As a result of Step S11406, when the determination is made not to copy, the SIP proxy server function 11 transfers the message received as a result of Step S11401 to the destination recited in the message.

Next, a data flow and operation of the entire system including the proxy server 10 according to the seventh exemplary embodiment of the present invention will be detailed with reference to the drawings.

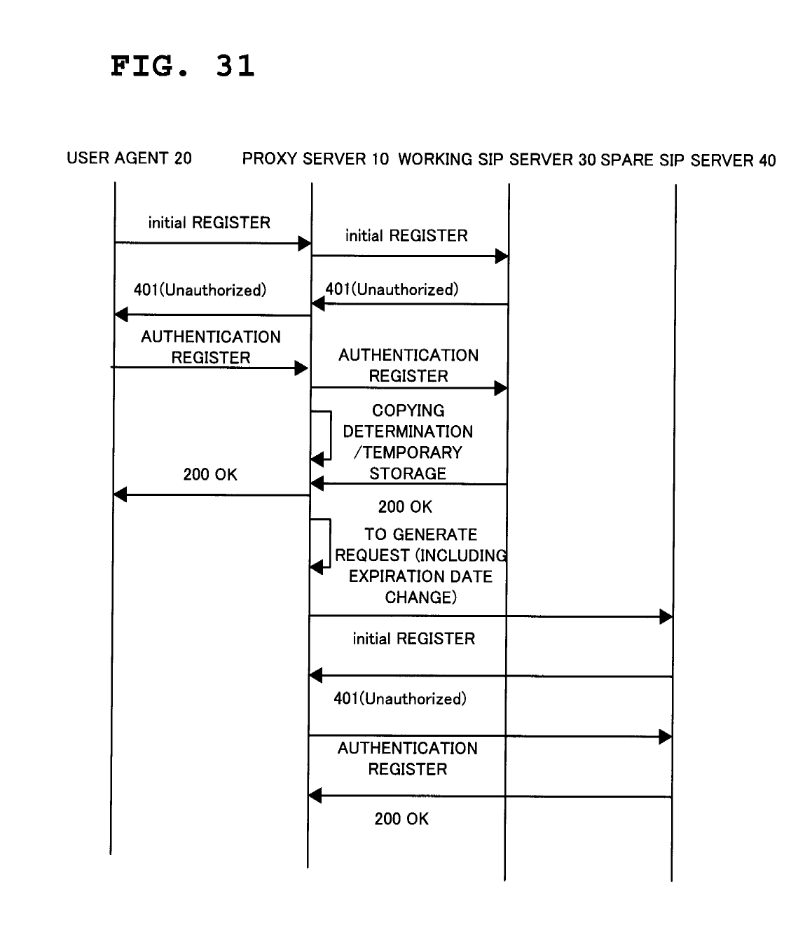

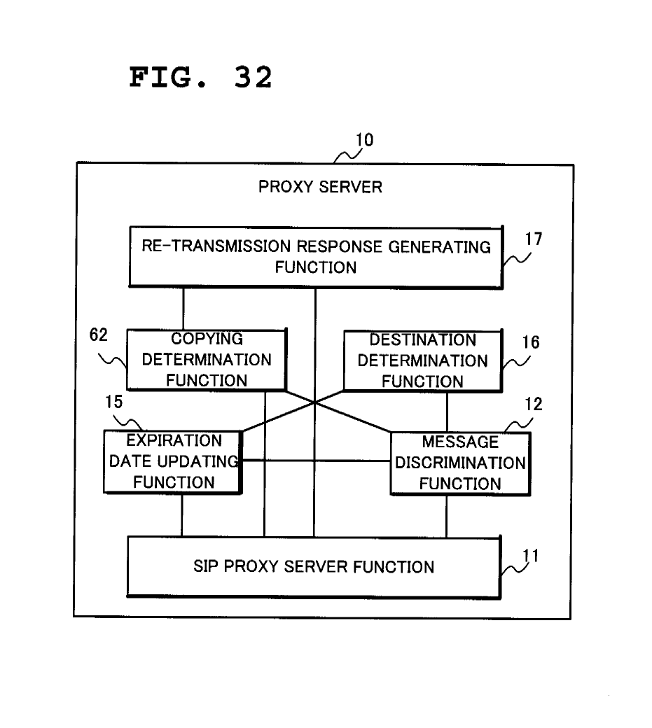

FIG. 30 shows a data flow of the entire system including the proxy server 10 according to the seventh exemplary embodiment of the present invention.

As shown in the figure, the data flow is basically the same as that of the proxy server 10 according to the first exemplary embodiment of the present invention. The present exemplary embodiment is characterized in that a REGISTER request from the user agent 20 is transferred to the spare SIP server 40 once in several times.

Moreover, this data flow illustrated as an operation sequence is shown in FIG. 31. As illustrated in the figure, a REGISTER request directed from the user agent 20 to the working SIP server 30 is temporally stored as a target to be copied once in several times and transferred with its Expires header value updated as a REGISTER request to be transferred to the spare SIP server 40.

### (Effects of the Seventh Exemplary Embodiment)

The present exemplary embodiment enables reduction in loads on registration information update of the spare SIP server 40 and reduction in traffic between the proxy server 10 and the spare SIP server 40 than in the first exemplary embodiment.

The reason is that with the introduction of the copying determination function 62, the proxy server 10 transmits a REGISTER request once in several times to the spare SIP server 40.

### Eighth Exemplary Embodiment

Next, a proxy server 10 according to an eighth exemplary embodiment of the present invention will be detailed with reference to the drawings.

### (Structure of the Eighth Exemplary Embodiment)

Structure of the proxy server 10 according to the eighth exemplary embodiment of the present invention will be detailed with reference to the drawings. FIG. 32 is a block diagram showing a structure of the proxy server 10 according to the eight exemplary embodiment of the present invention.

As shown in FIG. 32, the proxy server 10 according to the eighth exemplary embodiment of the present invention is structured with the copying determination function 62 and the expiration date updating function 15 added to the structure of the proxy server 10 according to the third exemplary embodiment of the present invention.

The copying determination function 62 is the same as the copying determination function 62 in the proxy server 10 according to the seventh exemplary embodiment of the present invention. Moreover, the expiration date updating function 15 is the same as the expiration date updating function 15 in the proxy server 10 according to the second exemplary embodiment of the present invention.

Addition of these functions causes REGISTER requests transmitted from the user agent 20 to be transferred to the spare SIP server 40 once in several times, while in the proxy server 10 according to the third exemplary embodiment of the present invention, the user agent 20 is designed to re-transmit every REGISTER request transmitted from the user agent 20 and transfer the same to the spare SIP server 40.

### (Operation of the Eighth Exemplary Embodiment)

Next, operation of the proxy server 10 according to the eighth exemplary embodiment of the present invention will be detailed with reference to the drawings.

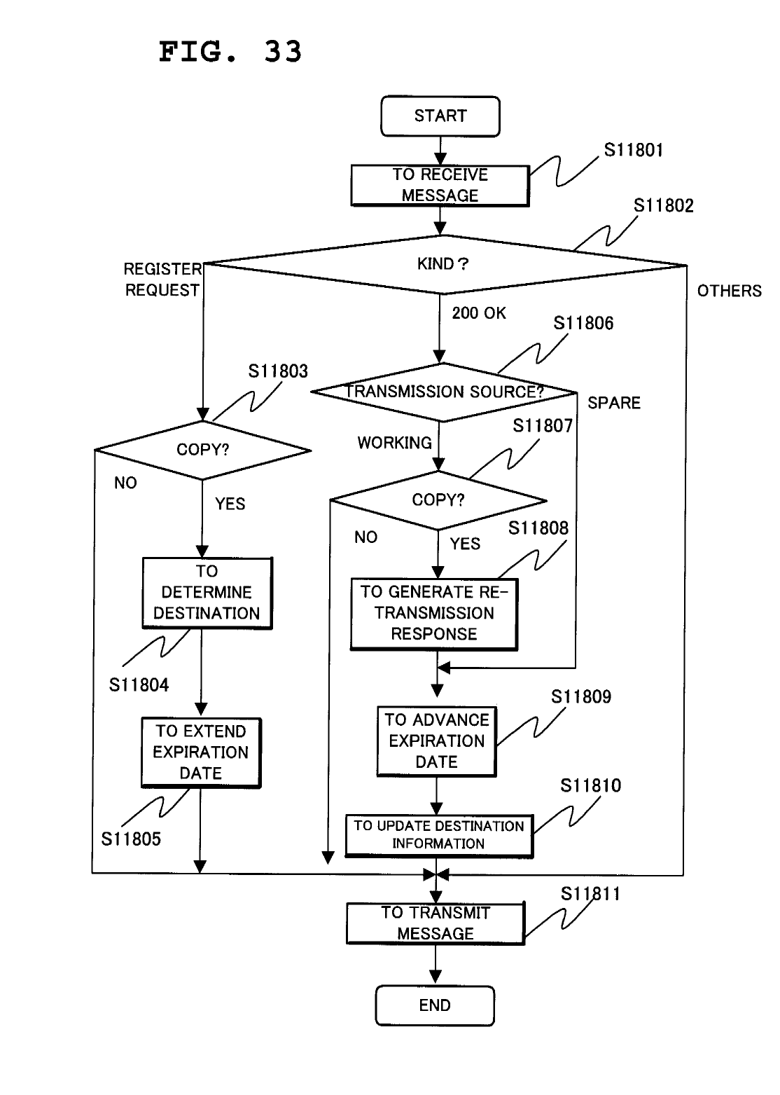

FIG. 33 is a flow chart showing operation of the proxy server 10 according to the eighth exemplary embodiment of the present invention. As illustrated in the figure, operation of the proxy server 10 according to the eighth exemplary embodiment of the present invention is formed with the copying determination processing (Step S11803 and Step S11807) by the copying determination function 62 and the processing of changing Expires header values of a REGISTER request and the SIP response (200 OK) by the expiration date updating function 15 (Step S11805 and Step S11809) added to the operation of the proxy server 10 according to the third exemplary embodiment of the present invention. Since as other steps than the copying determination processing and the Expires header value changing processing of the present exemplary embodiment, Step S11801 has the same processing contents as those of Step S1001 shown in FIG. 13 according to the third exemplary embodiment, Step S11802 as those of Step S1002, Step S11804 as those of Step S1003, Steps S11806 as those of Step S1004, Step S11808 as those of Step S1005, Step S11810 as those of Step S1006, and Step S11811 as those of Step S1007, no description will be made thereof.

The copying determination processing (Step S11803 and Step S11807) is the same as the copying determination processing in the operation at the proxy server 10 according to the seventh exemplary embodiment of the present invention (Step S11404 and Step S11406). Furthermore, the expiration date changing processing (Step S11805 and Step S11809) is the same as the expiration date extending processing (Step S703) and the expiration date advancing processing (Step S706) in the operation at the proxy server 10 according to the second exemplary embodiment of the present invention.

More specifically, as a result of Step S11802, when a kind of message received by the SIP proxy server function 11 is a REGISTER request, the copying determination function 62 determines whether to execute copying to the spare SIP server 40 (Step S11803).

As a result of Step S11803, when determining to copy, the destination determination function 16 determines a destination (Step S11804) and the expiration date updating function 15 executes the Expires header value changing processing (Step S11805).

As a result of Step S11802, when a kind of message received by the SIP proxy server function 11 is the SIP response (200 OK), the message discrimination function 12 discriminates a transmission source of the message (Step S11806) and as a result of Step S11806, when the transmission source is the working SIP server 30, the copying determination function 62 determines whether to execute copying to the spare SIP server 40 (Step S11807).

As a result of Step S11807, when the determination is made to copy, the re-transmission response generating function 17 generates a re-transmission response for causing the user agent 20 to re-transmit an initial REGISTER request (Step S11808), the expiration date updating function 15 executes the Expires header value changing processing (Step S11809) and the destination determination function 16 updates destination information (Step S11810).

As a result of Step S11802, when the message received by the SIP proxy server function 11 is neither a REGISTER request nor the SIP response (200 OK), when as a result of Step S11803 or Step S11807, the determination is made not to copy, when as a result of Step S11805, the Expires header value changing processing is executed and when as a result of Step S11801, the destination information is updated, the SIP proxy server function 11 transmits the message to a designated destination (Step S11811).

Next, a data flow and operation of the entire system including the proxy server 10 according to the eighth exemplary embodiment of the present invention will be detailed with reference to the drawings.

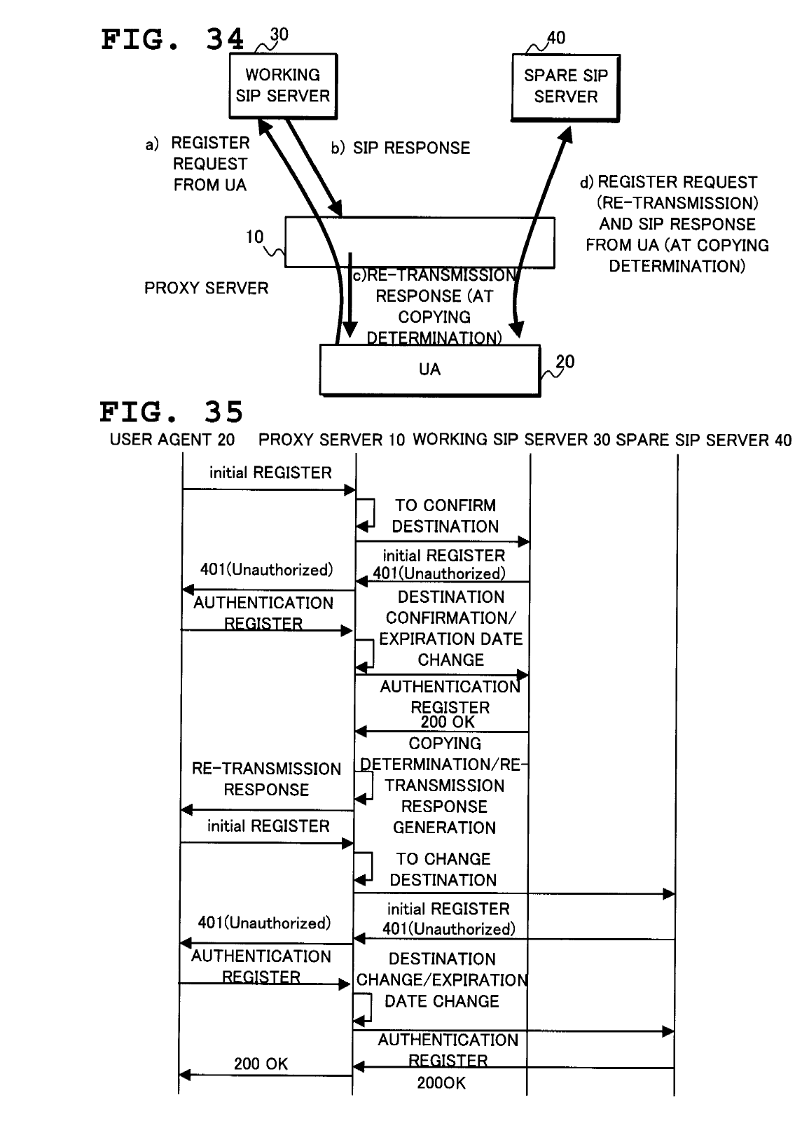

FIG. 34 is a diagram showing a data flow of the entire system including the proxy server 10 according to the eighth exemplary embodiment of the present invention.

As shown in the figure, the data flow of the entire system including the proxy server 10 according to the eighth exemplary embodiment of the present invention is basically the same as the data flow of the entire system including the proxy server 10 according to the third exemplary embodiment of the present invention (see FIG. 14). The present exemplary embodiment is, however, characterized in that a re-transmission response is returned to the user agent 20 once in several times from the proxy server 10 in response to a REGISTER request from the user agent 20, to which response, an initial REGISTER request from the user agent 20 is transferred to the spare SIP server 40.

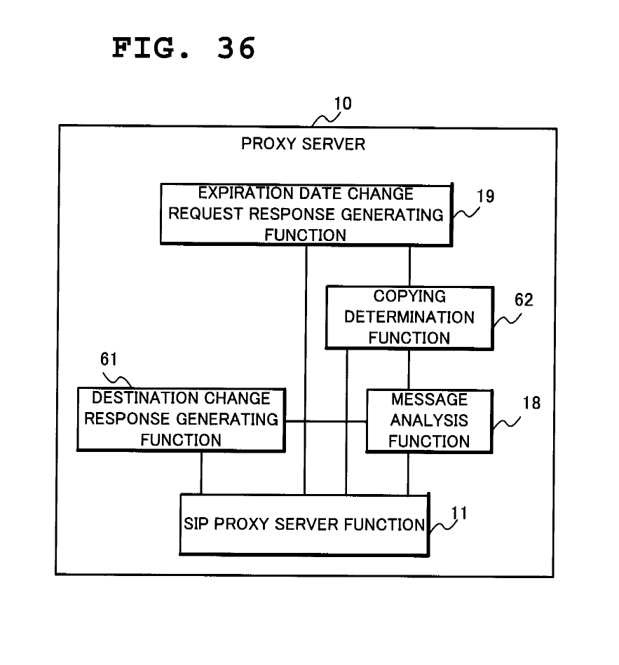

Moreover, this data flow illustrated as an operation sequence is shown in FIG. 35. As illustrated in the figure, a re-transmission response is returned once in several times to a REGISTER request transmitted from the user agent 20, and an Expires header of an initial REGISTER request transmitted in response to the response by the user agent 20 is changed by the proxy server 10 and then transferred to the spare SIP server 40.

### (Effects of the Eighth Exemplary Embodiment)

The present exemplary embodiment enables reduction in loads on registration information update of the spare SIP server 40, reduction in traffic between the proxy server 10 and the user agent 20 and reduction in traffic between the proxy server 10 and the spare SIP server 40 than in the third exemplary embodiment.

The reason is that an Expires header value of an authentication REGISTER request is changed by the expiration date updating function 15, a re-transmission response is returned to the user agent 20 once in several times from the proxy server 10 by the re-transmission response generating function 17 and the copying determination function 62 in response to a REGISTER request from the user agent 20 and in response to the response, an initial REGISTER request from the user agent 20 is transferred to the spare SIP server 40.

### Ninth Exemplary Embodiment

Next, a proxy server 10 according to a ninth exemplary embodiment of the present invention will be detailed with reference to the drawings.

### (Structure of the Ninth Exemplary Embodiment)

FIG. 36 is a block diagram showing a structure of the proxy server 10 according to the ninth exemplary embodiment of the present invention. As shown in the figure, the proxy server 10 according to the ninth exemplary embodiment of the present invention is structured with the destination change response generating function 61 for generating a destination change response (destination change request response) for causing the function of changing a transmission destination of an SIP request by the user agent 20 to operate which is defined by the SIP protocol code added in place of the destination determination function 16 in the structure of the proxy server 10 according to the fourth exemplary embodiment of the present invention.

Along the change, in the message analysis function 18, destination information for use in determining whether to generate a destination change response is preserved similarly to the message discrimination function 12 in the proxy server 10 according to the sixth exemplary embodiment of the present invention. Destination information is the same as that of the proxy server 10 according to the sixth exemplary embodiment of the present invention.

### (Operation of the Ninth Exemplary Embodiment)

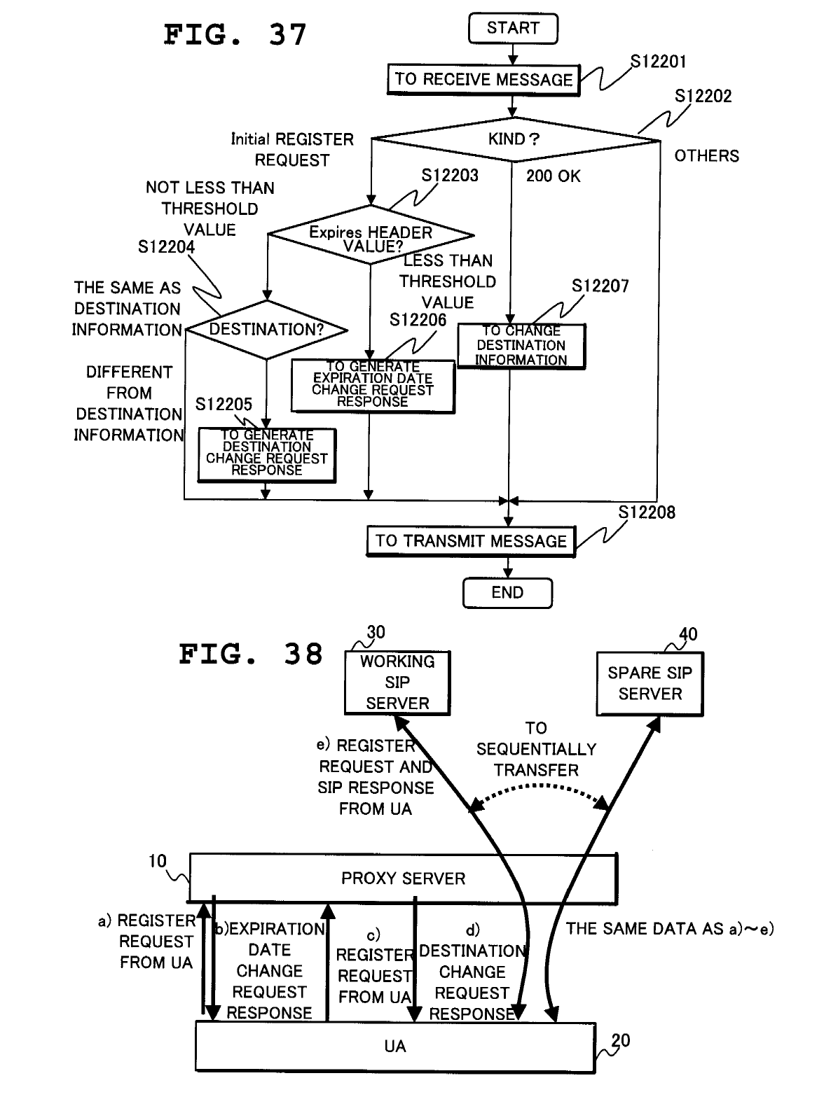

Next, operation of the proxy server 10 according to the ninth exemplary embodiment of the present invention will be detailed with reference to the drawings. FIG. 37 is a flow chart showing operation of the proxy server 10 according to the ninth exemplary embodiment of the present invention.

Assume now that the SIP proxy server function 11 receives an external message (Step S12201). Then, the message analysis function 18 examines a kind of message (Step S12202).

As a result of Step S12202, when the message received by the SIP proxy server function 11 is an initial REGISTER request, the message analysis function 18 further examines a value stored in the Expires header (Step S12203).

As a result of Step S12203, when the Expires header value of the received initial REGISTER request is less than a threshold value, the expiration date change request response generating function 19 generates an expiration date change request response (Step S12206).

Here, the processing of Step S12203 is the same as that at Step S1303 in the operation of the proxy server 10 according to the fourth exemplary embodiment of the present invention and the expiration date change request response generating processing at Step S12206 is the same as that of Step S1304 in the operation of the proxy server 10 according to the fourth exemplary embodiment of the present invention.

As result of Step S12203, when the Expires header value of the received initial REGISTER request is not less than a certain threshold value, the message analysis function 18 further examines a transmission destination (destination) of the received initial REGISTER request (Step S12204). This processing is the same as that of Step S1103 in the operation of the proxy server 10 according to the sixth exemplary embodiment of the present invention.

As a result of Step S12204, when the transmission destination of the initial REGISTER request differs from the destination information, the destination change response generating function 61 generates a destination change response (Step S12205). This processing is the same as that of Step S11004 in the operation of the proxy server 10 according to the sixth exemplary embodiment of the present invention.

As a result of Step S12202, when the message received by the SIP proxy server function 11 is the SIP response (200 OK), the message analysis function 18 updates the destination information (Step S12207). This processing is the same as that of Step S11006 in the operation of the proxy server 10 according to the sixth exemplary embodiment of the present invention.

As a result of Step S12204, when the transmission destination of the initial REGISTER request is the same as the destination information, or when as a result of Step S12207, change of destination information by the message analysis function 18 is completed or when as a result of Step S12202, the message received by the SIP proxy server function 11 is other than an initial REGISTER request and the SIP response (200 OK), the SIP proxy server function 11 transmits the message received at Step S12201 to a destination recited in the message, or when as a result of Step S12206, generation of an expiration date change request response to be transmitted to the user agent 20 is completed or when as a result of Step S12205, generation of a destination change response to be transmitted to the user agent 20 is completed, the proxy server 11 transmits the SIP response generated at Step S12205 and Step S12206 to the user agent 20 (Step S12208).

Next, a data flow and operation of the entire system including the proxy server 10 according to the ninth exemplary embodiment of the present invention will be detailed with reference to the drawings.

FIG. 38 is a diagram showing a data flow of the entire system including the proxy server 10 according to the ninth exemplary embodiment of the present invention.

As shown in the figure, the proxy server 10 having received the initial REGISTER request (a in FIG. 38) from the user agent 20 examines an Expires header value of the initial REGISTER request and when the value is less than a certain threshold value, returns an expiration date change request response (b in FIG. 38). Furthermore, the server examines a destination of an initial REGISTER request (c in FIG. 38) whose Expires header value is modified which is returned from the user agent 20 in response to the response and when it is not a destination transfer turn recited in the initial REGISTER request, transfers the destination change response (d in FIG. 38) to the user agent 20. The foregoing processing results in sequentially transferring an initial REGISTER request whose Expires header and destination are appropriately changed to the working/spare SIP server (e in FIG. 38). Moreover, the data flow is sequentially executed by the working SIP server 30 and the spare SIP server 40.

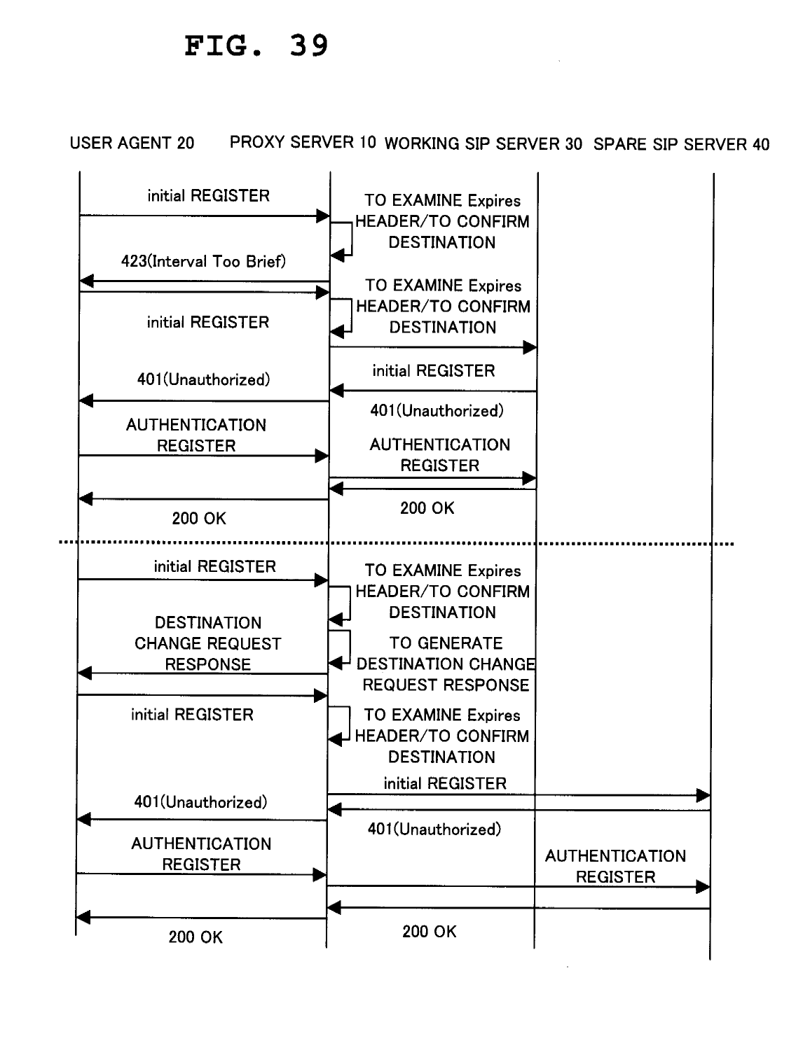

Moreover, this data flow illustrated as an operation sequence is shown in FIG. 39. As illustrated in the figure, the proxy server 10 causes processing for SIP responses (a destination change request response and an expiration date change request response) defined by the SIP protocol code to be operated at the user agent 20 to cause the user agent 20 to change the Expires header value and the destination of the REGISTER request. As a result, even in a form where a REGISTER request is sequentially transferred to the working SIP server 30 and the spare SIP server 40, registration information can be copied between SIP servers without invalidating the registration information held by each SIP server.

### (Effects of the Ninth Exemplary Embodiment)

According to the present exemplary embodiment, the proxy server 10 enables registration information to be copied between the SIP servers even in a form where a REGISTER request is sequentially transferred to the working SIP server 30 and the spare SIP server 40 without invalidating registration information held by each SIP server.

The reason is that with the provision of the expiration date change request response generating function 19 and the destination change response generating function 61, the proxy server 10 causes the processing for SIP responses (a destination change request response and an expiration date change request response) defined by the SIP protocol code to be operated at the user agent 20 to cause the user agent 20 to change the Expires header value and the destination of the REGISTER request.

### Tenth Exemplary Embodiment

Next, a proxy server 10 according to a tenth exemplary embodiment of the present invention will be detailed with reference to the drawings.

### (Structure of the Tenth Exemplary Embodiment)

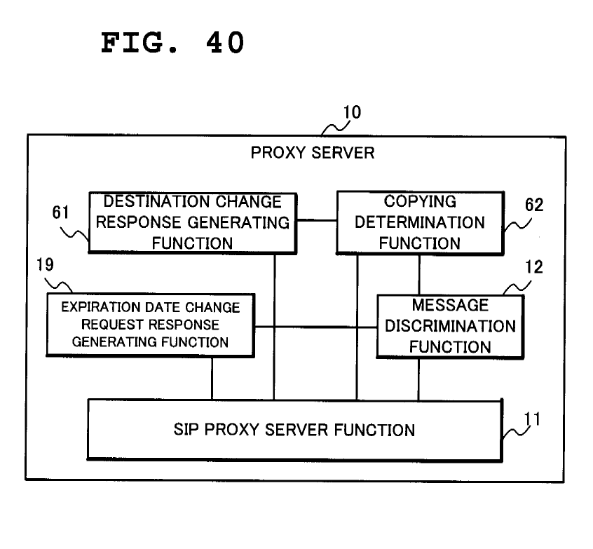

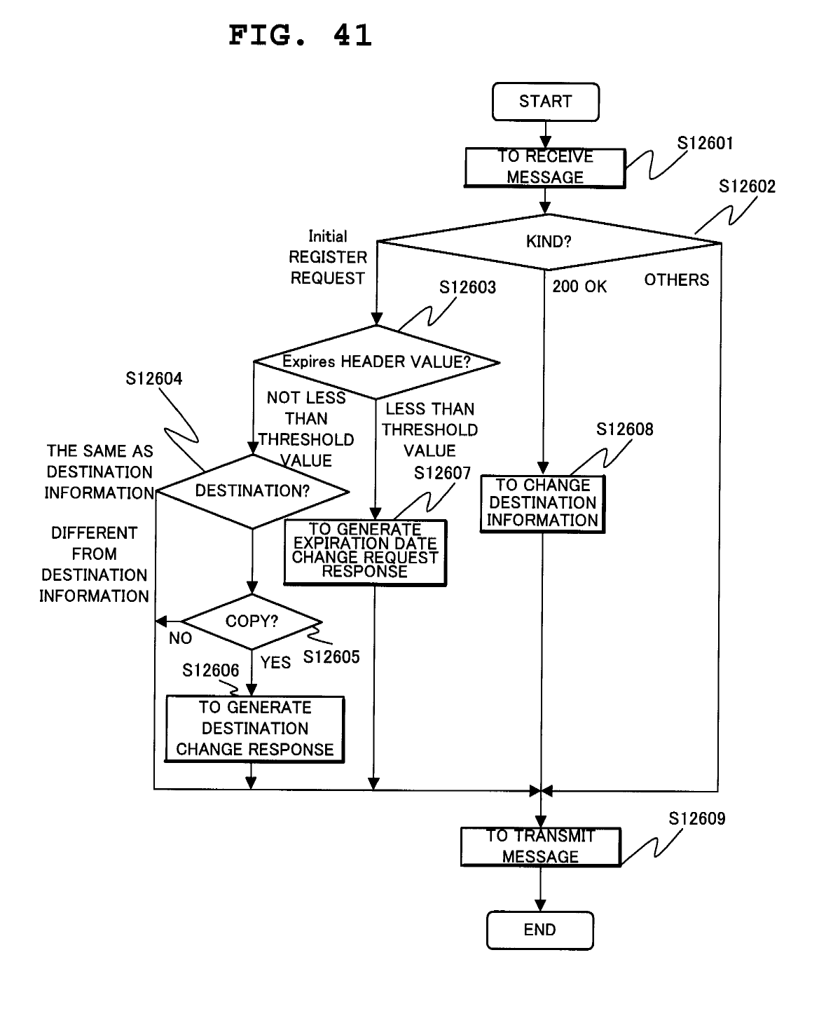

FIG. 40 is a block diagram showing a structure of the proxy server 10 according to the tenth exemplary embodiment of the present invention.

As shown in the figure, the proxy server 10 according to the tenth exemplary embodiment of the present invention is structured with the copying determination function 62 added to the structure of the proxy server 10 according to the ninth exemplary embodiment of the present invention. The copying determination function 62 has the same function as that of the copying determination function 62 in the proxy server 10 according to the seventh exemplary embodiment of the present invention.

### (Operation of the Tenth Exemplary Embodiment)

Next, operation of the proxy server 10 according to the tenth exemplary embodiment of the present invention will be detailed with reference to the drawings.

FIG. 41 is a flow chart showing operation of the proxy server 10 according to the tenth exemplary embodiment of the present invention. As illustrated in FIG. 41, operation of the proxy server 10 according to the tenth exemplary embodiment of the present invention is formed with copying determination operation of the copying determination function 62 (Step S12605) added to the flow chart indicating the operation of the proxy server 10 according to the ninth exemplary embodiment of the present invention. Since as other steps than the copying determination processing of the present exemplary embodiment, Step S12601 has the same processing contents as those of Step S12201 shown in FIG. 37 according to the ninth exemplary embodiment, Step S12602 as those of Step S12202, Step S12603 as those of Step S12203, Step S12604 as those of Step S12204, Step S12606 as those of Step S12205, Step S12607 as those of Step S12206, Step S12608 as those of Step S12207, and Step S12609 as those of Step S12208, no description will be made thereof.

Similarly to Step S11404 in the operation of the proxy server 10 according to the seventh exemplary embodiment of the present invention, the copying determination operation processing (Step S12605) can be realized as follows, for example. More specifically, when copying a message (REGISTER request) received at Step S12601 once in two times with reference to a CSeq header value, the determination is made to copy at an odd number and the determination is made not to copy at an even number.

As a result of Step S12605, when the determination is made to copy, the destination change response generating function 61 generates a destination change response (Step S12606). This processing is the same as that of Step S11004 in the operation of the proxy server 10 according to the sixth exemplary embodiment of the present invention.

Next, a data flow and operation of the entire system including the proxy server 10 according to the tenth exemplary embodiment of the present invention will be detailed with reference to the drawings.

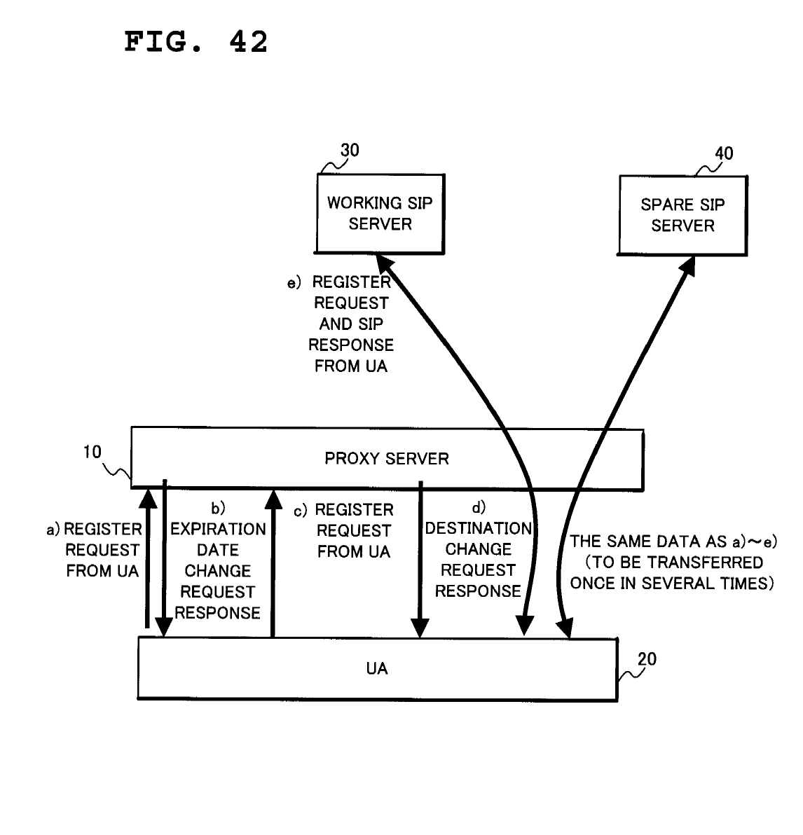

FIG. 42 shows a data flow of the entire system including the proxy server 10 according to the tenth exemplary embodiment of the present invention.

As shown in the figure, the data flow is basically the same as the data flow in the entire system including the proxy server 10 according to the ninth exemplary embodiment of the present invention. The present exemplary embodiment, however, differs from the proxy server 10 according to the ninth exemplary embodiment of the present invention in that initial REGISTER requests transferred from the user agent 20 will be transferred once in several times to the spare SIP server 40.

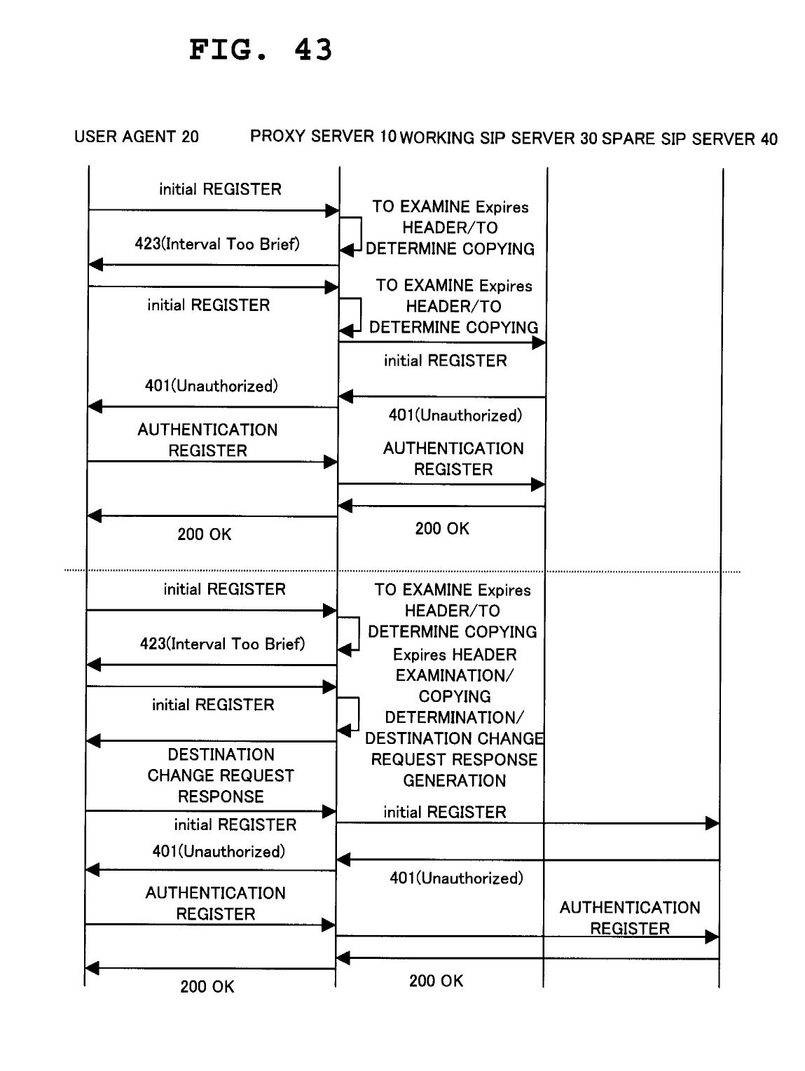

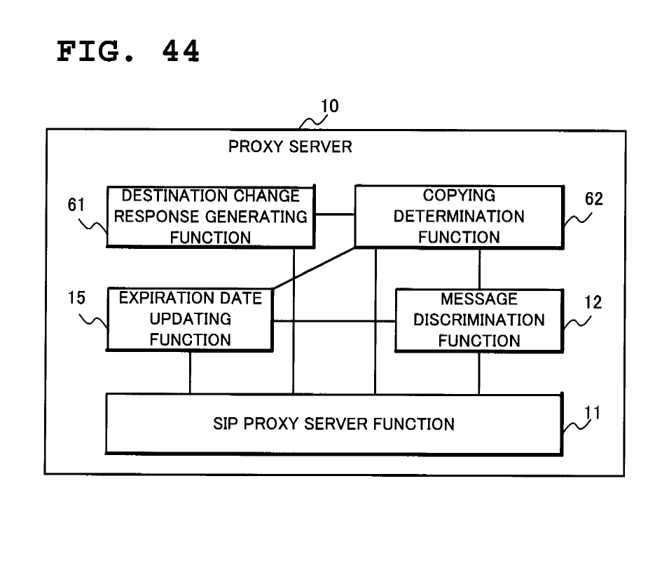

Moreover, this data flow illustrated as an operation sequence is shown in FIG. 43. As illustrated in the figure, even when registration information of the spare SIP server 40 is updated once in several times, the user agent 20 is requested to update an Expires header value to prevent invalidation of the registration information and the user agent 20 is further requested once in several times to change a destination of a REGISTER request in order to transfer the REGISTER request to the spare SIP server 40. As a result, although the REGISTER request is transferred to the spare SIP server 40 once in several times, registration information can be copied between the working/spare SIP servers without invalidating the registration information.

### (Effects of the Tenth Exemplary Embodiment)

According to the present exemplary embodiment, the proxy server 10 enables reduction in loads on registration information update of the spare SIP server 40, reduction in traffic between the proxy server 10 and the user agent 20 and reduction in traffic between the proxy server 10 and the spare SIP server 40 than in the ninth exemplary embodiment.

The reason is that with the provision of the destination change response generating function 61 and the copying determination function 62, in response to a REGISTER request from the user agent 20, the proxy server 10 requests the user agent 20 once in several times to change a destination of a REGISTER request in order to transfer a REGISTER request to the spare SIP server 40.

### Eleventh Exemplary Embodiment

Next, a proxy server 10 according to an eleventh exemplary embodiment of the present invention will be detailed with reference to the drawings.

### (Structure of the Eleventh Exemplary Embodiment)

Structure of the proxy server 10 according to the eleventh exemplary embodiment of the present invention will be detailed with reference to the drawings. FIG. 44 is a block diagram showing a structure of the proxy server 10 according to the eleventh exemplary embodiment of the present invention.

As shown in FIG. 44, the proxy server 10 according to the eleventh exemplary embodiment of the present invention is structured with the copying determination function 62 added to the structure of the proxy server 10 according to the sixth exemplary embodiment of the present invention. The copying determination function 62 has the same function as that of the copying determination function 62 in the proxy server 10 according to the seventh exemplary embodiment of the present invention which has been described above.

### (Operation of the Eleventh Exemplary Embodiment)

Next, operation of the proxy server 10 according to the eleventh exemplary embodiment of the present invention will be detailed with reference to the drawings.

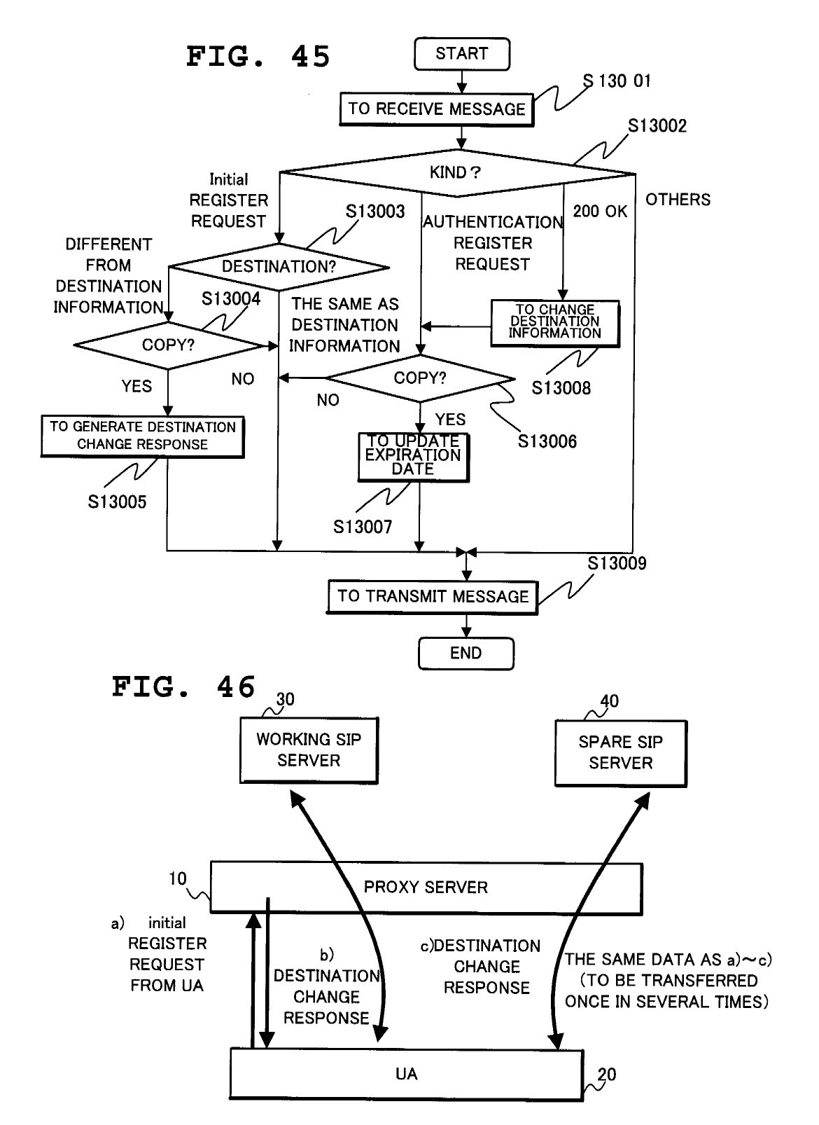

FIG. 45 is a flow chart showing operation of the proxy server 10 according to the eleventh exemplary embodiment of the present invention. As illustrated in FIG. 45, operation of the proxy server 10 according to the eleventh exemplary embodiment of the present invention is formed with the copying determination operation by the copying determination function 62 (Step S13004 and Step S13006) added to the operation of the proxy server 10 according to the sixth exemplary embodiment of the present invention. Since as other steps than the copying determination processing of the present exemplary embodiment, Step S13001 has the same processing contents as those of Step S11001 shown in FIG. 25 according to the sixth exemplary embodiment, Step S13002 as those of Step S11002, Step S13003 as those of Step S11003, Step S13005 as those of Step S11004, Step S13007 as those of Step S11005, Step S13008 as those of Step S11006, and Step S13009 as those of Step S11007, no description will be made thereof.

The copying determination processing (Step S13004 and Step S13006) is the same as the copying determination processing (Step S11404 and Step S11406) in the operation of the proxy server 10 according to the seventh exemplary embodiment of the present invention.

More specifically, as a result of Step S13002, when a kind of message received by the SIP proxy server function 11 is an initial REGISTER request and a destination of the initial REGISTER request differs from the destination information, the copying determination function 62 determines whether to execute copying to the spare SIP server 40 (Step S13004).

As a result of Step S13004, when copying, the destination change response generating function 61 generates a destination change response (Step S13005).

As a result of Step S13002, when a kind of message received by the SIP proxy server function 11 is an authentication REGISTER request, the copying determination function 62 determines whether to execute copying to the spare SIP server 40 (Step S13006).

As a result of Step S13006, when copying, the expiration date updating function 15 changes an Expires header value of the authentication REGISTER request (Step S13007).

As a result of Step S13002, when the message received by the SIP proxy server function 11 is neither an initial REGISTER request nor an authentication REGISTER request, when as a result of Step S13004 or Step S13006, the determination is made not to copy, when as a result of Step S13005, a destination change response is generated and when as a result of Step S13007, the Expires header value changing processing is executed, the SIP proxy server function 11 transmits a destination change response to the user agent 20 and otherwise it transmits the message to a designated destination (Step S13008).

Next, a data flow and operation of the entire system including the proxy server 10 according to the eleventh exemplary embodiment of the present invention will be detailed with reference to the drawings.

FIG. 46 shows a data flow of the entire system including the proxy server 10 according to the eleventh exemplary embodiment of the present invention.

As shown in the figure, the data flow is basically the same as the data flow of the entire system including the proxy server 10 according to the sixth exemplary embodiment of the present invention. The present exemplary embodiment, however, differs from the proxy server 10 according to the sixth exemplary embodiment of the present invention in that initial REGISTER requests transferred from the user agent 20 will be transferred once in several times to the spare SIP server 40.

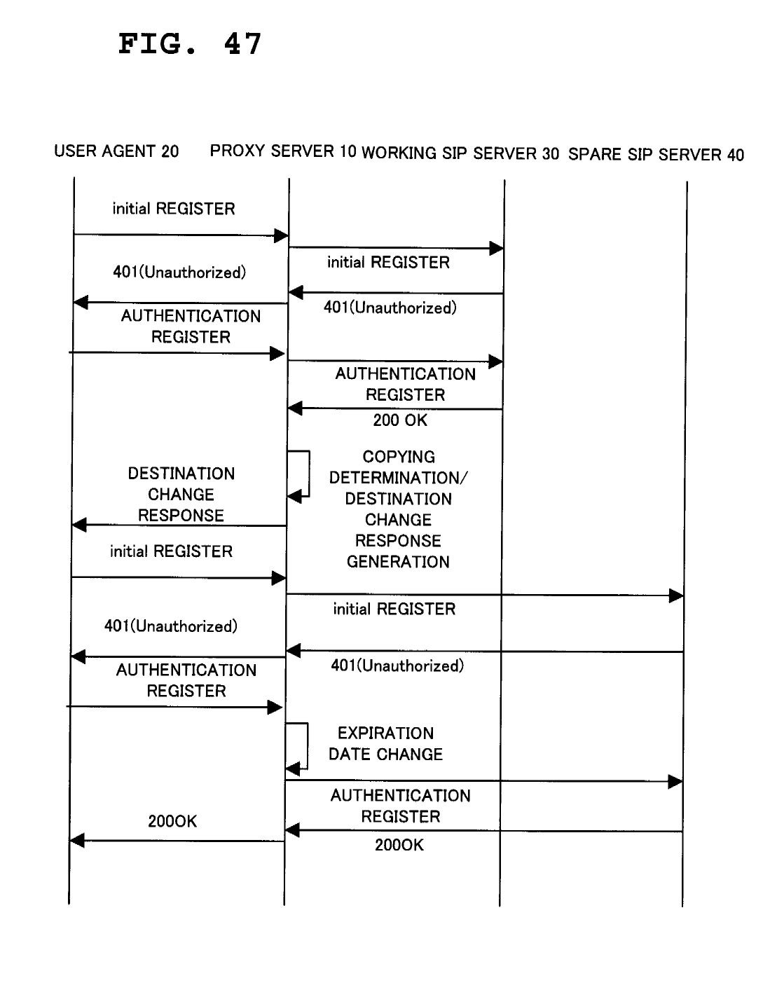

Moreover, this data flow illustrated as an operation sequence is shown in FIG. 47. As illustrated in the figure, even when registration information of the spare SIP server 40 is updated once in several times, in order to prevent invalidation of the registration information, the user agent 20 is requested once in several times to change an Expires header value and further change a destination of a REGISTER request to transfer the REGISTER request to the spare SIP server 40. As a result, although the REGISTER request is transferred to the spare SIP server 40 once in several times, registration information can be copied between the working/spare SIP servers without invalidating the registration information.

### (Effects of the Eleventh Exemplary Embodiment)

The present exemplary embodiment enables reduction in loads on registration information update of the spare SIP server 40, reduction in traffic between the proxy server 10 and the user agent 20 and reduction in traffic between the proxy server 10 and the spare SIP server 40 than in the sixth exemplary embodiment.

The reason is that the expiration date updating function 15 changes an Expiration header value of an authentication REGISTER request and the copying determination function 62 causes the proxy server 10 to return a destination change response to the user agent 20 once in several times in response to a REGISTER request from the user agent 20, thereby transferring an initial REGISTER request from the user agent 20 responsive to the response to the spare SIP server 40.

### Twelfth Exemplary Embodiment

Next, a proxy server 10 according to a twelfth exemplary embodiment of the present invention will be detailed with reference to the drawings.

### (Structure of the Twelfth Exemplary Embodiment)

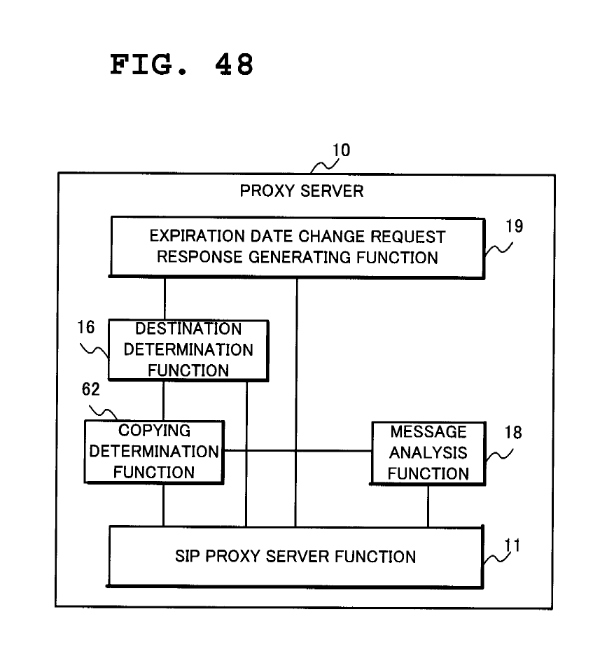

Structure of the proxy server 10 according to the twelfth exemplary embodiment of the present invention will be detailed with reference to the drawings. FIG. 48 is a block diagram showing a structure of the proxy server 10 according to the twelfth exemplary embodiment of the present invention.

As shown in FIG. 48, the proxy server 10 according to the twelfth exemplary embodiment of the present invention is structured with the copying determination function 62 added to the structure of the proxy server 10 according to the fourth exemplary embodiment of the present invention. The copying determination function 62 has the same function as that of the copying determination function 62 in the proxy server 10 according to the seventh exemplary embodiment of the present invention which has been described above.

### (Operation of the Twelfth Exemplary Embodiment)

Next, operation of the proxy server 10 according to the twelfth exemplary embodiment of the present invention will be detailed with reference to the drawings.

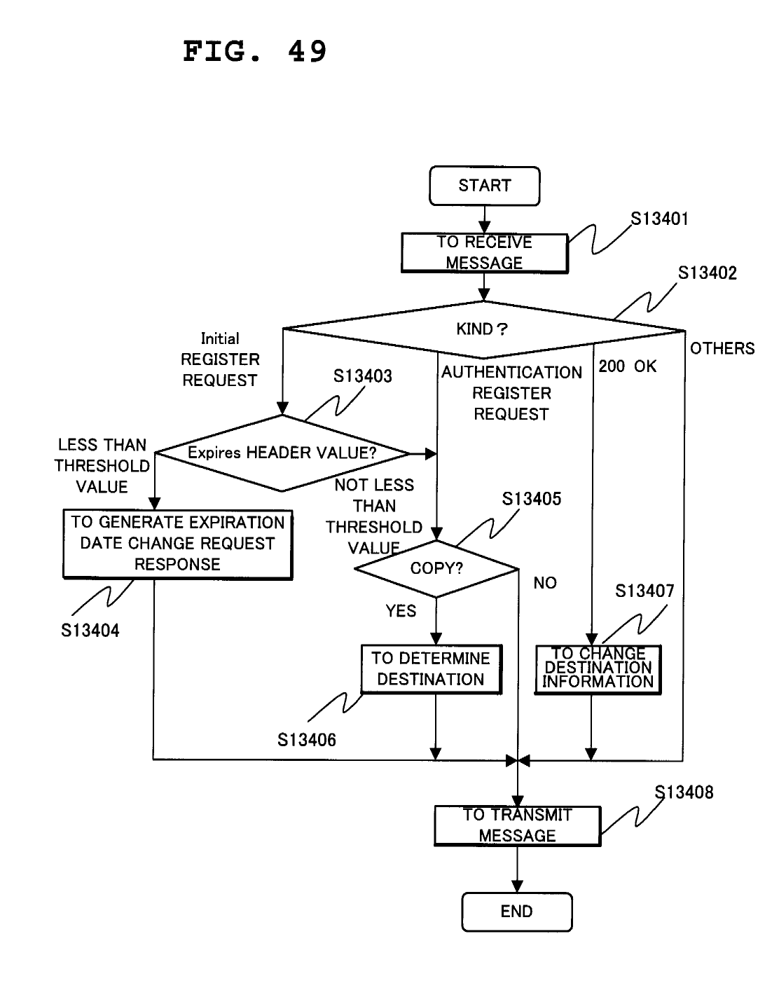

FIG. 49 is a flow chart showing operation of the proxy server 10 according to the twelfth exemplary embodiment of the present invention. As illustrated in FIG. 49, operation of the proxy server 10 according to the twelfth exemplary embodiment of the present invention is formed with the copying determination processing of the copying determination function 62 (Step S13405) added to the operation of the proxy server 10 according to the fourth exemplary embodiment of the present invention. Since as other steps than the copying determination processing of the present exemplary embodiment, Step S13401 has the same processing contents as those of Step S1301 shown in FIG. 17 according to the fourth exemplary embodiment, Step S13402 as those of Step S1302, Step S13403 as those of Step S1303, Step S13404 as those of Step S1304, Step S13406 as those of Step S1305, Step S13407 as those of Step S1306, and Step S13408 as those of Step S1307, no description will be made thereof.

The copying determination processing (Step S13405) is the same as the copying determination processing (Step S11404 and Step S11406) in the operation of the proxy server 10 according to the seventh exemplary embodiment of the present invention.

More specifically, when as a result of Step S13403, an Expires header value is not less than a threshold value or when as a result of Step S13402, a kind of message received by the SIP proxy server function 11 is an authentication REGISTER request, the copying determination function 62 determines whether to execute copying to the spare SIP server 40 (Step S13405).

As a result of Step S13405, when copying, the destination determination function 16 determines a destination of a REGISTER request with reference to the destination information (Step S13406).

Next, a data flow and operation of the entire system including the proxy server 10 according to the twelfth exemplary embodiment of the present invention will be detailed with reference to the drawings.

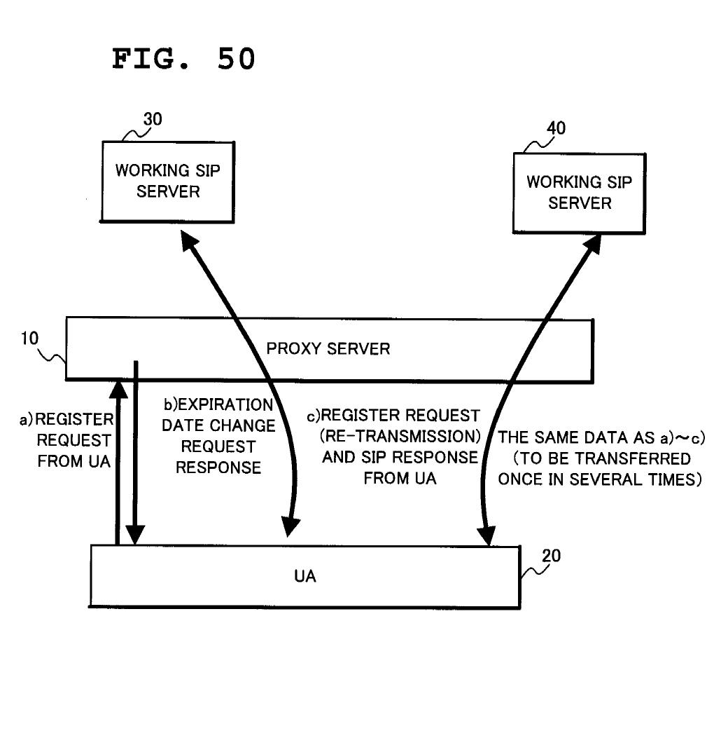

FIG. 50 shows a data flow of the entire system including the proxy server 10 according to the twelfth exemplary embodiment of the present invention.

As shown in the figure, the data flow is basically the same as the data flow of the entire system including the proxy server 10 according to the fourth exemplary embodiment of the present invention. The present exemplary embodiment, however, differs from the data flow in the entire system including the proxy server 10 according to the fourth exemplary embodiment of the present invention in that initial REGISTER requests transferred from the user agent 20 will be transferred once in several times to the spare SIP server 40.

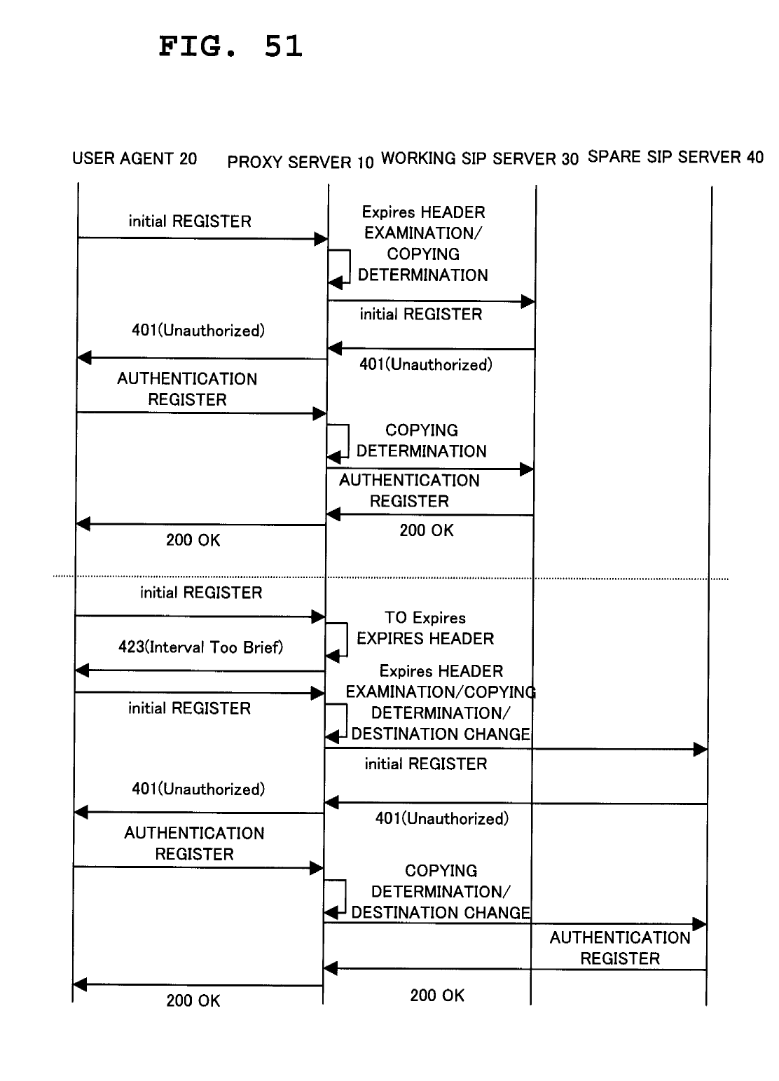

Moreover, this data flow illustrated as an operation sequence is shown in FIG. 51. As illustrated in the figure, even when the registration information of the spare SIP server 40 is updated once in several times, the user agent 20 is requested to change an Expires header value to prevent invalidation of the registration information. Moreover, in order to transfer the REGISTER request to the spare SIP server 40, a destination of a REGISTER request is changed once in several times by the proxy server 10. As a result, although the REGISTER request is transferred to the spare SIP server 40 once in several times, the registration information can be copied between the working/spare SIP servers without invalidating the registration information.

### (Effects of the Twelfth Exemplary Embodiment)

The present exemplary embodiment enables reduction in loads on registration information update of the spare SIP server 40, reduction in traffic between the proxy server 10 and the user agent 20 and reduction in traffic between the proxy server 10 and the spare SIP server 40 than in the fourth exemplary embodiment.

The reason is that in the proxy server 10, the destination determination function 16 and the copying determination function 62 change a destination of a REGISTER request from the user agent 20 once in several times and transfer a copy of a received REGISTER request to the spare SIP server 40.

### Thirteenth Exemplary Embodiment

Next, a proxy server 10 according to a thirteenth exemplary embodiment of the present invention will be detailed with reference to the drawings.

### (Structure of the Thirteenth Exemplary Embodiment)

Structure of the proxy server 10 according to the thirteenth exemplary embodiment of the present invention will be detailed with reference to the drawings. FIG. 52 is a block diagram showing a structure of the proxy server 10 according to the thirteenth exemplary embodiment of the present invention.

As shown in FIG. 52, the proxy server 10 according to the thirteenth exemplary embodiment of the present invention is structured with the copying determination function 62 added to the structure of the proxy server 10 according to the second exemplary embodiment of the present invention. The copying determination function 62 has the same function as the copying determination function 62 in the proxy server 10 according to the seventh exemplary embodiment of the present invention which has been described above.

### (Operation of the Thirteenth Exemplary Embodiment)

Next, operation of the proxy server 10 according to the thirteenth exemplary embodiment of the present invention will be detailed with reference to the drawings.

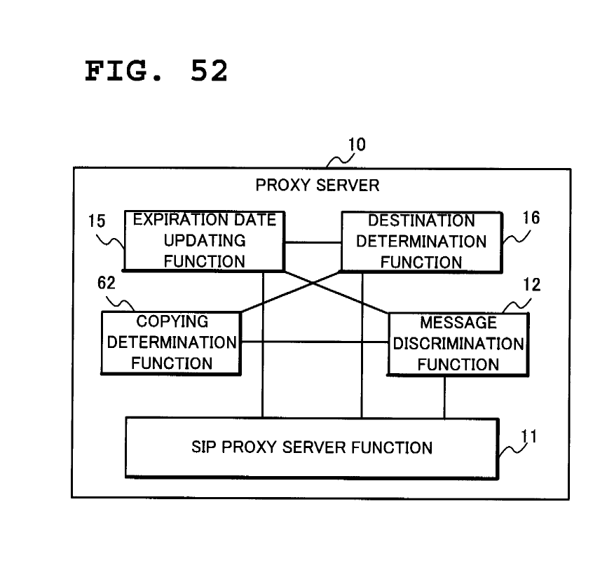

FIG. 53 is a flow chart showing operation of the proxy server 10 according to the thirteenth exemplary embodiment of the present invention. As illustrated in FIG. 53, operation of the proxy server 10 according to the thirteenth exemplary embodiment of the present invention is formed with the copying determination processing of the copying determination function 62 (Step S13804) added to the operation of the proxy server 10 according to the second exemplary embodiment of the present invention. Since as other steps than the copying determination processing of the present exemplary embodiment, Step S13801 has the same processing contents as those of Step S701 shown in FIG. 9 according to the second exemplary embodiment, Step S13802 as those of Step S702, Step S13803 as those of Step S703, Step S13805 as those of Step S704, Step S13806 as those of Step S705, Step S13807 as those of Step S706, and Step S13808 as those of Step S707, no description will be made thereof.

The copying determination processing (Step S13804) is the same as the copying determination processing (Step S11404 and Step S11406) in the operation of the proxy server 10 according to the seventh exemplary embodiment of the present invention.

More specifically, as a result of the addition of this Step S13804, Step S13806 will be changed as follows. In a case where a message received as a result of Step S13802 is a REGISTER request, when the determination is made not to copy as a result of Step S13804 after Expires header value change processing (Step S13803), because none of the processing at Step S13805 is executed, a destination (the working SIP server 30) recited in the received message is made to reflect on the destination information. On the other hand, when the determination is made to copy as a result of Step S13804, because the processing of Step S13805 is executed, the destination determined as a result of Step S13805 is made to reflect on the destination information.

Next, a data flow and operation of the entire system including the proxy server 10 according to the thirteenth exemplary embodiment of the present invention will be detailed with reference to the drawings.

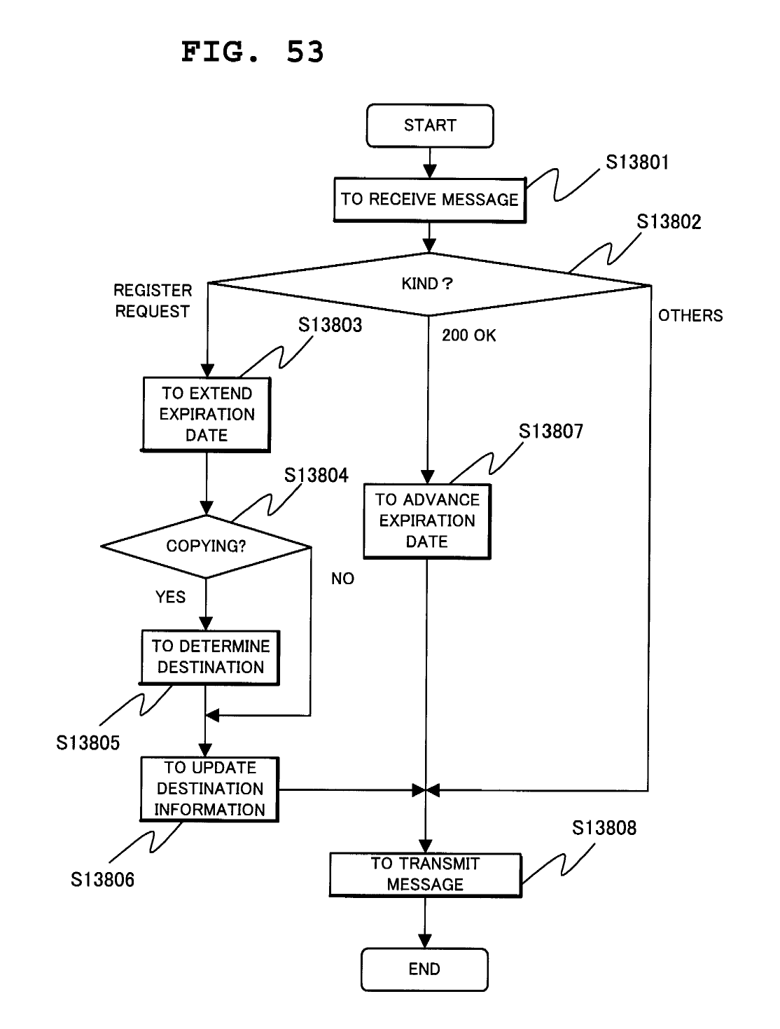

FIG. 54 shows a data flow in the entire system including the proxy server 10 according to the thirteenth exemplary embodiment of the present invention.

As shown in the figure, the data flow is basically the same as that in the entire system including the proxy server 10 according to the second exemplary embodiment of the present invention. Difference from the data flow in the entire system including the proxy server 10 according to the second exemplary embodiment of the present invention resides in that initial REGISTER requests transferred from the user agent 20 will be transferred once in several times to the spare SIP server 40.

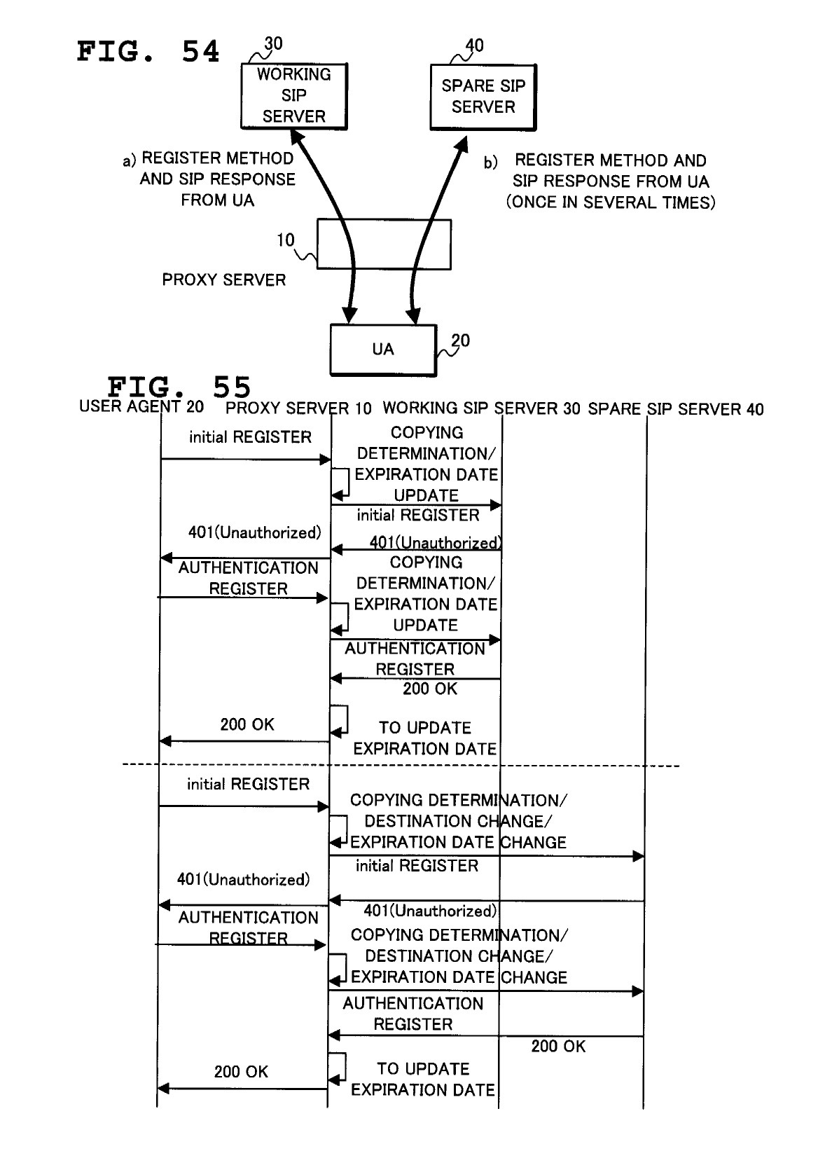

Moreover, this data flow illustrated as an operation sequence is shown in FIG. 55. As illustrated in the figure, even when the registration information of the spare SIP server 40 is updated once in several times, an Expires header value is changed by the proxy server 10 to prevent invalidation of the registration information.

Furthermore, in order to transfer the REGISTER request to the spare SIP server, a destination of a REGISTER request is also changed once in several times by the proxy server 10. As a result, although the REGISTER request is transferred to the spare SIP server 40 once in several times, registration information can be copied between the working/spare SIP servers without invalidating the registration information.

### (Effects of the Thirteenth Exemplary Embodiment)

The proxy server 10 in the present exemplary embodiment enables reduction in loads on registration information update of the spare SIP server 40 and reduction in traffic between the proxy server 10 and the spare SIP server 40 than in the second exemplary embodiment.

The reason is that with the provision of the destination determination function 16 and the copying determination function 62, the proxy server 10 copies a REGISTER request received from the user agent 20 once in several times and changes its destination to transfer an obtained request to the spare SIP server 40.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

For example, while in the above-described exemplary embodiments, the description has been made of a form enabling servers to copy registration information of an external terminal by using an SIP (Session Initial Protocol), a protocol to be used is not limited to the SIP and, for example, it is possible in a WEB system comprising a WEB server and a client to enable a plurality of servers to copy client information by digest authentication by using an HTTP (HyperText Transfer Protocol).

For solving the first problem, the proxy server of the above-described exemplary embodiments is designed to hold a function, in addition to the function held by the above-described SIP proxy server, of generating a REGISTER request based on temporarily recorded contents of a REGISTER request from a user terminal. More specifically, the proxy server of the present invention generates a REGISTER request for a spare SIP server at an intermediate point between a user agent and an SIP server and transmits the same to the spare SIP server, thereby realizing registration information copying.

For solving the second problem, the proxy server of the above-described exemplary embodiments is designed to hold a user identifier and a password of the proxy server itself to execute Digest authentication between the proxy server and the spare SIP server. This guarantees properness of one who accesses the spare SIP server.

For solving the third problem, the proxy server of the above-described exemplary embodiments transmits a copied REGISTER request to the spare SIP server after confirming a REGISTER request processing completion response (200 OK) from the working SIP server. Return of the SIP response (200 OK) form the working SIP server denotes that a REGISTER request transmitted from a user agent is proper and processing has been normally completed at the working SIP server. In other words, by confirming that a processing result of a REGISTER request to be transmitted to the spare SIP server which is obtained at the working SIP server is the SIP response (200 OK), properness of the REGISTER request to be transmitted to the spare SIP server can be indicated to the spare SIP server.

With the foregoing units, registration information of the working SIP server can be copied to the spare SIP server after guaranteeing properness of one who accesses (proxy server) the spare SIP server and of a transmission REGISTER request.

The above-described exemplary embodiments attains the effects set forth below.

The first effect is realizing registration information copying. This is because the proxy server holds the function of generating a REGISTER request (message) to be transmitted to the spare SIP server in addition to the function that the proxy server originally has.

The second effect is enabling, at the copying of registration information, properness of one who accesses the spare SIP server to be indicated to the spare SIP server. This is because the proxy server is designed to hold its own user identifier and password to execute Digest authentication between the proxy server and the spare SIP server.

### INCORPORATION BY REFERENCE

This application is based upon and claims the benefit of priority from Japanese patent application No. 2006-223363, filed on Aug. 18, 2006, the disclosure of which is incorporated herein in its entirety by reference.

### INDUSTRIAL APPLICABILITY

The proxy server of the present invention is applicable to an SIP network having a plurality of user terminals and a plurality of SIP servers.

1. A proxy server, comprising:
a proxy server function of intervening in a message among an external user terminal, an external working communication control device and an external spare communication control device;
a message discrimination function of discriminating a kind of message received by said proxy server function;
a temporary storage function of, when determination is made by the message discrimination function that said message is a message requesting processing of information related to said user terminal which is held in said working communication control device, temporarily recording contents of the message; and
a request generation function of, when said message is accepted by said working communication control device, copying a message having the same contents as the contents of said message to said spare communication control device for authentication.

2. A proxy server, comprising:
an SIP proxy server function of intervening in an SIP message transmitted/received between a user terminal, and a working SIP server and a spare SIP server;
a message discrimination function of discriminating a kind and a transmission source of an SIP message received by said SIP proxy server function;
a temporary storage function of temporarily storing a copy of a REGISTER request of said user terminal which is received by said SIP proxy server function; and
a request generation function of generating a REGISTER request for authentication by said spare SIP server based on a copy of said REGISTER request corresponding to a REGISTER request whose processing at said working SIP server is normally completed.

3. The proxy server according to claim 2, wherein
said request generation function generates a REGISTER request to be transmitted to said spare SIP server by using a user identifier and a password of the proxy server itself which are for use in Digest authentication with the spare SIP server to which registration information of said user terminal is to be copied.

4. The proxy server according to claim 2, further comprising:
a function of generating a copy of a REGISTER request to be transmitted to said working SIP server from said user terminal through the proxy server itself and after confirming normal processing completion of said REGISTER request transmitted to said working SIP server, transmitting, to the spare SIP server, a REGISTER request which is newly generated based on the copied REGISTER request and a user identifier and a password for identifying the proxy server itself which are held in advance.

5. The proxy server according to any one of claim 2 to claim 4, further comprising:
a copying unit for generating, when a received message is a REGISTER request, a copy of the REGISTER request;
a transmission source discrimination unit for discriminating, when a received message is other than a REGISTER request, a transmission source of the message;
a first request generation unit for generating, when a received message is an SIP response indicative of authentication allowance and a transmission source is the working SIP server, a first authentication REGISTER request based on said copied REGISTER request and the user identifier and the password for identifying said proxy server itself;
a second REGISTER request generation unit for generating, when a received message indicates yet-to-be-allowed and a transmission source is the spare SIP server, a second authentication REGISTER request in response to said received message based on the user identifier and the password for identifying said proxy server itself; and
a transmission unit for transmitting a received message to said user terminal when the received message indicates yet-to-be-allowed and a transmission source is the working SIP server.

6. A proxy server, comprising:
an SIP proxy server function of transmitting and receiving an external message;
a message discrimination function of identifying a kind of message received by said SIP proxy server function; and
a transmission destination determination function of determining a transmission destination of said REGISTER request from among a plurality of external SIP servers as transmission destinations.

7. The proxy server according to claim 6, wherein
said transmission destination determination function determines a transmission destination of a REGISTER request transmitted from a user terminal to a working SIP server through the proxy server itself to be a spare SIP server.

8. The proxy server according to claim 7, wherein said transmission destination determination function refers to an identifier for identifying said user terminal among transmission destination information indicative of a transmission destination of a REGISTER request to obtain a transmission destination of said REGISTER request from the user terminal from the transmission destination information.

9. The proxy server according to any one of claim 6 to claim 8, wherein said transmission destination determination function, when a received message is an Initial REGISTER request, determines a transmission destination not recited in a transmission destination of the message to be a transmission destination of the Initial REGISTER request, while when the received message is an authentication REGISTER request, determines the transmission destination of the message to be a transmission destination of the authentication REGISTER request.

10. The proxy server according to any one of claim 6 to claim 8, comprising a re-transmission request response generating function of generating a re-transmission request response for requesting said user terminal to re-transmit an Initial REGISTER request, wherein
said re-transmission request response generating function, when a received message is an SIP response indicative of authentication allowance and a transmission source is the working SIP server, transmits said re-transmission request response to said user terminal, and
said transmission destination determination function determines a transmission destination of an Initial REGISTER request re-transmitted from said user terminal to be said spare SIP server.

11. A proxy server, comprising:
an SIP proxy server function of transmitting and receiving an external message;
a message discrimination function of identifying a kind and a transmission source of a message received by said SIP proxy server function;
a transmission destination determination function of determining a transmission destination of said REGISTER request from among a plurality of external SIP servers as transmission destinations; and
a re-transmission request response generating function of, when said working SIP server accepts a REGISTER request, generating an SIP response urging re-transmission of a REGISTER request without sending an acceptance completion notification to a user terminal.

12. A proxy server, comprising:
an SIP proxy server function of transmitting and receiving an external message;
a message discrimination function of identifying a kind of message received by said SIP proxy server function; and
a destination change request response generating function of generating a destination change request response for causing a user terminal to change a transmission destination of an SIP request to a spare SIP server after confirming normal processing completion of said REGISTER request transmitted to a working SIP server through the proxy server itself.

13. The proxy server according to claim 12, wherein said destination change request response generating function generates said destination change request response when a received message is an SIP response indicative of authentication allowance and a transmission source is the working SIP server.

14. A proxy server, comprising:
an SIP proxy server function of transmitting and receiving an external message;
a message discrimination function of identifying a kind of message received by said SIP proxy server function;
transmission destination correspondence information indicative of a correspondence relationship between a user terminal and a transfer destination of a REGISTER request to be transmitted from said user terminal through the proxy server itself; and
a destination change request response generating function of generating a destination change request response for causing the user terminal to change a transmission destination of an SIP request when a transmission destination of a received Initial REGISTER request differs from a transmission destination indicated by said transmission destination correspondence information.

15. The proxy server according to claim 14, wherein
when a message received from said spare SIP server is an SIP response indicative of authentication allowance, updates said transmission destination correspondence information, and
when receiving a message of an SIP response indicative of following authentication allowance from a new spare SIP server, correlates a transmission destination of a relevant REGISTER request with a new working SIP server and when receiving the message from the new working SIP server, correlates the transmission destination of the relevant REGISTER request with the new spare SIP server.

16. The proxy server according to any one of claim 6 to claim 9, claim 14 and claim 15, further comprising an expiration date updating function of updating an expiration date of a received message.

17. The proxy server according to claim 16, wherein said expiration date updating function, when a received message is an authentication REGISTER request, extends an expiration date of the authentication REGISTER request and when the received message is the SIP response indicative of authentication allowance, advances the expiration date.

18. The proxy server according to any one of claim 1 to claim 5, wherein a copy of said REGISTER request is generated once in several times out of times of said transmission.

19. The proxy server according to any one of claim 1 to claim 5, and claim 18, further comprising an expiration date updating function of, at the time of generation of a REGISTER request to be transmitted to the spare SIP server, extending an expiration date of the REGISTER request.

20. The proxy server according to claim 10 or claim 11, wherein said re-transmission request response generating function generates said re-transmission request response in response to one of SIP responses indicative of authentication allowance which are received a plurality of times from said working SIP server.

21. The proxy server according to claim 20, wherein said re-transmission request response generating function determines whether to generate said re-transmission request response upon receiving an Initial REGISTER request from said user terminal, and which further comprises:
an expiration date updating function of, when determining to generate said re-transmission request response, updating an expiration date of a received message.

22. The proxy server according to claim 16 or claim 21, wherein said expiration date updating function updates said expiration date according to the total number of said working SIP servers and said spare SIP servers.

23. The proxy server according to claim 21 or claim 22, wherein said expiration date updating function, when determination is made to generate said re-transmission request response, extends an expiration date of an authentication REGISTER request received from said user terminal and when a received message is the SIP response indicative of authentication allowance, advances the expiration date.

24. A proxy server, comprising:
an SIP proxy server function of transmitting and receiving an external message;
a message discrimination function of identifying a kind and a transmission source of a message received by said SIP proxy server function; and
a destination change request response generating function of, upon reception of an Initial REGISTER request to be transmitted from a user terminal to a working SIP server through the proxy server itself, generating a destination change request response for causing the user terminal to change a transmission destination of the Initial REGISTER request to a spare SIP server.

25. The proxy server according to claim 24, further comprising:
transmission destination correspondence information indicative of a correspondence relationship between the user terminal and a transfer destination of a REGISTER request to be transmitted from said user terminal through the proxy server itself; wherein
said destination change request response generating function generates said destination change request response when a transmission destination of a received Initial REGISTER request differs from a transmission destination indicated by said transmission destination correspondence information.

26. The proxy server according to claim 25, which
when a message received from said spare SIP server is an SIP response indicative of authentication allowance, updates said transmission destination correspondence information, and
when receiving a message of an SIP response indicative of following authentication allowance from a new spare SIP server, correlates a transmission destination of a relevant REGISTER request with a new working SIP server and when receiving the message from the new working SIP server, correlates the transmission destination of the relevant REGISTER request with the new spare SIP server.

27. The proxy server according to any one of claim 24 to claim 26, wherein
said destination change request response generating function generates said destination change request response in response to one of a plurality of Initial REGISTER requests received which are to be transmitted to the working SIP server through the proxy server itself.

28. The proxy server according to any one of claim 14 to claim 17, claim 22, and claim 24 to claim 27, wherein
said destination change request response generating function generates said destination change request response in response to one of a plurality of cases where a transmission destination of a received Initial REGISTER request differs from a transmission destination indicated by said transmission destination correspondence information.

29. The proxy server according to any one of claim 6 to claim 9, wherein in response to one of a plurality of Initial REGISTER requests received from said user terminal, said transmission destination determination function determines said spare SIP server to be a transmission destination of said Initial REGISTER request.

30. The proxy server according to any one of claim 6 to claim 9, claim 24 to claim 26, and claim 29, further comprising:
an expiration date change request response generating function of generating an expiration date change request response for requesting said user terminal to change an expiration date of a received message.

31. The proxy server according to claim 30, wherein
said expiration date change request response generating function generates said expiration date change request response based on a result of comparison between an expiration date of a received Initial REGISTER request and a predetermined threshold value.

32. The proxy server according to claim 31, wherein said predetermined threshold value is determined according to the total number of said working SIP servers and said spare SIP servers.

33. A proxy server, comprising:
an SIP proxy server function of transmitting and receiving an external message;
a message discrimination function of discriminating a kind of message received by said SIP proxy server function; and
a destination change request response generating function of generating a destination change request response for causing a user terminal to change a transmission destination of said Initial REGISTER request to a spare SIP server in response to one of a plurality of Initial REGISTER requests received which are to be transmitted to a working SIP server through the proxy server itself.

34. The proxy server according to claim 33, wherein
said destination change request response generating function generates said destination change request response when an expiration date of a received Initial REGISTER request is extended.

35. A communication system including working and spare communication control devices for transmitting and receiving a message to/from an external user terminal, and a proxy server for intervening in transmission and reception of said message, wherein said proxy server comprises:
a proxy server function of intervening in transmission and reception of said message;
a message discrimination function of discriminating a kind of message received by said proxy server function;
a temporary storage function of, when determination is made by said message discrimination function that said message is a message requesting processing of information related to said user terminal which is held in said working communication control device, temporarily recording contents of the message; and
a request generation function of, when said message is accepted by said working communication control device, copying a message having the same contents as the contents of said message to said spare communication control device for authentication, thereby enabling authentication of said user terminal to be executed between said proxy server and said spare communication control device by said REGISTER request generated by copying.

36. A communication system including working and spare SIP servers for transmitting and receiving an SIP message to/from an external user terminal, and a proxy server for intervening in transmission and reception of said SIP message, wherein said proxy server comprises:
an SIP proxy server function of intervening in transmission and reception of an SIP message;
a message discrimination function of discriminating a kind and a transmission source of an SIP message received by said SIP proxy server function;
a temporary storage function of temporarily storing a copy of a REGISTER request of said user terminal which is received by said SIP proxy server function; and
a request generation function of generating a REGISTER request for authentication by said spare SIP server based on a copy of said REGISTER request corresponding to a REGISTER request whose processing at said working SIP server is normally completed and a user identifier and a password of said proxy server which are for use in Digest authentication with a spare SIP server to which registration information of said user terminal is copied, thereby enabling authentication of said user terminal to be executed between said proxy server and said spare SIP server by said REGISTER request generated by copying.

37. A communication system including working and spare SIP servers for transmitting and receiving an SIP message to/from an external user terminal, and a proxy server for intervening in transmission and reception of said SIP message, wherein said proxy server comprises:
an SIP proxy server function of transmitting and receiving an external message;
a message discrimination function of identifying a kind of message received by said SIP proxy server function; and
a transmission destination determination function of determining a transmission destination of a REGISTER request to be transmitted from said user terminal to the working SIP server through said proxy server itself from among a plurality of spare SIP servers as transmission destinations, thereby enabling authentication of said user terminal to be executed between said user terminal and said spare SIP server by said REGISTER request.

38. A communication system including working and spare SIP servers for transmitting and receiving an SIP message to/from an external user terminal, and a proxy server for intervening in transmission and reception of said SIP message, wherein said proxy server comprises:
an SIP proxy server function of transmitting and receiving an external message;
a message discrimination function of identifying a kind and a transmission source of a message received by said SIP proxy server function;
a transmission destination determination function of determining a transmission destination of said REGISTER request from among a plurality of external SIP servers as transmission destinations; and
a re-transmission response generating function of, when said working SIP server accepts a REGISTER request, generating an SIP response which urges re-transmission of a REGISTER request without sending an acceptance completion notification to the user terminal; wherein
said transmission destination determination function determines said spare SIP server as a transmission destination of a REGISTER request re-transmitted from said user terminal, thereby enabling authentication of said user terminal to be executed between said user terminal and said spare SIP server by said REGISTER request.

39. A communication system including working and spare SIP servers for transmitting and receiving an SIP message to/from an external user terminal, and a proxy server for intervening in transmission and reception of said SIP message, wherein said proxy server comprises:
an SIP proxy server function of transmitting and receiving an external message;
a message discrimination function of identifying a kind of message received by said SIP proxy server function; and
a destination change request response generating unit for generating a destination change request response which causes said user terminal to change a transmission destination of an SIP request to the spare SIP server after confirming normal processing completion of said REGISTER request transmitted to the working SIP server through said proxy server itself, thereby enabling authentication of said user terminal to be executed between said user terminal and said spare SIP server by said REGISTER request.

40. A communication system including working and spare SIP servers for transmitting and receiving an SIP message to/from an external user terminal, and a proxy server for intervening in transmission and reception of said SIP message, wherein said proxy server comprises:
an SIP proxy server function of transmitting and receiving an external message;
a message discrimination function of identifying a kind of message received by said SIP proxy server function;
transmission destination correspondence information indicative of a correspondence relationship between said user terminal and a transfer destination of a REGISTER request to be transmitted from said user terminal through the proxy server itself; and
a destination change request response generating function of generating a destination change request response for causing said user terminal to change a transmission destination of an SIP request when a transmission destination of a received Initial REGISTER request differs from a transmission destination indicated by said transmission destination correspondence information, thereby enabling authentication of said user terminal to be executed between said user terminal and said spare SIP server by said REGISTER request.

41. The communication system according to claim 40, wherein said proxy server
when a message received from said spare SIP server is an SIP response indicative of authentication allowance, updates said transmission destination correspondence information, and
when receiving a message of an SIP response indicative of following authentication allowance from a new spare SIP server, correlates a transmission destination of a relevant REGISTER request with a new working SIP server and when receiving the message from a new working SIP server, correlates the transmission destination of the relevant REGISTER request with the new spare SIP server.

42. The communication system according to any one of claim 37, claim 40 and claim 41, wherein said proxy server comprises an expiration date updating function of updating an expiration date of a received message.

43. The communication system according to claim 35 or claim 36, wherein said proxy server generates a copy of said REGISTER request once in several times out of times of said transmission.

44. The communication system according to any one of claim 35, claim 36, and claim 43, further comprising an expiration date updating function of, at the time of generation of a REGISTER request to be transmitted to the spare SIP server, extending an expiration date of the REGISTER request.

45. The communication system according to claim 38, wherein said re-transmission request response generating function generates said re-transmission request response in response to one of SIP responses indicative of authentication allowance which are received a plurality of times from said working SIP server.

46. The communication system according to claim 45, wherein
said re-transmission request response generating function determines whether to generate said re-transmission request response upon reception of an Initial REGISTER request from said user terminal, and
said proxy server comprises, when determining to generate said re-transmission request response, an expiration date updating function of updating an expiration date of a received message.

47. A communication system including working and spare SIP servers for transmitting and receiving an SIP message to/from an external user terminal, and a proxy server for intervening in transmission and reception of said SIP message, wherein said proxy server comprises:
an SIP proxy server function of transmitting and receiving an external message;
a message discrimination function of identifying a kind of message received by said SIP proxy server function; and
a destination change request response generating function of, upon reception of an Initial REGISTER request to be transmitted from the user terminal to the working SIP server through said proxy server itself, generating a destination change request response for causing said user terminal to change a transmission destination of the Initial REGISTER request to the spare SIP server, thereby enabling authentication of said user terminal to be executed between said user terminal and said spare SIP server by said REGISTER request.

48. The communication system according to claim 47, wherein
said proxy server comprises transmission destination correspondence information indicative of a correspondence relationship between said user terminal and a transfer destination of a REGISTER request to be transmitted from said user terminal through said proxy server itself, and
said destination change request response generating function generates said destination change request response when a transmission destination of a received Initial REGISTER request differs from a transmission destination indicated by said transmission destination correspondence information.

49. The communication system according to claim 48, wherein said proxy server when a message received from said spare SIP server is an SIP response indicative of authentication allowance, updates said transmission destination correspondence information, and
when receiving a message of an SIP response indicative of following authentication allowance from a new spare SIP server, correlates a transmission destination of a relevant REGISTER request with a new working SIP server and when receiving the message from the new working SIP server, correlates the transmission destination of the relevant REGISTER request with the new spare SIP server.

50. The communication system according to any one of claim 47 to claim 49, wherein
said destination change request response generating function generates said destination change request response in response to one of a plurality of Initial REGISTER requests received which are to be transmitted to said working SIP server through said proxy server.

51. The communication system according to any one of claim 40 to claim 42, and claim 47 to claim 50, wherein
said destination change request response generating function generates said destination change request response in response to one of a plurality of cases where a transmission destination of a received Initial REGISTER request differs from a transmission destination indicated by said transmission destination correspondence information.

52. The communication system according to claim 38 or claim 39, wherein in response to one of a plurality of Initial REGISTER requests received from said user terminal, said transmission destination determination function determines said spare SIP server to be a transmission destination of said Initial REGISTER request.

53. The communication system according to any one of claim 37, claim 47 to claim 49, and claim 52, further comprising:
an expiration date change request response generating function of generating an expiration date change request response for requesting said user terminal to change an expiration date of a received message.

54. A communication system including working and spare SIP servers for transmitting and receiving an SIP message to/from an external user terminal, and a proxy server for intervening in transmission and reception of said SIP message, wherein said proxy server comprises:
an SIP proxy server function of transmitting and receiving an external message;
a message discrimination function of discriminating a kind of message received by said SIP proxy server function; and
a destination change request response generating function of generating a destination change request response for causing the user terminal to change a transmission destination of said Initial REGISTER request to the spare SIP server in response to one of a plurality of Initial REGISTER requests received which are to be transmitted to the working SIP server through the proxy server itself, thereby enabling authentication of said user terminal to be executed between said user terminal and said spare SIP server by said REGISTER request.

55. A communication method in a proxy server which, with respect to working and spare communication control devices for transmitting/receiving a message to/from an external user terminal, intervenes in transmission/reception of said message, comprising:
an intervening step of intervening in transmission/reception of said message;
a message discrimination step of discriminating a kind of message received at said intervening step;
a temporary storage step of, when determination is made by said message discrimination step that said message is a message requesting processing of information related to said user terminal which is held in said working communication control device, temporarily recording contents of the message; and
a request generation step of, when said message is accepted by said working communication control device, copying a message having the same contents as the contents of said message to said spare communication control device for authentication.

56. A communication method in a proxy server which, with respect to working and spare SIP servers for transmitting/receiving an SIP message to/from an external user terminal, intervenes in transmission/reception of said SIP message, comprising:
an intervening step of intervening in an SIP message;
a message discrimination step of discriminating a kind and a transmission source of an SIP message received by said intervening step;
a temporary storage step of temporarily storing a copy of a REGISTER request of said user terminal which is received at said intervening step; and
a request generation step of generating a REGISTER request for authentication by said spare SIP server based on a copy of said REGISTER request corresponding to a REGISTER request whose processing at said working SIP server is normally completed and a user identifier and a password of said proxy server which are for use in Digest authentication with a spare SIP server to which registration information of said user terminal is copied.

57. A communication method in a proxy server which, with respect to working and spare SIP servers for transmitting and receiving an SIP message to/from an external user terminal, intervenes in transmission and reception of said SIP message, comprising:
an intervening step of transmitting and receiving an external message;
a message discrimination step of identifying a kind of message received by said intervening step; and
a transmission destination determination step of determining a transmission destination of a REGISTER request to be transmitted from said user terminal to the working SIP server through said proxy server itself from among a plurality of external spare SIP servers as transmission destinations.

58. A communication method in a proxy server which, with respect to working and spare SIP servers for transmitting and receiving an SIP message to/from an external user terminal, intervenes in transmission and reception of said SIP message, comprising:
an intervening step of transmitting and receiving an external message;
a message discrimination step of identifying a kind and a transmission source of a message received at said intervening step;
a transmission destination determination step of determining a transmission destination of said REGISTER request from among a plurality of external SIP servers as transmission destinations; and
a re-transmission response generating step of, when said working SIP server accepts a REGISTER request, generating an SIP response which urges re-transmission of a REGISTER request without sending an acceptance completion notification to the user terminal; wherein
at said transmission destination determination step, a transmission destination of a REGISTER request re-transmitted from said user terminal is determined to be said spare SIP server.

59. A communication method in a proxy server which, with respect to working and spare SIP servers for transmitting and receiving an SIP message to/from an external user terminal, intervenes in transmission and reception of said SIP message, comprising:
an intervening step of transmitting and receiving an external message;
a message discrimination step of identifying a kind of message received at said intervening step; and
a destination change request response generating step of generating a destination change request response for causing said user terminal to change a transmission destination of an SIP request to a spare SIP server after confirming normal processing completion of said REGISTER request transmitted to the working SIP server through said proxy server itself.

60. A communication method in a proxy server which, with respect to working and spare SIP servers for transmitting and receiving an SIP message to/from an external user terminal, intervenes in transmission and reception of said SIP message, comprising:
an intervening step of transmitting and receiving an external message;
a message discrimination step of identifying a kind of message received at said intervening step; and
a destination change request response generating step of generating a destination change request response for causing said user terminal to change a transmission destination of an SIP request when a transmission destination of a received Initial REGISTER request differs from a transmission destination indicated by transmission destination correspondence information indicative of a correspondence relationship between said user terminal and a transfer destination of a REGISTER request to be transmitted from said user terminal through said proxy server itself.

61. The communication method according to claim 60, wherein
when a message received from said spare SIP server is an SIP response indicative of authentication allowance, said transmission destination correspondence information is updated, and
upon reception of a message of an SIP response indicative of following authentication allowance from a new spare SIP server, a transmission destination of a relevant REGISTER request is correlated with a new working SIP server and upon reception of the message from the new working SIP server, the transmission destination of the relevant REGISTER request is correlated with the new spare SIP server.

62. The communication method according to any one of claim 57, claim 60 and claim 61, further comprising an expiration date updating step of updating an expiration date of a received message.

63. The communication method according to claim 55 or claim 56, wherein a copy of said REGISTER request is generated once in several times out of times of said transmission.

64. The communication method according to any one of claim 55, claim 56 and claim 63, further comprising an expiration date updating step of extending, at the time of generation of a REGISTER request to be transmitted to the spare SIP server, an expiration date of the REGISTER request.

65. The communication method according to claim 58, wherein said re-transmission request response generating step generates said re-transmission request response in response to one of SIP responses indicative of authentication allowance which are received a plurality of times from said working SIP server.

66. The communication method according to claim 65, wherein
said re-transmission request response generating step determines whether to generate said re-transmission request response upon reception of an Initial REGISTER request from said user terminal, and which further comprises
an expiration date updating step of, upon determination to generate said re-transmission request response, updating an expiration date of a received message.

67. A communication method in a proxy server which, with respect to working and spare SIP servers for transmitting and receiving an SIP message to/from an external user terminal, intervenes in transmission and reception of said SIP message, comprising:
an intervening step of transmitting and receiving an external message;
a message discrimination step of identifying a kind of message received by said intervening step; and
a destination change request response generating step of, upon reception of an Initial REGISTER request to be transmitted from the user terminal to the working SIP server through said proxy server itself, generating a destination change request response for causing said user terminal to change a transmission destination of the Initial REGISTER request to the spare SIP server.

68. The communication method according to claim 67, wherein
at said destination change request response generating step, said destination change request response is generated when a transmission destination of a received Initial REGISTER request differs from a transmission destination indicated by transmission destination correspondence information indicative of a correspondence relationship between said user terminal and a transfer destination of a REGISTER request to be transmitted from said user terminal through said proxy server itself.

69. The communication method according to claim 68, wherein
when a message received from said spare SIP server is an SIP response indicative of authentication allowance, said transmission destination correspondence information is updated, and
upon reception of a message of an SIP response indicative of following authentication allowance from a new spare SIP server, a transmission destination of a relevant REGISTER request is correlated with a new working SIP server and upon reception of the message from the new working SIP server, the transmission destination of the relevant REGISTER request is correlated with the new spare SIP server.

70. The communication method according to any one of claim 67 to claim 69, wherein
said destination change request response generating step generates said destination change request response in response to one of a plurality of Initial REGISTER requests received which are to be transmitted to said working SIP server through said proxy server.

71. The communication method according to any one of claim 60 to claim 62, and claim 67 to claim 70, wherein
said destination change request response generating step generates said destination change request response in response to one of a plurality of cases where a transmission destination of a received Initial REGISTER request differs from a transmission destination indicated by said transmission destination correspondence information.

72. The communication method according to claim 57, wherein said transmission destination determination step determines, in response to one of a plurality of Initial REGISTER requests received from said user terminal, said spare SIP server to be a transmission destination of said Initial REGISTER request.

73. The communication method according to any one of claim 57, claim 67 to claim 69, and claim 72, further comprising:
an expiration date change request response generating step of generating an expiration date change request response for requesting said user terminal to change an expiration date of a received message.

74. A communication method in a proxy server which, with respect to working and spare SIP servers for transmitting and receiving an SIP message to/from an external user terminal, intervenes in transmission and reception of said SIP message, comprising:
an intervening step of transmitting and receiving an external message;
a message discrimination step of discriminating a kind of message received at said intervening step; and
a destination change request response generating step of generating a destination change request response for causing the user terminal to change a transmission destination of said Initial REGISTER request to the spare SIP server in response to one of a plurality of Initial REGISTER requests received which are to be transmitted to the working SIP server through said proxy server itself.

75. A program to be executed by a proxy server which, with respect to working and spare communication control devices for transmitting/receiving a message to/from an external user terminal, intervenes in transmission/reception of said message, which makes said proxy server execute the following processings:
proxy server processing of intervening in transmission/reception of said message;
message discrimination processing of discriminating a kind of message received at said proxy server processing;
temporary storage processing of, when determination is made by said message discrimination processing that said message is a message requesting processing of information related to said user terminal which is held in said working communication control device, temporarily recording contents of the message; and
request generation processing of, when said message is accepted by said working communication control device, copying a message having the same contents as the contents of said message to said spare communication control device for authentication.

76. A program to be executed by a proxy server which, with respect to working and spare communication control devices for transmitting/receiving a message to/from an external user terminal, intervenes in transmission/reception of said message, which makes said proxy server execute the following processings:
SIP proxy server processing of intervening in an SIP message;
message discrimination processing of discriminating a kind and a transmission source of an SIP message received by said SIP proxy server processing;
temporary storage processing of temporarily storing a copy of a REGISTER request of said user terminal which is received by said SIP proxy server processing; and
request generation processing of generating a REGISTER request for authentication by said spare SIP server based on a copy of said REGISTER request corresponding to a REGISTER request whose processing at said working SIP server is normally completed, and a user identifier and a password of said proxy server which are for use in Digest authentication with a spare SIP server to which registration information of said user terminal is copied.

77. A program to be executed by a proxy server which, with respect to working and spare communication control devices for transmitting/receiving a message to/from an external user terminal, intervenes in transmission/reception of said message, which makes said proxy server execute the following processings:
SIP proxy server processing of transmitting and receiving an external message;
message discrimination processing of identifying a kind of message received by said SIP proxy server processing; and
transmission destination determination processing of determining a transmission destination of a REGISTER request to be transmitted from said user terminal to a working SIP server through said proxy server itself from among a plurality of external spare SIP servers as transmission destinations.

78. A program to be executed by a proxy server which, with respect to working and spare communication control devices for transmitting/receiving a message to/from an external user terminal, intervenes in transmission/reception of said message, which makes said proxy server execute the following processings:
SIP proxy server processing of transmitting and receiving an external message;
message discrimination processing of identifying a kind and a transmission source of a message received by said SIP proxy server processing;
transmission destination determination processing of determining a transmission destination of said REGISTER request from among a plurality of external SIP servers as transmission destinations; and
re-transmission response generating processing of, when said working SIP server accepts a REGISTER request, generating an SIP response which urges re-transmission of a REGISTER request without sending an acceptance completion notification to the user terminal; wherein
at said transmission destination determination processing, a transmission destination of a REGISTER request re-transmitted from said user terminal is determined to be said spare SIP server.

79. A program to be executed by a proxy server which, with respect to working and spare communication control devices for transmitting/receiving a message to/from an external user terminal, intervenes in transmission/reception of said message, which makes said proxy server execute the following processings:
SIP proxy server processing of transmitting and receiving an external message;
message discrimination processing of identifying a kind of message received by said SIP proxy server processing; and
destination change request response generating processing of generating a destination change request response for causing said user terminal to change a transmission destination of an SIP request to a spare SIP server after confirming normal processing completion of said REGISTER request transmitted to a working SIP server through the proxy server itself.

80. A program to be executed by a proxy server which, with respect to working and spare communication control devices for transmitting/receiving a message to/from an external user terminal, intervenes in transmission/reception of said message, which makes said proxy server execute the following processings:
SIP proxy server processing of transmitting and receiving an external message;
message discrimination processing of identifying a kind of message received by said SIP proxy server processing; and
destination change request response generating processing of generating a destination change request response for causing said user terminal to change a transmission destination of an SIP request when a transmission destination of a received Initial REGISTER request differs from a transmission destination indicated by transmission destination correspondence information indicative of a correspondence relationship between said user terminal and a transfer destination of a REGISTER request to be transmitted from said user terminal through the proxy server itself.

81. The program according to claim 80, wherein
when a message received from said spare SIP server is an SIP response indicative of authentication allowance, said transmission destination correspondence information is updated, and
upon reception of a message of an SIP response indicative of following authentication allowance from a new spare SIP server, a transmission destination of a relevant REGISTER request is correlated with a new working SIP server and upon reception of the message from the new working SIP server, the transmission destination of the relevant REGISTER request is correlated with the new spare SIP server.

82. The program according to any one of claim 77, claim 80 and claim 81, which causes said proxy server to execute expiration date updating processing of updating an expiration date of a received message.

83. The program according to claim 75 or claim 76, wherein a copy of said REGISTER request is generated once in several times out of times of said transmission.

84. The program according to any one of claim 75, claim 76 and claim 83, which causes said proxy server to execute an expiration date updating processing of extending, at the time of generation of a REGISTER request to be transmitted to the spare SIP server, an expiration date of the REGISTER request.

85. The program according to claim 78, wherein said re-transmission request response generating processing generates said re-transmission request response in response to one of SIP responses indicative of authentication allowance which are received a plurality of times from said working SIP server.

86. The program according to claim 85, wherein
said re-transmission request response generating processing determines whether to generate said re-transmission request response upon reception of an Initial REGISTER request from said user terminal, and which causes said proxy server to execute
expiration date updating processing of, upon determination to generate said re-transmission request response, updating an expiration date of a received message.

87. A program to be executed by a proxy server which, with respect to working and spare communication control devices for transmitting/receiving a message to/from an external user terminal, intervenes in transmission/reception of said message, which makes said proxy server execute the following processings:
SIP proxy server processing of transmitting and receiving an external message;
message discrimination processing of identifying a kind of message received by said SIP proxy server processing; and
destination change request response generating processing of, upon reception of an Initial REGISTER request to be transmitted from the user terminal to a working SIP server through said proxy server itself, generating a destination change request response for causing said user terminal to change a transmission destination of the Initial REGISTER request to a spare SIP server.

88. The program according to claim 87, wherein
in said destination change request response generating processing, said destination change request response is generated when a transmission destination of a received Initial REGISTER request differs from a transmission destination indicated by transmission destination correspondence information indicative of a correspondence relationship between said user terminal and a transfer destination of a REGISTER request to be transmitted from said user terminal through said proxy server itself.

89. The program according to claim 88, wherein
when a message received from said spare SIP server is an SIP response indicative of authentication allowance, said transmission destination correspondence information is updated, and
upon reception of a message of an SIP response indicative of following authentication allowance from a new spare SIP server, a transmission destination of a relevant REGISTER request is correlated with a new working SIP server and upon reception of the message from the new working SIP server, the transmission destination of the relevant REGISTER request is correlated with the new spare SIP server.

90. The program according to any one of claim 87 through claim 89, wherein
said destination change request response generating processing generates said destination change request response in response to one of a plurality of Initial REGISTER requests received which are to be transmitted to said working SIP server through the proxy server.

91. The program according to any one of claim 80 through claim 82, and claim 87 through claim 90, wherein
said destination change request response generating processing generates said destination change request response in response to one of a plurality of cases where a transmission destination of a received Initial REGISTER request differs from a transmission destination indicated by said transmission destination correspondence information.

92. The program according to claim 77, wherein said transmission destination determination processing determines, in response to one of a plurality of Initial REGISTER requests received from said user terminal, said spare SIP server to be a transmission destination of said Initial REGISTER request.

93. The program according to any one of claim 77, claim 87 through claim 89, and claim 92, which causes said proxy server to execute
expiration date change request response generating processing of generating an expiration date change request response for requesting said user terminal to change an expiration date of a received message.

94. A program to be executed by a proxy server which, with respect to working and spare communication control devices for transmitting/receiving a message to/from an external user terminal, intervenes in transmission/reception of said message, which makes said proxy server execute the following processings:
SIP proxy server processing of transmitting and receiving an external message;
message discrimination processing of discriminating a kind of message received by said SIP proxy server processing; and
destination change request response generating processing of generating a destination change request response for causing the user terminal to change a transmission destination of said Initial REGISTER request to a spare SIP server in response to one of a plurality of Initial REGISTER requests received which are to be transmitted to a working SIP server through the proxy server itself.
